(19) United States
(12) Patent Application Publication
(10) Pub. No.: US 2025/0286716 A1
(43) Pub. Date: Sep. 11, 2025

(54) METHODS, ARCHITECTURES, APPARATUSES, AND SYSTEMS FOR DECENTRALIZED DATA CONTROL AND ACCESS MANAGEMENT

(71) Applicant: InterDigital Patent Holdings, Inc., Wilmington, DE (US)

(72) Inventors: Efat Fathalla, Lexington, VA (US); Chonggang Wang, Princeton, NJ (US); Xu Li, Plainsboro, NJ (US); Robert Gazda, Spring City, PA (US); Michel Roy, Candiac (CA); Michael Starsinic, Newtown, PA (US)

(21) Appl. No.: 18/858,918

(22) PCT Filed: Apr. 26, 2023
(86) PCT No.: PCT/US2023/019979

§ 371 Date: Oct. 22, 2024

Related U.S. Application Data
(60) Provisional application No. 63/335,315, filed on Apr. 27, 2022.

(51) Int. Cl. H04L 9/30; H04L 9/00; H04L 9/06

(52) U.S. Cl. CPC H04L 9/3073; H04L 9/006; H04L 9/0643

(57) ABSTRACT

Procedures, methods, architectures, apparatuses, systems, devices, and computer program products for decentralized data control and access management. For example, a data owner may perform a subscription procedure to obtain verification credentials and an index (e.g., address, identifier) to public data control and access information. The data owner may perform a registration procedure to register ownership of data using the public data control and access information. The public data control and access information may include a public key. The public key is paired with a private trapdoor key to form a key pair. The data owner and a data consumer may perform an access procedure to grant access to registered data. For example, the registration procedure may verify collisions between a token hash, a data hash, and a data owner hash based on use of the key pair.

### CROSS-REFERENCE TO RELATED APPLICATIONS

This application claims the benefit of U.S. Provisional Patent Application No. 63/335,315 filed 27 Apr. 2022 which is incorporated herein by reference.

### TECHNICAL FIELD

The present disclosure is generally directed to the fields of communications, software and encoding, including, for example, to methods, architectures, apparatuses, systems directed to decentralized data control and access management thereof.

### BACKGROUND

A wireless transmit/receive unit (WTRU) may be configured to operate in a 5G network. In a Distributed Ledger System (DLS), interactions between entities within the DLS may be placed in a pool of transactions until verified. Common consensus protocols for verification are Proof-of-Work (PoW) and Proof-of-Stake (PoS).

### SUMMARY

The present disclosure is generally directed to the fields of communications, software and encoding, including, for example, to methods, architectures, apparatuses, systems directed to decentralized ownership of data.

In certain representative embodiments, a data owner may perform procedures to register owned data, provide access to owned data, revoke ownership of data, and/or transfer ownership of owned data.

In certain representative embodiments, a data consumer may perform procedures to access owned data, and/or transfer ownership of owned data.

In certain representative embodiments, a network entity may perform procedures to register owned data, provide access to owned data, revoke ownership of data, and/or transfer ownership of owned data.

In certain representative embodiments, a WTRU may register ownership of data. For example, the WTRU may send information indicating a request to register data. The request may include an identifier of an owner of the data. The WTRU may determine a set of chameleon hash (CH) collision public parameters, including an au′ parameter and a bu′ parameter, based on a CH collision function using a secret key of the owner, a CH value of an identifier of the owner, a hash value of the data, and a set of public parameters. The WTRU may send information indicating (1) the data to be registered and (2) the set of CH collision public parameters of the data. The WTRU may receive, from an access control entity, information indicating an identifier of the registered data (e.g., registration of ownership of the data).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram illustrating an example of a decentralized identifier (DID) and a decentralized document (DIDDoc) for an owner-managed digital identification service;

FIG. 3 is a conceptual diagram illustrating an example of chameleon hash functions;

FIG. 4 is a system diagram illustrating an example of a data control system in a decentralized scheme;

FIG. 5 is a system diagram illustrating an example of a 5G communication system;

FIG. 6 is a system diagram illustrating example procedures performed in a 5G communication system;

FIG. 7 is a system diagram illustrating examples for data control and access management triggering events for different scenarios and/or applications;

FIG. 8 is a conceptual diagram illustrating an example of induced collisions in decentralized data access using chameleon hash functions;

FIG. 9 is a flow diagram illustrating an example procedure for data control and access management based on self-sovereign identity (SSI);

FIG. 10 is a diagram illustrating example procedures for data control and access management with example information elements that may be used therein;

FIG. 11 is a flow diagram illustrating an example procedure for a service subscription;

FIG. 12 is a flow diagram illustrating an example procedure for data registration;

FIG. 13 is a flow diagram illustrating an example procedure for data access;

FIG. 14 is a conceptual diagram illustrating an example structures of various X-DIDDocs;

FIG. 15 is a conceptual diagram illustrating examples of smart contracts and blockchain transactions obtained during the decentralized data control and access management scheme procedures;

FIG. 16 is a flow diagram illustrating an example procedure for data ownership transfer;

FIG. 17 is a flow diagram illustrating an example procedure for identity credential revocation;

FIG. 18 is a flow diagram illustrating an example procedure for linking a data fingerprint with DO-DID credentials after obtaining an identity revocation;

FIG. 19 is a flow diagram illustrating an example procedure for data registration of locally stored data;

FIG. 20 is a flow diagram illustrating an example procedure for data access of locally stored data;

FIG. 21 is a flow diagram illustrating an example procedure for service subscription of SMC-Data;

FIG. 22 is a conceptual diagram illustrating an example of SMC-Data sharing;

FIG. 23 is a flow diagram illustrating an example procedure for data registration of SMC-Data;

FIG. 24 is a flow diagram illustrating an example procedure for data access of SMC-Data;

FIG. 25 is a system diagram illustrating an example deployment of distributed access control in a wireless network;

FIG. 26 is a system diagram illustrating another example deployment of distributed access control in a wireless network;

FIG. 27 is a system diagram illustrating another example deployment of distributed access control in a wireless network;

FIG. 28 is a system diagram illustrating another example deployment of distributed access control in a wireless network;

FIG. 29 is a flow diagram illustrating an example procedure for an SSI service request;

FIG. 30 is a flow diagram illustrating an example procedure for data registration;

FIG. 31 is a flow diagram illustrating an example procedure for data access;

FIG. 32 is a flow diagram illustrating another example procedure for data registration;

FIG. 33 is a system diagram illustrating an example deployment of distributed data management and access control in an European Telecommunications Standards Institute (ETSI) permissioned distributed ledger (PDL) system;

FIG. 34 is a procedural diagram illustrating an example procedure to register data ownership by a data owner;

FIG. 35 is a procedural diagram illustrating an example procedure to access data owned by a data owner;

FIG. 36 is a procedural diagram illustrating an example procedure to access data owned by a data owner;

FIG. 37 is a procedural diagram illustrating an example procedure to register ownership of data in a network;

FIG. 38 is a procedural diagram illustrating an example procedure to transfer ownership of data owned by a data owner;

FIG. 39 is a procedural diagram illustrating an example procedure to transfer ownership of data owned by a data owner;

FIG. 40 is a procedural diagram illustrating an example procedure to register data owned by a data owner; and

FIG. 41 is a procedural diagram illustrating an example procedure to access data owned by a data owner.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

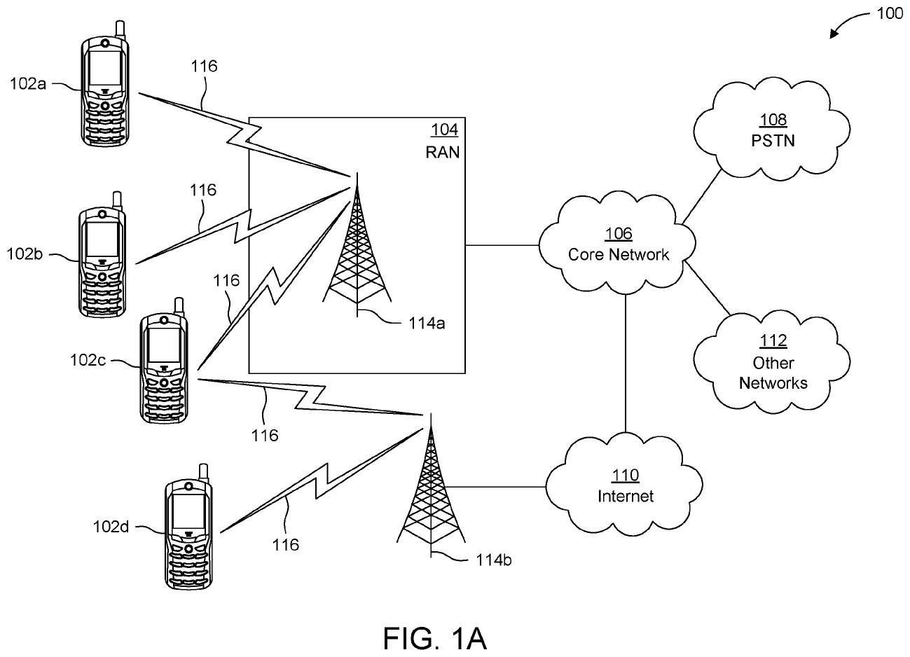

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a virtual reality and/or augmented reality (VR/AR) device, an activity tracker, and the like.

The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

As used herein, the following abbreviations and terms may be used:
3GPP 3rd Generation Partnership Project
AI Artificial Intelligence
CH Chameleon Hash
CHPP Chameleon Hash Public Parameters
CHCPP Chameleon Hash Collision Public Parameters
DAPPs Decentralized Applications
DC Data Consumer
DDoS Distributed Denial of Service
DID Decentralized Identifier
DIDDoc Decentralized Document
DLT Distributed Ledger Technology
DLS Distributed Ledger System
DO Data Owner
DSP Decentralized Storage Platform
ML Machine Learning
P2P Peer-to-Peer network
PKI Public Key Infrastructure
PoS Proof of Stake
PoW Proof of Work
SMC Secure Multiparty Computation
SP Service Provider
SSI Self-Sovereign Identity
SUPI Subscription Permanent Identifier
UE User Equipment
VC Verifiable Credentials
W3C World Wide Web Consortium
WTRU Wireless Transmit/Receive Unit

Data control and access management for data sharing schemes between Data Owners (DOs 404) and Data Consumers (DCs 406) may be critical for various businesses, organizations, and fields, such as wireless networks including future wireless networks.

Some traditional data control and access schemes may rely on Public Key Infrastructure (PKI) to generate a public and private key pair to control data and manage the accessibility of the data. Reliance on centralized PKI solutions for data control and access management systems has been shown to be un-secure, un-trusted, restrictive, not scalable, and/or may serve as a single point of failure. Alternatively, distributed ledger systems (DLS) have been recently proposed to replace the governance of certificate authorities and/or enable the users to create their PKI-related information.

In certain representative embodiments, a DO 404 should have the (e.g., absolute) right to control any owned data without relying on external third-party services.

In certain representative embodiments, a DO 404 should have the control of enabling data accessibility and/or ownership transfer to the potential DC 406 in a decentralized manner.

In certain representative embodiments, owned data may be linked to the DO's identity not only through PKI signatures but also through validated data registration transactions linking the data to a governed (Decentralized Identifier) DID.

In certain representative embodiments, a system may facilitate easy data retrieval and/or ownership reestablishment, such as cases where a PKI-generated private key is lost and/or compromised. Namely, owned data should be easily retrieved and re-linked to its owner's identity.

In certain representative embodiments, the owned data should be easily and efficiently traced back.

In certain representative embodiments, DO and DC rights may be guaranteed during data access.

In some traditional data control and access schemes, systematic problems are present in the certificate authority model related to certificate revocation, certificate authority governance, and security breaches.

In some traditional data control and access schemes, dependencies on the centralized certificate authority prohibit the participants (e.g., DOs 404 and/or DCs 406) from governing their owned digital certificates. For example, system participants cannot control the generation of the PKI policies, roles, authentication mechanisms, etc.

In some traditional data control and access schemes, there is no service monitoring that enables linking the PKI-based digital certificates to the holders' actual identities in traditional data control and access management schemes. For example, any entity can request a valid digital certificate with an authentic public key regardless of its real identity or the intended service definition. Data ownership may be challenging to be traced, which makes the data prone to being stolen. In other words, any entity may claim ownership of the data if it had a copy of it.

In some traditional data control and access schemes, publishing owned data in the DLS network is not practical and risks data confidentiality. Even if the data were encrypted by its owner, a sophisticated attacker could invest time and effort to decrypt and steal the data.

In some traditional data control and access schemes, only PKI public/private key pairs are relied on for identifications and verifications. However, if such a public/private key pair gets compromised, all the related data may be impacted, resulting in data loss and/or theft. Thus, provisioning of data ownership using PKI alone risks data availability and is vulnerable to being stolen and/or manipulated.

Some traditional data control and access schemes follow general, fixed, and restrictive policies. DOs and DCs 406 are assumed to be trusted after being authenticated, which may not be the general case. However, the data access process still suffers from piracy, illegal reselling, illegal redistribution, ownership claiming, forgery, theft, and/or data misappropriation.

In some traditional data control and access schemes, enabling the generation of multiple different DIDs for each piece of owned data is impractical, especially for limited resources and storage devices.

In certain representative embodiments, data control and access management may use a distributed ledger-enabled self-sovereign identity (SSI)-based approach. A Distributed Ledger System (DLS) and its applications like smart contracts and SSI may enable a decentralized data control and access management approach which is provisioned using SSI techniques. This may alleviate the usage of the PKI private key by inducing a chameleon hash (CH) collision to couple all the owned data of a DO 404 to the DID 202 of the DO 404. Service subscription, data registration, and data access procedures may enable decentralized SSI-enabled data control and access management systems. Service subscription procedures may maintain decentralized SSI-enabled data control and access management scheme. Decentralized data registration service procedures may provide decentralized data coupling services with a DO 404 (e.g., global and/or system) DID (DO-DID). Data access procedures may provide a decentralized data access model coupling owned data of a DO 404 and a DO-DID to a generated access token.

In certain representative embodiments, two management keys may be provided to control data ownership. Each of the management keys may be used for a certain task. This requires only the participants to hold two keys, a PKI private key and a CH trapdoor key (e.g., instead of storing various PKI keys for each owned data, or relying on one PKI key which may risk PKI key security).

In certain representative embodiments, SSI-based data storage may be managed and/or may be provided with different storage considerations. For example, owned data may be stored with a DSP or stored locally.

In certain representative embodiments, SSI-based data ownership management may include data ownership transfer and/or identify revocation.

In certain representative embodiments, data access may be performed among one or more DOs and one or more DCs 406. For example, data control may involve interaction between a single DO 404 and a single DC 406. As another example, data control may involve interaction between multiple DOs and multiple DCs 406.

### Distributed Ledger Technology (DLT)

Distributed Ledger Technology (DLT) may refer to shared, immutable, and/or tamper-proof decentralized records of transactions maintained across several computers, such as those linked in a peer-to-peer network. Distributed ledgers, like blockchain, facilitate recording the history of transactions between two or more entities that may not trust each other. The interactions between entities within a Distributed Ledger System (DLS) are usually placed in a pool of transactions until verified. Verified transactions are then compacted to form a Merkle tree stored within cryptographically chained blocks. In any DLS, the network peers may follow a consensus mechanism to manage the transactions and block validations. In other words, the consensus mechanism may enable multiple network peers to have the same/consistent view and/or decision on the ledger status (e.g., which new transaction block should be appended to the ledger in each round, etc.). According to the DLS requirements, type, speed of verifications, and application, the adopted consensus mechanisms may differ. Common consensus protocols are Proof-of-Work (PoW) and Proof-of-Stake (PoS).

PoW, for example, is the consensus mechanism adopted by bitcoin applications. The block generation and validation in PoW relies on a mining process. In the mining process, the network peers (miners) solve arbitrary puzzles that require finding a nonce used to complete the block generation. The miners are incentivized to find a nonce correctly to win a corresponding block reward. The rest of the network peers then validate the proffered effort done by the winning miner and broadcast the generated block to the rest of the network peers. PoW is known for the exertion of computational power in finding unique (e.g., distinguishable within the system) nonce values that satisfy the hashing criteria of the generated blocks. The adoption of the PoW mechanism guarantees fairness between the competing miners and maintains system security. POW requires high energy consumption and a relatively long processing time.

PoS, on the other hand, evolved as a low-cost energy-friendly consensus mechanism. PoS depends on responsibility allocation to maintain the network. Thus, the validators' selection criteria rely on staked coins. Staking more cryptocurrency gives a validator more chances to have the right to check and add new blocks of transactions to the distributed ledger. This comes with the drawback that crypto coin hoarding is incentivized instead of spending.

Other consensus mechanisms like Delegated PoS (DPoS) and Practical Byzantine Fault Tolerance (PBFT) require lower energy consumption replacing the computation hungry PoW mechanism. DPoS is a variation of PoS by which higher staking miners vote on several delegates who must manage and secure the DLS network. The voting and delegation mechanism incentivizes blockchain nodes to secure the network with their staked collateral. In the PBFT mechanism, any block to be verified requires a group of a certain number of blockchain nodes to agree on its validity. More precisely, the nodes could reach a consensus when strictly more than three times the assumed Byzantine nodes vote towards a particular decision.

There are various types of DLS, which are classified as public, private, consortium, and permissioned DLS. The public DLS allows anyone to join, participate, and access the DLS records. The bitcoin blockchain application is a well-known example of public DLS networks. On the other hand, a Private DLS is a small-scale DLS hosted within an internal local network (e.g., governed by a single organization). In private DLS, there are restrictions on who will generate the transaction blocks and how the consensus protocol will be applied. Thus, the organization oversees the DLS network and manages transaction generation, accessibility, and verification. Permissioned DLS is like the private DLS, where single and/or multiple entities control the network. Any data accessibility can be private or public under the control of the governing entity. Consortium DLS is a network governed by a group of organizations controlling the execution of the consensus mechanism and maintaining the shared ledger using a byzantine fault tolerance mechanism. The governing organizations manage which data to store in the ledger and the accessibility constraints to the network transactions.

### Self-Sovereign Identity (SSI)

Advances in internet technology urge contemporary digital identity management services to protect the privacy of users' identities and/or may systematically cope with the network's secure identification and authentication processes. Accordingly, federated identity management solutions have evolved by offering online users centralized identification and authentication services. Despite their effectiveness, federated identity management services have raised concerns about users' privacy and self-controllability.

Third-party authentication services rescinded the user's controllability and governance to his identity, which may risk identity information to unexpected failures, higher possibilities of identity theft, and/or privacy invasions. SSI was developed with an aim to enable a decentralized identity management solution that allow users to govern their identity credentials. SSI enables individuals or organizations a (e.g., lifetime) portable digital identity. The portable digital identity may not depend on any central authority. The portable digital identity may be controlled only by its holder. As understood by those skilled in the art, SSI mimics the actual physical paper credentials model by enabling a verifiable credentials model. The verifiable credentials model provides cryptographically-protected machine-readable data about online users' identities issued by a trusted authority.

In certain representative embodiments, an SSI model comprises three primary entities (referred to as SSI users): the holder, issuer, and verifier. Each SSI user plays a role in SSI.

For example, issuers are authorized trusted entities responsible for issuing users valid and authentic verifiable credentials. Identity issuer capabilities may be limited only to issuing or revoking verifiable credentials. For example, an issuer may not control and/or use such credentials. As used herein, the terms SSI issuer, trusted authority, and identity issuer may be used interchangeably to refer to the issuer. Further, the terms verifiable credentials or identity credentials may be used interchangeably to denote the verifiable credentials issued by the issuer to the identity owner/holder.

For example, a holder is an online user who owns one or more issued verifiable credentials. According to SSI regulations, the holder is the only entity controlling and managing his verifiable credentials. As used herein, the terms such as identity holder, identity owner, SSI identity holder, and VC holder may be used interchangeably to refer to the holder unless otherwise specified.

For example, a verifier is an online service provider or application that requires identification proof from online users (e.g., identity holders) before granting any service accessibility. In the SSI model, the identification process relies on proofing the ownership of the issued verifiable credentials. Subsequently, the verifier trusts verifiable credentials authenticity issued by the issuers. As used herein, the terms SSI verifier and identity verifier may be used interchangeably to refer to the verifier.

The SSI relies on multiple components facilitating its service provisioning while adding a layer of trust among interacting SSI users.

In certain representative embodiments, an SSI-enabled DLS network (SSI-DLS) may keep track and store the history of interactions between SSI users in a decentralized fashion. For example, the identity issuer may publish the most related public information about issuing the verifiable credentials process within the SSI-DLS network. The SSI model relies on a consortium DLS network, which means transactions are publicly accessible yet verified only by SSI stewards. For example, SSI Stewards may be a group of trusted entities such as government firms, top-tier companies, and organizations cooperating to orchestrate the SSI-DLS network and verify system transactions.

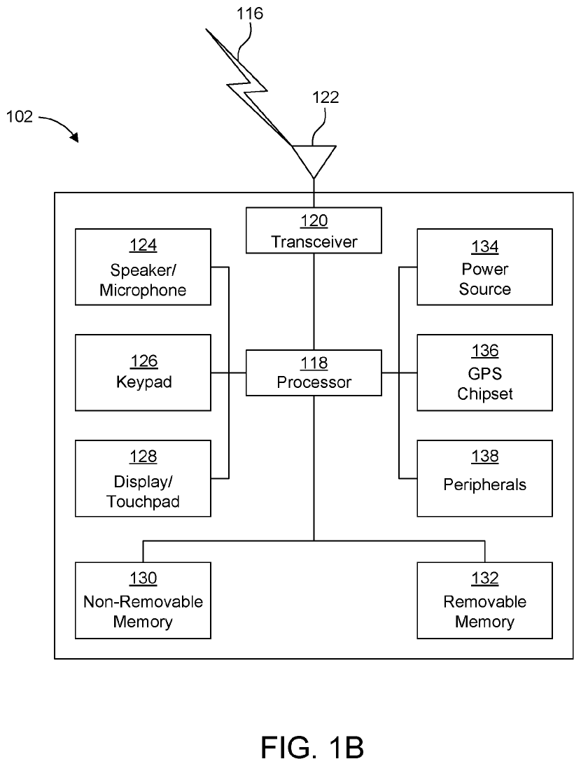

FIG. 2 is a system diagram illustrating a representative example of a verifiable digital identification service managed by its owner and published within SSI-DLS.

In certain representative embodiments, a Decentralized Identifier (DID) 202 is an identifier associated with the identity information of a user (e.g., SSI user 204). For example, a DID 202 may be portable and/or unique (e.g., globally unique and/or distinguishable within the system) URL-based identifier associated with the identity information of its SSI user 204. A DID 202 may be implemented in a decentralized, verifiable digital identification service managed by its owner and published within a SSI-DLS 206, as depicted in FIG. 2. A DID 202 may be decoupled from any centralized authority and may be used to extract needed cryptographic and public information about its holder's identity. DIDs 202 may be (e.g., are) associated with resolving decentralized identifier documents (DIDDocs) 208 also published in the SSI-DLS 206, allowing trustable interaction with their holders.

In certain representative embodiments, a DIDDoc 208 may be (e.g., a piece of) a JSON file posted in the SSI-DLS 206. A DIDDoc 208 may be associated with the identity information of an SSI user. DIDDoc 208 may include and/or indicate cryptographical material and/or services enabling SSI users to prove their control over their DID 202 and their verifiable credentials. For example, decentralized and globally identifiable DIDs may improve verifiable credentials' portability from one system to another without re-issuing of the DIDs. DIDs may conform to a DIDDoc 208 using DID resolver software.

In certain representative embodiments, a DID 202 and content of an associated DIDDoc 208 may be structured as follows. A DID 202 maybe include and/or indicate at least three parts: scheme, method, and method-specific identifier. The DID 202 scheme may be a representation or indication that this identifier is a DID identifier. For example, it may be represented in a format that begins with the identifier “did.” The method may be a representation or indication of a driver of generating and managing the DID 202 and associated DIDDoc 208 content. The method-specific identifier may be a (e.g., unique and/or distinguishable within the system) identifier to the holder that corresponds to a conforming DIDDoc 208 within the SSI-DLS 206.

In certain representative embodiments, a DIDDoc 208 may include and/or indicate multiple attributes facilitating the authentication and verification process of the holder's identity. For example, a DIDDoc 208 may include and/or indicate a DID 202 for self-description, a set of public keys determined by the holder (e.g., Public_key_pem), available authentication schemes the holder uses, a signature to ensure content integrity, and/or a timestamp for auditing purposes.

In certain representative embodiments, verifiable credentials (VC) may be a digital representation of a holder's (e.g., actual and/or true) identity. VCs may be cryptographically protected data that any other SSI user can verify and authenticate online. For example, two types of VCs are verifiable IDs and verifiable attestations. A verifiable ID may identify the holder's identity attributes (e.g., his name, date of birth, and/or address, etc.). A verifiable attestation may represent data issued to its holder by the SSI issuer, such as current job description, driving license, and/or Subscription Permanent Identifier (SUPI) in 5G networks, etc. An issued VC may (e.g., should) show relatable information about the issued identity information alongside information about the issuer and holder DIDs, scheme definition, and/or (e.g., cryptographic) proof generated by the issuer.

### Chameleon Hash

In general, a hashing scheme may be defined as a one-way function that accepts an input of any arbitrary length and generates a (e.g., unique and/or distinguishable within the system) random output denoted as a hash value, which may be otherwise referred to as the input's fingerprint or hash. Due to being a one-way function, it is likely impossible or improbable to retrieve the input value knowing only the hash value. Hashing schemes are usually characterized as collision resistance schemes, where any arbitrary change in the input value may (e.g., must) result in a completely new output of a different hash value. The hash function effectiveness and security rely on the likelihood of finding collisions between two distinct messages (e.g., m₁, m₂). Thus, the possibility to find collisions between two different inputs is almost negligible in more robust hashing schemes. Well-known hashing schemes include SHA256, SHA512, MD5, etc. Depending on the scheme, hash outputs may have the same length. As an example, the length of the hash output of SHA256 is 256 bits regardless of the input length, and the length of the hash output of SHA512 is 512 bits. For example, a cryptographic hash function may (e.g., should) have one or more of the following properties: (1) accept input with any arbitrary length and produce a fixed-length output; (2) one-way function, such that given only the output, it is improbable (e.g., impossible) to recognize the input; and/or (3) collision resistance (e.g., collision-free), where it is improbable (e.g., impossible) to find two different input values that have the same hash value output.

Such properties have caused hashing schemes to gain attention for applications that require integrity checks. For example, backend servers may employ hash schemes to store passwords by their hash values to avoid keeping the unencrypted data related to stored passwords. When an online user specifies his password during a service request, the hash value of the password is compared to the stored hash value within the backend server database, such as (e.g., part of) the user identification and authentication check. DLS is another example of demonstrating the strength of hash functions schemes. The generated blocks in a DLS are chained by their hash values, making the DLS gain features of being immutable and tamper-proof. Despite being effective in obtaining information integrity checks, other applications may require some flexibility to alter the data while keeping the computed hash value the same. For instance, the append-only nature of DLT has already been abused, leading to crypto criminals and hackers to inject arbitrary, illegal contents into a distributed ledger successfully.

As an alternative, Krawczyk and Rabin proposed a hashing scheme called Chameleon Hashing (CH). Like collision-free hashing schemes, CH provides a one-way function generating unpredicted hash values (h) according to the input message (m). According to theory, it is assumed to be impossible to extract the value of (m) given only the knowledge of the value of (h). CH is a collision-free scheme, where it is likely impossible to find any two messages (m₁, m₂) resulting in the same exact value of (h) unless a collision trapdoor key exists. The difference between CH and other hashing schemes is the use of a trapdoor protected by a secret trapdoor key. For example, the owner of the secret trapdoor key may be assumed to be the only entity that can cause collisions between two or more different messages (m₁, m₂, . . . , mₙ).

In certain representative embodiments, CH may take a user-generated key pair, which are a public key (Yᵤ) and a private trapdoor key (Xᵤ). In this context, the subscript “u” in (Xᵤ, Yᵤ) refers to the user generating and controlling such parameters. The usage of each CH key may be described as follows.

The public key (Yᵤ) facilitates the calculation of a CH value (m₁-CH) for a given input (m₁), where m₁∈[0,1]*. Knowing the public key allows any entity to calculate or verify the CH value (m₁-CH) corresponding to the given input message (m₁).

The private trapdoor key (Xᵤ) triggers a CH trapdoor that causes a collision between two or more distinct messages (m₁, m₂, . . . , mₙ) of arbitrary lengths. As described herein, the terms trapdoor key or secret trapdoor key may be used interchangeably to refer to the private trapdoor key (Xᵤ).

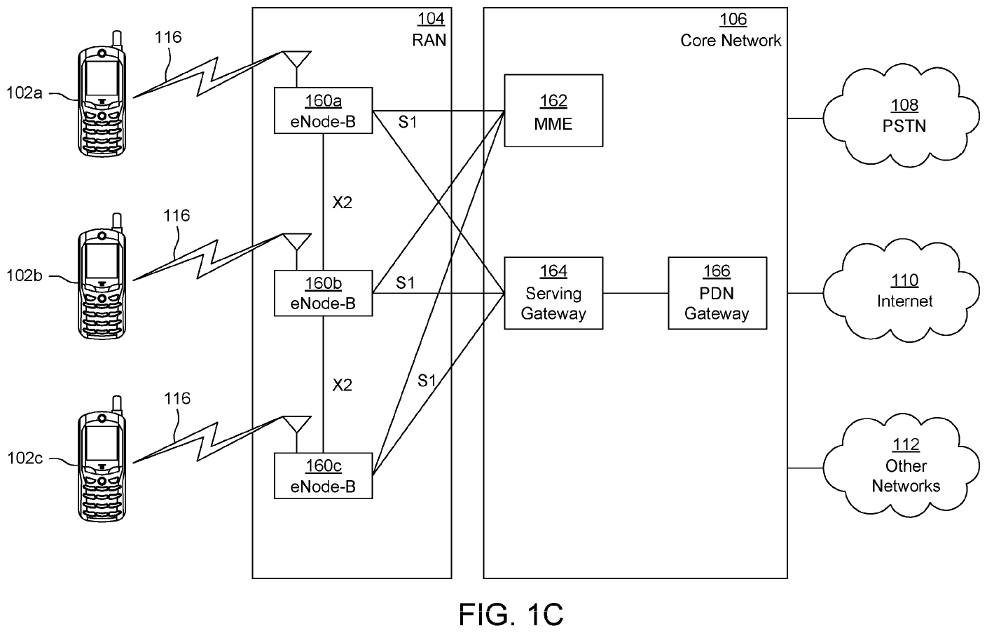

In certain representative embodiments, CH may involve four operational functions: CH.Gen, CH.Hash, CH.Ver, and CH.Col. FIG. 3 is a diagram illustrating a representative example 300 of the chameleon hash functions described as follows.

For example, the CH.Gen function may generate the public (Yᵤ)/private (Xᵤ) key pairs for a particular user (u).

For example, the CH.Hash function is a one-way (e.g., irreversible) hashing function that accepts any input of an arbitrary length and computes, as an output, a corresponding (e.g., unique and/or distinguishable within the system) and collision-free CH value. This function may rely on the user's (u) public key (Yᵤ), one or more precalculated cryptographic primitives (g, p, q), and two randomly generated numbers (aᵤ, bᵤ) referred to as CH collision public parameters (CHCPP) in computing CH value (m₁-CH) of the input message (m₁).

For example, the CH.Ver function validates the equality between a given CH value (m₁-CH) of a certain input (m₁) and the output of executing CH.Hash function for the same input (m₁). For example, CH.Ver indicates whether m₁-CH is equal to the resulting value of executing the CH-Hash function, given public parameters (Yᵤ, g, p, q), and message (m₁), and corresponding CHCPP (aᵤ, bᵤ).

For example, the CH.Col function requires the secret trapdoor key (Xᵤ) to induce collisions between the CH value of the input (m₁) and any other input messages (m₂, m₃, . . . , mₙ). A CH collision may be represented by m₁-CH and will have the same value of m₂-CH, m₃-CH, . . . , mₙ-CH.

In certain representative embodiments, among the foregoing keys, (e.g., only) the trapdoor key Xᵤ may be a secret value, while the tuple (Yᵤ, p, q, aᵤ, bᵤ) may be public values. As described herein, the tuple (Yᵤ, p, q, g) may be referred to as CH public parameters (CHPP), and the parameters (aᵤ, bᵤ) may be referred to as CH collision public parameters (CHCPP).

### Data Control and Access Management

Data sharing may be critical for various businesses, organizations, and fields, including future wireless systems, healthcare, education, and the financial sector. For example, data sharing in wireless communications may derive valuable insights about the quality of the network, the reliability of the communication, and/or help in understanding more about security risks, etc. Network providers and other third parties in wireless communications network alliances may seek actual data obtained from the network subscribers. Network subscribers' data may be accessible to all 3GPP partners and their members and/or may be accessed by third parties with subscribers' consent during network provisioning.

Conventional data sharing models incorporate multiple interacting entities, including data aggregation, data control, data access management, and storage entities. Successful data sharing models typically rely on efficient and secure data control and access management schemes that consider various data-driven protection attributes to secure data-oriented operations, including security, reliability, integrity, accessibility, portability, and scalability. Each of these attributes shapes the complexity and efficiency of the data control design. Despite that, conventional data control and access management schemes inherit multiple shortcomings, including data theft, centralization, lack of data protection, etc. Additionally, reliance on storage services like cloud storage platforms, while assuming absolute trust, is another significant risk.

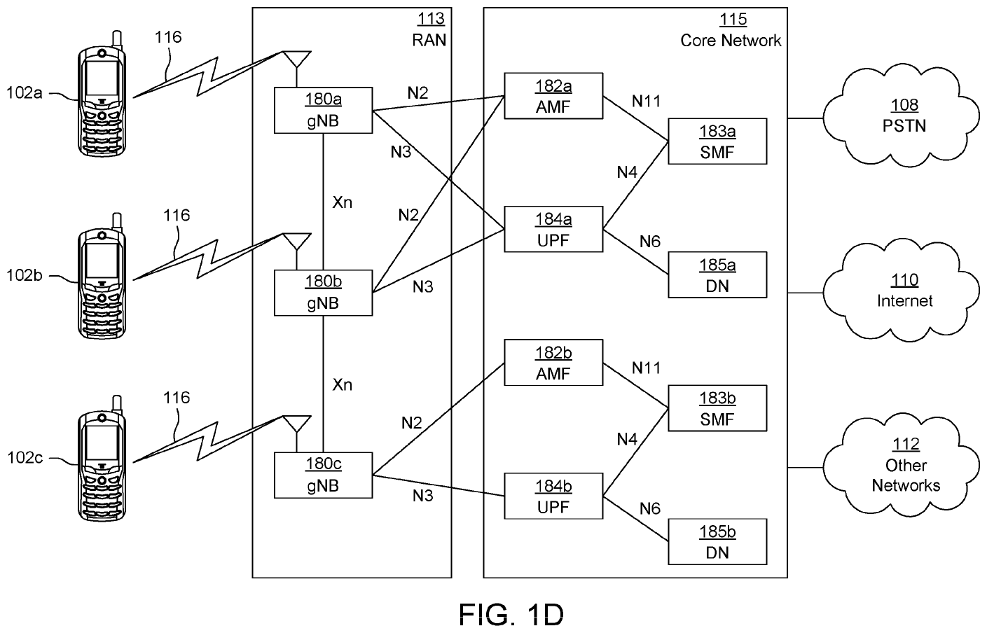

FIG. 4 is a diagram illustrating an example of a data control system 400. A DLS 402 as shown in FIG. 4 offers a decentralized solution which may mitigate the centralization issues of the conventional data control and access management schemes. For example, an SSI model could allow the participants to generate their own PKI and assign its role using DIDDocs 208 (e.g., instead of relying on a central authority to create digital certificates). Furthermore, data owners (DOs) 404 may store their data on-chain to ensure trust, immutability, and ownership protection rather than keeping data with the cloud services.

As shown in FIG. 4, a data consumer (DC) 406 may generate a DC DID at 408. The generated DC DID may be stored by a DLS 402. A DO 404 may generate a DO DID at 410. The generated DO DID may be stored by a DLS 402. The DO 404 may register data (e.g., digitally signed data) with the DLS 402 at 412. Any data access transactions (e.g., by the DC 406 and/or DO 404) may be stored by the DLS 402 at 414. A DC 406 may request the DLS 402 to access data owned by the DO 404 at 416.

Due to shortcomings in centralized data control systems, research has shifted focus to studying decentralized data control schemes for various applications and from different perspectives. For example, Hillman and Ganesh have introduced a Kratos model that provides a decentralized data outsourcing scheme for the educational sector. Researchers, Somy et al., have proposed another model focused on securing and protecting federated machine learning and data control schemes for wireless communication. In this model, a federated AI mechanism was proposed where a data owner seeks to make use of owned data without risking its confidentiality and integrity.

### 5G System Architecture

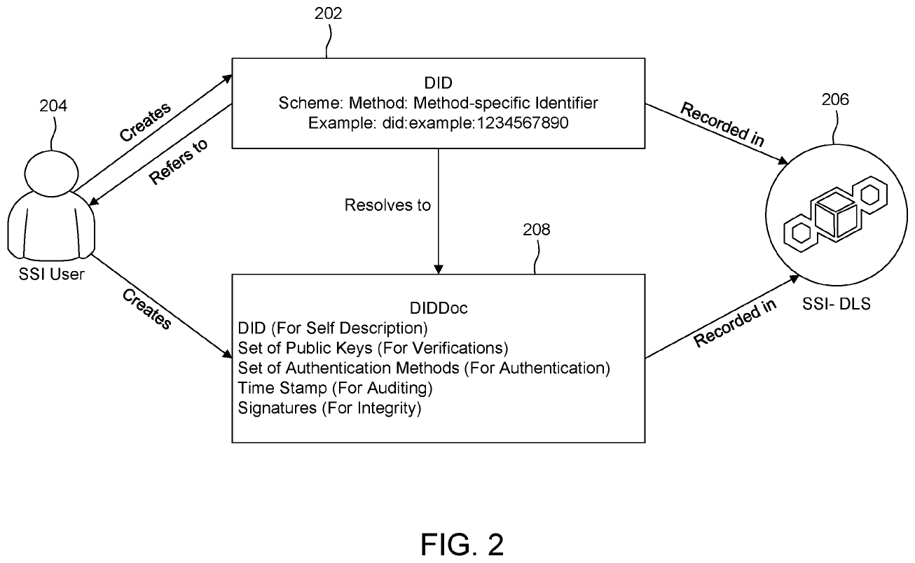

FIG. 5 is a system diagram illustrating an example of a 5G communication system architecture. As shown in FIG. 5, the 5G system architecture may include a WTRU 102, a RAN (e.g., 5G RAN 113), and a CN (e.g., 5G Core Network 115) which communicate using interfaces (e.g., N1, N2, N3, N4, N6, N9, etc.). One of the design principles for 5G system architecture is being service-centric or service-based. As shown in FIG. 5, a 5G CN 115 contains a variety of network functions, which work together to fulfill and provide needed services to the RAN 113, WTRU 102, and Application Servers and/or Service Providers. A network function can access another function in request/response mode or subscription/notification mode. Before two network functions interact with each other, they first may need to register with a Network Repository Function (NRF) 502 so that they can discover each other from the NRF 502. Among these network functions, an Access and Mobility Management Function (AMF) 182, is dedicated to managing WTRU 102 access to the 5G system and its mobility, and a Session Management Function (SMF) 183 is responsible for establishing sessions between a WTRU 102 and the 5G core network. An Authentication Server Function (AUSF) 504 takes charge of WTRU authentication. In addition, a Policy Control Function (PCF) 506 provides policy rules for other control plane network functions and WTRUs. The PCF 506 assigns an identifier for each created policy rule, which other control plane network functions and WTRUs use to refer to a corresponding policy rule. A User Plane Function (UPF) 184b is a function for the user plane, and facilitates monitoring, managing, controlling, and redirecting user plane traffic flows, such as between a WTRU 102 and an application server (e.g., of a data network (DN) 508a). A Network Exposure Function (NEF) 510 enables exploration control plane functions to entities such as network applications outside the 5G system and not in the same trusted domain. The 5G CN 115 also provides data storage and analytics services through functions including a Unified Data Management (UDM) 512, a Unified Data Repository (UDR) 514, an Unstructured Data Storage Function (UDSF) 516, and a Network Data Analytics Function (NWDAF) 518. Another feature of the 5G system is network slicing, facilitated by a Network Slice Selection Function (NSSF) 520. The 5G CN 115 also may include a Location Management Function (LMF) 522. Although these network functions are defined as separate logical entities, a particular scenario may require multiple functions. For example, WTRU mobility will need to communicate with the AMF 182, AUSF 504, and SMF 183. For a given type of network function, multiple instances could be instantiated, and a NRF will maintain the information of each instantiated network function instance. With the emergence of edge computing, some network functions in the 5G CN, such as the UPF 184a and the NEF 510, may be deployed and reside in an edge network 524 that is much nearer to and potentially co-located with the RAN 113.

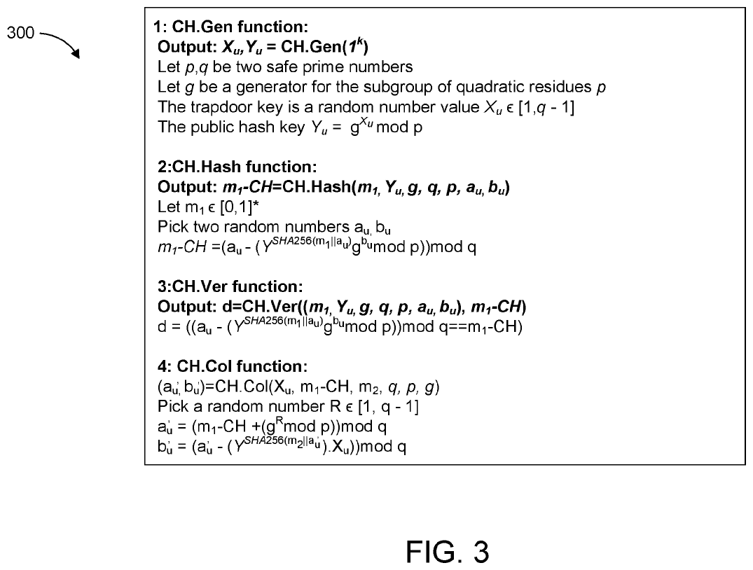

FIG. 6 is system diagram illustrating example procedures performed in a 5G communication system. As shown in FIG. 6, procedures may be jointly performed by a WTRU 102, RAN node (e.g., gNB 180), and 5G CN to enable a WTRU 102 to fulfill certain functionalities.

At Step 1 in FIG. 6, a WTRU 102 may discover and select a network (e.g., a PLMN, a RAN, a cell) based on a received System Information Block (SIB), which is broadcast by a RAN node to any WTRUs. At Step 2, the WTRU 102 may establish a Radio Resource Control (RRC) connection with a selected RAN (e.g., RAN1 113a) so that the WTRU 102 can communicate with the core network via the selected RAN 113a.

At Step 3, the WTRU 102 may initiate registration with a serving AMF 182a, determined by the selected RAN 113a. The serving AMF 182a may check with the AUSF 504 for primary access authentication and authorization, request the WTRU's subscription data from the UDM 512, check with the PCF 506 for access and mobility policies, and contact the SMF to activate any existing PDU session when indicated by the WTRU 102. A Registration Area (RA) 602a, 602b may include multiple Tracking Areas (TAs). When the WTRU 102 stays within a RA (e.g., RA1 602a), it does not need to perform a registration update with the serving AMF again to reduce signaling overhead unless a periodical registration timer expires. Each TA may cover multiple cells. When the WTRU 102 moves from one RA to another RA (e.g., RA2 602b), the WTRU 102 needs to perform a new registration with the registration type set to Mobility Registration Update. A larger RA helps to reduce registration overhead, but may increase the overhead of paging signaling, which the serving AMF uses to page a WTRU 102. After successful registration, the WTRU 102 enters the RM-REGISTERED state and may start interacting with other control planes NFs (e.g., via the serving AMF 182A). The serving AMF 182A is the (e.g., only) entry point for the WTRU 102 to access and interact with the CN control plane.

For example, a service request procedure at Step 5 may be done together with WTRU registration at Step 3. As a result, the WTRU 102 may enter a CM-CONNECTED state. When the WTRU 102 is in the CM-CONNECTED state, the WTRU 102 may move within the RA without notifying the serving AMF 182A.

Should the WTRU 102 move out of a RAN Notification Area (RNA) yet is still within the RA, the WTRU 102 may need to perform a RAN update to trigger the RAN to update the WTRU 102 context and the corresponding RRC connection maintained by the RAN. An RNA may be a subset of a RA. For example, TA1, TA2, and TA3 may form an RNA.

At Step 4, the WTRU 102 may establish a PDU session for a designated DN with an SMF, which the serving AMF 182A determines. At Step 4, the SMF may check with a PCF 506 for PDU session policies and select a UPF as a PDU Session Anchor (PSA). The PSA is an entry point for the WTRU 102 to access a Data Network (DN) or to receive packets from a DN. When the SMF checks with the PCF 506 for session policies, the PCF 506 may retrieve the WTRU's subscription data from a UDR. The SMF may perform a primary session authentication using the WTRU's subscription data as retrieved from a UDM 512 and may optionally perform a secondary authentication between the WTRU 102 and a DN-AAA server using the Extensible Authentication Protocol (EAP) as defined in RFC3748 and RFC5247. A service request procedure at Step 5 may be performed together with the PDU establishment at Step 4.

At Step 5, when the WTRU 102 enters to a CM-IDLE state (e.g., after the WTRU's connection with the serving AMF 182A is released), the WTRU 102 (e.g., in Mobile Initiated Connections Only (MICO) mode) may actively initiate a service request procedure to reestablish a connection with the serving AMF 182A and enter the CM-CONNECTED state. If the WTRU 102 is not in MICO mode while in the CM-IDLE state, the serving AMF 182A may page and trigger the WTRU 102 to initiate a service request procedure, such as to receive any downlink packets. As a result of the service request, a Non-Access-Stratum (NAS) connection is established between the WTRU 102 and its serving AMF 182A.

At Step 6, the WTRU 102 may start user plane data transmission with the designated DN via the RAN and the UPF as a PSA. Each DN has a Data Network Name (DNN). At Step 7, the WTRU 102 may move from RA1 to RA2, and may detect this event by checking the list of TAs for each RA as configured by the serving AMF 182A. Then, the WTRU 102 may perform a Mobile Registration Update with a new serving AMF 182B. During this step, an Xn-based or N2-based inter-RAN handover may be conducted between the new RAN and the old RAN. The new serving AMF 182B may contact the old serving AMF for transferring the WTRU's context information. The SMF may contact the PCF 506 and the UPF to update any existing PDU sessions with the WTRU 102 at Step 7.

As shown in FIG. 6, multiple TAs can be grouped together as a Local Area Data Network (LADN) service area to support LADN service. As an example, TA4, TA5, and TA6 may form a LADN service area. The WTRU 102 may be allowed to access LADN1 if and only if the WTRU 102 stays within TA4, TA5, or TA6. Similarly, a set of TAs can be grouped as a service area, based on which the 5G system can specify and enforce service area restrictions for the WTRU 102. For example, TA7, TA8, and TA9 may form a service area, which the 5G system can configure with a WTRU 102 for service area restriction. For example, the WTRU 102 may be allowed to access the 5G system if and only if the WTRU 102 stays within TA7, TA8, and TA9.

The foregoing procedures of FIG. 6 are provided as general examples. The WTRU 102 may perform these procedures in a different order, such as performing Step 7 before Step 6 and/or skipping Step 5. In FIG. 6, data transmission occurs in the user plane whereas the other procedures occur in the control plane.

### Wireless Communication Data Sharing Use Cases

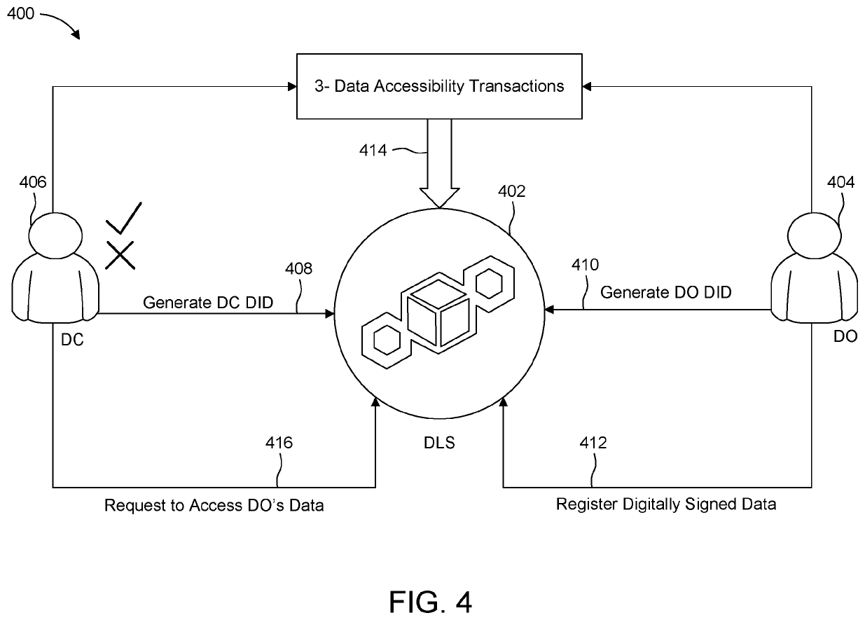

Data control and/or access management schemes for wireless communication networks may be important for many data-sharing-related applications, including device-to-device communication, content offloading, native artificial intelligence, network reliability statistics, emergency recording, and/or monitoring, etc. Network providers and other third-party services may aim to collect data from the subscribers and their terminal devices (WTRUs) for a multitude of purposes. FIG. 7 is a system diagram illustrating example data control and access management triggering events for different scenarios and/or applications, which include but are not limited to the following.

### Scenario 1) Network Reliability and Service Enhancement

To better analyze the network quality in various locations, network providers strive to gather precise service information from their subscribers and avoid overwhelming the deployed resources with more tasks. Such information may help improve the collection of network statistics, including signal strength, reliability, the quick discovery of congested areas and times, weather impacts on service quality, etc. The collected statistics may help network providers to apply enhancements to the system to improve the overall quality of the service without overwhelming the deployed resources. For example, the applied enhancements may include, but are not limited to, automated network load balancing, enhanced service quality, better resource utilization to optimize investment, etc. For example, the network provider may need to access such data after obtaining consent and/or permission from the subscribers to perform such analysis.

### Scenario 2) Network Security

Network security and subscribers' privacy protection may be critical aspects for any network provider. Network providers may have to gather enough data to assess network security, discover vulnerabilities and/or threat points, and/or train AI-based anomaly detection and prevention models. Collecting such information may entail the network provider to regulate the network subscribers' activities to enable accurate timely detection and/or to prevent malicious activities. For example, an international mobile subscriber identity (IMSI) catcher attack invades network subscribers' privacy and broadcasts fake network information by impersonating network resources. Recently, researchers started deploying actual IMSI catching experiments to collect enough data by deploying AI models to protect WTRUs from such a hack. Having precise network analysis and actual data collected over time from WTRUs during network service provisioning may be more accurate and realistic. It is expected that such analysis would lead to discovering new and/or hidden features about the network collected data.

### Scenario 3) Content Offloading

Due to (e.g., massive) increases in on-demand infotainment services, data offloading schemes have been proposed to reduce network providers' heavy and/or redundant traffic. Content offloading may require direct data access between a DO 404 and any DCs 406.

### Scenario 4) Emergency Data Recording/Monitoring

Network infrastructure may either become heavy-loaded and/or may be forced entirely offline during catastrophic emergencies. To guarantee continuous service provisioning during such events, network providers seek all the information about pre- and post-emergency situations to study the impact and optimize resource availability, provide alternative solutions, and attempt to guarantee continuity of the service. Thus, the network providers need to have accessibility to the collected data and events captured when service was offline, such as requested from ad-hoc network services provided during the emergency event or actions captured by multiple witnesses during the emergency.

### Scenario 5) Federated Learning (FL)

Next-generation wireless communication networks are contemplating the integration of ML and AI-based network analysis for real-time decision-making and radio resource management. One promising distributed learning approach is the federated learning (FL) framework considered for the future Internet of Things (IoT) systems. In FL, wireless devices may cooperatively execute a learning task by (e.g., only) uploading a local learning model to a base station (BS) instead of sharing their (e.g., collective) training data. The wireless devices may (e.g., must) exchange local training results and metadata over wireless links to implement FL over wireless networks. The WTRUs and BSs may need to agree on the model parameters' accessibility and manageability methods during this process. In such a scenario, any owners may seek to control the exchanged model parameters and training data. The data accessibility may (e.g., should) be managed in a decentralized fashion and under its owner's control to avoid data loss, manipulation, or redundancy.

For example, one of the data control and access management events may include a (e.g., single) DC 406 requesting access to a piece of data owned by a (e.g., single) DO 404. For example, in scenario 3, a WTRU 102b is capturing some infotainment videos or other content and wants to share such content with the other surrounding WTRUs as a paid infotainment service. In this case, WTRU 102b owns the infotainment video content (thus acts as a DO 404) and is willing to share it with another interested nearby individual WTRUs (e.g., WTRU 102d), which acts as a DC 406.

For example, one of the data control and access management events may include a (e.g., single) DC 406 requesting data access owned by a group of (e.g., cooperating) DOs 404. As shown in scenario 4 in FIG. 7, a group of WTRUs (e.g., WTRUs 102d, 102e) may collaborate to monitor or provide ad-hoc service during a catastrophic emergency in a particular area. The infrastructure, in this case, is assumed to be out of service. The cooperating DOs 404 gather their limited resources and create an ad-hoc network to monitor and provide SOS services. In post-disaster management and analysis, one of the wireless network providers may request access and/or purchase the collected data owned by the group of cooperating DOs 404 (e.g., WTRUs). In this case, the group of DOs 404 may implement a data control and access embodiment to orchestrate their data ownership and its accessibility by the network provider.

For example, one of the data control and access management events may include multiple DCs 406 requesting access to shareable data owned by a single or multiple DOs 404. As shown in scenarios 1 or 2 in FIG. 7, a single or a group of individual DOs 404 (e.g., WTRUs) may analyze network coverage and service reliability within a specific area. Two network providers may cooperate and invest in enhancing network connectivity in this area, share resources reasonably, guarantee subscribers' security, and/or provide load balancing during heavy traffic. Both network providers may need to explore the statistics and previous network measurements accumulated by the volunteering WTRUs to run an AI model. The AI model may optimize the network coverage and predict resource sharing schemes between the cooperating network provider to enhance resources utilization and achieve load balancing. Although the network providers cooperate, they may (e.g., should) not fully trust each other. In this case, both network providers may access the measurement data together (e.g., at the same time) to avoid any conflict of interest. Therefore, the group of DOs 404 may implement a data control and access embodiment to manage the ownership of the collected statistics about network coverage (e.g., the owned data).

As described herein, the terms UE and WTRU may refer to any network subscriber, including mobile users, vehicles with networking capabilities, drones, IoT gateways, and/or edge computing devices, etc.

### Targeted Advertisement Use Cases

Data control and/or access management schemes may include collecting data from wireless network infrastructure and subscribers to support application-specific usages, such as intelligent advertisements delivery. The pertinent information about active WTRUs may include but is not limited to real-time locations, data usage patterns, and/or signal quality, etc. In the case of wireless communication systems, the wireless-related data generation and/or acquisition may be managed by the network provider (e.g., the wireless operator). However, the ownership of the data may reside with a WTRU 102 (e.g., the DO 404). In other words, the WTRU 102 may have or seek the absolute right to validate and control the accessibility of its owned data. For example, a real-time location of a WTRU 102 is measured by its serving gNB 180 using network-assisted positioning. However, due to user privacy concerns, such information (e.g., location information) may be owned by the WTRU 102 and may not be shared with other external entities without consent and/or permission.

As an example, assume a park or other attraction in a particular city, where families and friends may visit to spend time. A company may seek to study visitor activities by collecting analytical data (e.g., shared by the visitors and the wireless operators). For example, analytical data may be acquired to see how people use a wireless network within the parking area. Based on that, the network provider may apply specific wireless network optimizations, such as to address where a new BS may be deployed, what capabilities of already-deployed nearby BSs are available, where network enhancements may be provided due to traffic load (e.g., because many people using video chat data when sitting around the park).

The network provider may apply specific wireless network optimizations to analyze visitors' behavior and/or preferences. The network provider may then deliver certain advertisements (e.g., various entertainment programs offered within the park). Data to be collected is not limited to data related to a particular WTRU application (e.g., which can be directly managed by an application server). Multiple types of wireless data generated in the cellular system may be collected, such as visitors' wireless data usage history, usage pattern, common visited locations in the park, and/or wireless signal strength, etc.

Conventional data control and access management schemes suffer from various shortcomings. For example, the certificate authority model has systematic problems related to certificate revocation, certificate authority governance, and/or security breaches. Reliance on a centralized model with a single entity may be considered a single point of failure. For example, dependencies on a centralized certificate authority may prohibit the participants (DOs 404 and DCs 406) from governing their own digital certificates. System participants cannot control the generation of the PKI policies, roles, authentication mechanisms, and the like. For example, there is no service monitoring that enables linking the PKI-based digital certificates to the holders' actual identity. Any entity can request a valid digital certificate with an authentic public key regardless of its actual identity or the intended service definition. Data ownership would be challenging to be traced, which makes the data prone to be stolen. In other words, any entity could claim ownership of the data if it had a copy of it.

Decentralized data control and access management schemes have been introduced as a promising remedy for the shortcomings present in conventional centralized data control and access management schemes. Existing decentralized data control and access management schemes may suffer from other shortcomings. For example, publishing owned data in the DLS 402 network may not always be practical and may risk data confidentiality. With encrypted data, a sophisticated attacker may still be able to invest time and effort to decrypt and steal the data.

In the Kratos approach, data can be accessed by any other entity just by knowing the data fingerprint (e.g., data hash value). In the Somy et al. approach, the ownership of stored data may be proven through a published list in the DLS 402 network showing who owns what data. The published list shows the hash values of the anonymous addresses of the cloud services hosting the data. This data ownership mechanism may still be vulnerable to creditability transfer and data theft hacks. Any adversary may create a similar list and transfer the data ownership to himself. In August of 2021, a catastrophic poly networks hack exploited this vulnerability. Hence, such a list may be easy to forge, even where the data owner uses a PKI to sign and verify the data ownership proofs.

In certain representative embodiments described herein, a DO 404 may control data accessibility safely (e.g., without being stolen), policies may be implemented that restrict data accessibility, and/or shareable owned data may be associated to a DO's identity.

In certain representative embodiments, SSI may be applied to data control and access management procedures. For example, a (e.g., any) DO 404 may (1) govern both their self-generated PKI published in their controlled DIDDoc 208 and (2) moderate their owned data without the need for any centralized third-party services. A DO 404 may also generate data-specific PKI within an established DIDDoc 208. The DO 404 may control the DIDDoc 208 and/or PKI usage and shareability via a public DID 202 of the DO 404. For example, a (e.g., any) DC 406 may explore data availability from the DLS 402 and/or may request to access such data from a corresponding DO 404. Hence, (e.g., all) data governance may be controlled by the DO 404. Data ownership is linked to a pair of PKI-generated keys generated and controlled by DO 404 in a decentralized manner.

Further, conventional data control and access management schemes rely only on PKI public/private key pair for identifications and verifications. However, when a public/private key pair get compromised, all the related data will be impacted, which may result in data loss and theft. Provisioning of data ownership using PKI alone is still risks data availability and is vulnerable to being stolen or manipulated.

For example, in a wireless communication system, the network subscribers, including WTRUs, IoT devices, and/or edge computing nodes, are resource-limited devices exposed to various physical and network-based attacks. Network subscribers may end up losing the private key of the owned data that corresponds to a DIDDoc 208 stored public key—losing such the secret private key may mean either losing data ownership or exposing the data to being stolen.

Further, conventional data control and access management schemes follow general, fixed, and/or restrictive policies. DOs 404 and DCs 406 are assumed to be trusted after being authenticated. The data access process still suffers from piracy, data illegal reselling, illegal redistribution, ownership claiming, forgery, theft, and data misappropriation. A DO 404 could cause minor changes to the owned data and then create a new DID 202 and DIDDoc 208, claiming unused and unique data. In this case, the DCs may not be fully aware that such data is redundant. Similarly, DCs are also assumed to not be trusted. Shared data still suffers from piracy, data illegal reselling, illegal redistribution, ownership claiming, forgery, theft, and data misappropriation.

In some instances, enabling the generation of multiple different DIDDocs 208 for each piece of owned data may not be practical, especially for limited resources and storage devices.

In view of the foregoing, certain representative embodiments may include a decentralized SSI-enabled data control and access management system to manage the interactions between data owners and data consumers in a trustworthy, traceable, yet secure manner. For example, DOs 404 may have the absolute right to control their owned data (e.g., without the intervention of any external third-party services). For example, DOs 404 may have the ability to grant data accessibility or ownership transfer to the potential DCs in a decentralized manner. For example, the owned data may be linked to the DO's identity and to the DO's PKI information. For example, when the private key is lost, the data associated with the private key may still be retrieved and re-linked to its owner's identity again. For example, ownership of any (e.g., all) owned data may be determined (e.g., traced back).

In certain representative embodiments, procedures may be implemented that identifies data ownership of data without exposing private keys of generated DIDs.

In certain representative embodiments, DCs access to data may be provided (e.g., guaranteed) on condition that the DCs are allowed to access the data. For example, the DCs (e.g., network providers) may (e.g., should) trust the DOs 404 and/or may ensure the integrity of the accessed data. Shareable data may (e.g., should) not be redundant and/or be susceptible to being manipulated and/or faked. For example, the WTRUs (DOs 404) may (e.g., should) trust that the network provider won't sell the gathered data to other parties interested in purchasing subscriber information. In certain representative embodiments, model parameters (e.g., AI and/or ML parameters) and/or training data may (e.g., should) be authentic and not redundant, such as to guarantee accurate FL model performance (e.g., during a system decision making or network spectrum sharing resource utilization).

In certain representative embodiments, a management layer of protection is provided in a decentralized data control and access management system. For example, current and/or next-generation wireless communication networks and/or other data-sharing-oriented applications may easily integrate the data control and access management procedures described herein. For example, representative procedures may facilitate DO 404 actions to govern and control (e.g., all) their owned data, such as in a decentralized and/or trusted environment. For example, representative procedures may facilitate coupling the owned data to the DO's SSI DID, such as to alleviate and/or reduce the usage of the DO's PKI private key. In certain representative embodiments, an access token (e.g., decentralized access tokens) may be associated (e.g., coupled) to the DO's DID, such as without introducing overreliance on the DO's PKI private key for digital signatures.

In certain representative embodiments, procedures may be implemented for trust (e.g., guaranteed absolute trust) among interacting participants (e.g., DOs 404 and DCs), such as the avoidance of exposing the participants private keys and/or risking data availability. For example, induced collisions between a DO's DID 202 and owned data fingerprints may be implemented as described herein. For example, to facilitate (e.g., seamless) data tracing and/or control data access, a DO 404 may (e.g., will) authorize data access tokens with induced hash collision with the accessed data. For example, procedures may include checking on data uniqueness (e.g., before registering it in a DLS 402) to prevent redundancy, piracy, data illegal reselling, redistribution, ownership claiming, and/or forgery. Certain representative embodiments may alleviate the impact of lost PKI private keys and/or render a unified indicator to trace the data ownership to its owner (e.g., without performing heavy cryptography computations).

### Distributed Ledger-Enabled Data Control and Access Management

In certain representative embodiments, a DLS 402 may be employed for decentralized data control and access management. For example, the data control and access management schemes may use identification information, such as SSI information. SSI information may be used to maintain decentralized data control and access management to or by the DLS 402. For example, the SSI and CH techniques may alleviate reliance on the usage of the PKI private key by inducing chameleon hash (CH) collisions to couple (e.g., all) owned data to a DO's DID. In some representative embodiments, the integration between the DLS 402 and CH provided features may ensure data integrity and confirm data ownership without utilizing the DO PKI private key. In certain representative embodiments, a DLS 402 may manage any of service subscriptions, data registrations, and data access procedures.

### Service Subscription Procedure

In certain representative embodiments, a data control and access management system may include a service subscription stage for handling interaction between system participants (e.g., DOs 404/DCs) and/or a system issuer (e.g., an SSI SP). The service subscription stage may implement procedures for maintaining decentralized data control and access management. For example, a DO 404 and/or DC 406 may (e.g., shall) obtain valid VC. For example, the VC may conform to generated CH parameters needed for a coupling process with the owned data and/or future generated access tokens to the owned data.

### Decentralized Data Registration Procedure

In certain representative embodiments, a data control and access management system may include a data registration stage for handling interactions between DOs 404 and/or a provisioned decentralized storage service, such as a decentralized storage platform (DSP). The data registration stage may implement procedures for providing decentralized data coupling services with DO 404 identities (e.g., DO global identifiers such as DO-DIDs). For example, CH-provisioned collisions may be induced between a DO 404 being registered and the DO's DID 202 under the control of the DO 404. For example, any data owned by the same DO 404 will have the same chameleon hash (CH) value linked to the DO's DID. A (e.g., direct) linkage between stored data and the DO's DID 202 may be (e.g., direct) evidence of data ownership, facilitates data traceability, and/or protection from being stolen or tampered with. For example, the linkage between stored data and the DO's DID 202 may reduce the reliance on using the PKI private key for identification and/or authentication requests. The ability to cause CH collisions between the owned data and the DO-DID may indicate cryptographic proof as to data ownership.

### Decentralized Data Access Procedure

In certain representative embodiments, a data control and access management system may include a data access stage for coupling owned data and/or DO's DID 202 to an access token. The data access stage may implement procedures for providing decentralized data access tokens that have the same CH hash value as the DO's DID 202 and/or decentralized stored data fingerprints. For example, the ability to cause CH collisions between owned data, the SSIDO-DID, and any generated data access tokens may be considered solid evidence about the data ownership status and the authenticity of the generated tokens. For example, a DO-DID chameleon hash value may (e.g., should) be the exact value of a SHA256 hash (e.g., of the owned data) and a chameleon hash of any rendered access tokens issued for the requesting data consumer (DC).

### Dual Management Keys to Control Data Ownership

In certain representative embodiments, two (e.g., different and individual) keys may be used, where each key may be used for a certain task. For example, a first key may be a PKI private key used for verifying the digital signatures of data, authentication of DOs 404 and/or DCs, and/or identification of the governance of the DIDDoc 208. For example, a second key may be a chameleon hash (CH) trap door key, which may be used to link data (e.g., all of a DO's owned data) to the DO's decentralized identifier (DID) and couple, any (e.g., all) data access tokens to a same DID 202 in a decentralized fashion. Data activities, traceability, and/or ownership proof may be enhanced with the use of the foregoing keys. In some representative embodiments, system participants may only need to hold two keys (e.g., a PKI private key and a CH trapdoor key) instead of storing various PKI keys for each owned data.

### SSI-Based Data Storage Management

In certain representative embodiments, data storage scenarios may include storing owned data with a DSP and/or storing owned data locally. In certain representative embodiments, procedures may be implemented to discover owned data. For example, owned data may (e.g., must) be registered and checked before being accepted as valid data, such as for data access as described herein.

### SSI-Based Data Ownership Management

In certain representative embodiments, other (e.g., decentralized) data control scenarios, including data ownership transfer and identity revocations, may implement procedures and systems described herein. In some representative embodiments, data ownership transfer may occur, such as where a DC 406 requests purchasing data owned by a DO 404 in order to take full possession of the owned data from the DO 404. In some representative embodiments, an identity revocation event may occur when identity credentials are compromised, stolen, and/or lost.

### Data Access and Control Among Multiple DOs and Multiple DCs

In certain representative embodiments, interactions, such as for data access and/or data control, may occur between single DOs 404 and single DCs, and interactions may occur between and/or among multiple DOs 404 and multiple DCs.

### System Architecture for Distributed Ledger-Enabled Data Access Control Management

In certain representative embodiments, a DO-controlled management layer may be implemented to protect detain decentralized sharing systems. For example, introducing the management layer may reduce reliance on the PKI private keys used for verifications by enabling collision-induced coupling between owned data, generated access tokens, and/or a DO's DID. In some representative embodiments, data access and control management may be enhanced through the use of SSI-based decentralized data-enabled operations and induced chameleon hash collisions, such as for seamless, trustworthy, traceable data sharing models.

In certain representative embodiments, procedures may use chameleon hash (CH) (e.g., functions) for enhancing data control and access management. For example, data coupling may be controlled by a DO 404 by inducing CH collisions between the DO's DID 202 and his data fingerprints. In this way, data ownership is coupled and may be confirmed for the DO, such as under the guidance of the SSI SP or any other third party (e.g., DSP) in a decentralized manner. For example, a DO 404 may be configured to induce collisions between the authorized data access tokens and the owned data and the governed DID 202 hash values. A data access grant may be established by the DO 404 to the DC 406 under the management of a DSP in a decentralized fashion. Any generated access tokens may (e.g., shall) incorporate multiple attributes and pre-arranged access policies that occurred between DO 404 and DC, which may be appended in the DLS 402 before authorizing data access. For example, the DO 404 may (e.g., will) be the only entity controlling and managing all the data activities without risking the governed PKI private key while enhancing the intrinsic decentralized trust between system participants.

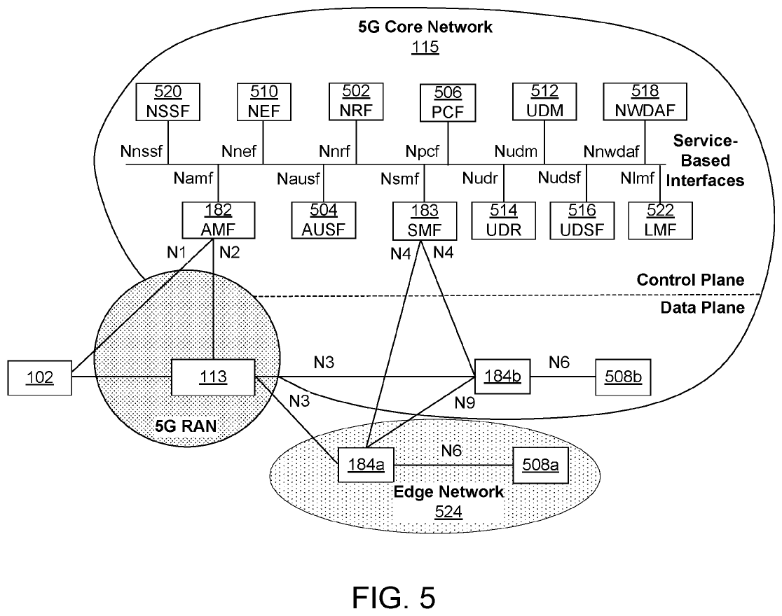

FIG. 8 is a diagram illustrating an example 800 of induced collisions using chameleon hash functions. In certain representative embodiments, a chameleon hash collision may occur, as shown in FIG. 8. For example, during data registration, a DO-governed CH secret trapdoor key may be engaged to cause induced collisions between data fingerprints (e.g., SHA256(Data)) and the DO's governed DID 202 (e.g., DO-DID) at 808. With respect to ownership of the corresponding data, the DO 404 may (e.g., shall) provide correct CHCPP related to the data being registered (e.g., Data-CHCPP). For example, to grant data access, a DC 406 may want to access data owned by a DO 404. In this case, the DO 404 may (e.g., shall) engage the CH secret trapdoor key to compute the needed CHCPP for the access tokens (e.g., token-CHCPP) that causes another hash collision between the pre-agreed access token with the owned data and the identity DO-DID at 810.

In certain representative embodiments, the use of CH collisions may provide any of the following features. Intrinsic data ownership may be demonstrated (e.g., proven) by witnessing the induced collisions between an owned data fingerprint and a DO-DID.

Any interaction involving the data (e.g., granting access token, transfer ownership, applying edits or modifications on data, etc.) may (e.g., will) be backlogged in the DLS 402 and may be validated through the induced collisions without exposing the data ownership.

The ability to retrieve data ownership if the PKI private key is lost and/or compromised. In this case, the ability to prove governance on the CH trapdoor key may be an alternative identification method to recover data and enable relinking them with the DO's (e.g., new) PKI upon system approval. In this way, the DO 404 may (e.g., shall) prove to the DSP and the SSI SP the ability to cause collisions with the stored data. In this case, the SSI SP may (e.g., will) re-issue the DO's VC. After, the DO 404 may (e.g., will) relink the owned data to the new VC.

The ability to retrieve data ownership in cases where the CH trapdoor key is lost and/or compromised. Losing the trapdoor key may (e.g., will) not risk losing data ownership, as the ability to prove governance of the corresponding PKI private key within the DO's DIDDoc 208 would facilitate the recovery process of the data ownership.

The ability to retrieve data ownership, such as when the PKI private key and CH trapdoor key have been compromised and/or lost. Data registration and linkability may use the induced chameleon hash collisions to ease data ownership retrieval. The ability to provide and prove know-how of identity-relatable private information using pre-management credentials (e.g., an ID used during the user subscription to the network provider, contracts used during the cooperation between two wireless network corps) would facilitate the recovery of the lost data ownership. In this case, the DO 404 may (e.g., will) request revoking of the old DID 202 and may relink all the owned data to the newly generated DID.

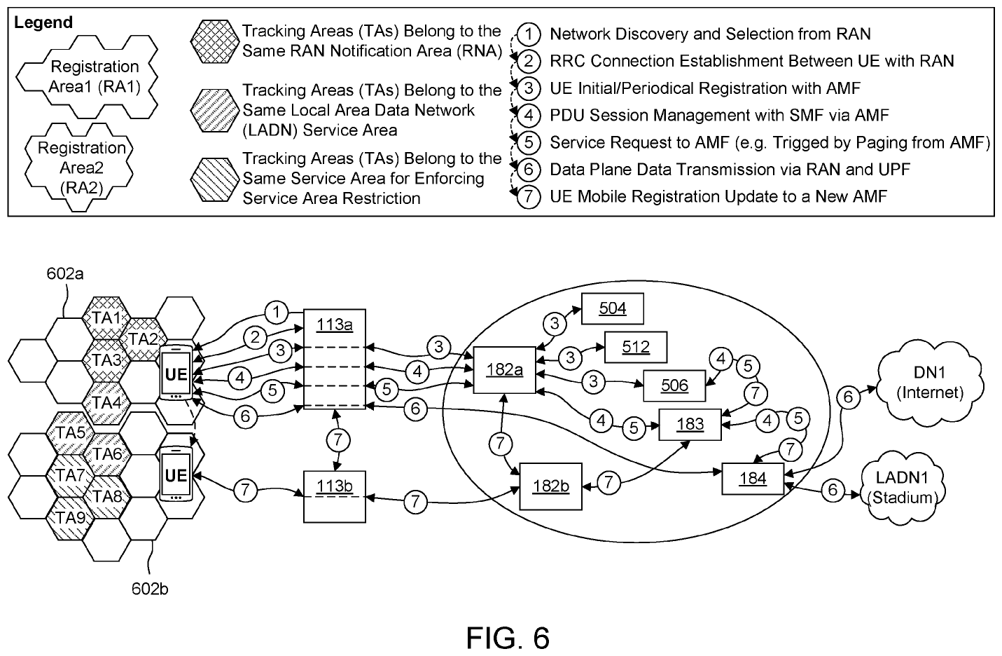

FIG. 9 is a flow diagram illustrating an example procedure for the overall architecture of the proposed SSI-enabled data control and access management. As shown in FIG. 9, the system participants are Data Owner (DO) 404, Data Consumer (DC) 406, Decentralized Storage Platforms (DSP) 902, a DLS 402 and SSI service provider (SSI SP) 904. All the system participants (e.g., DOs 404 and/or DCs 406) may (e.g., should) be SSI holders (e.g., users) configured with (e.g., governing self-generated) DIDs 202 and DIDDocs 208, referred to as DO-DID, DO-DIDDoc, DC-DID, and DC-DIDDoc, respectively. To join the data control and access management service, the system participants (e.g., all DOs 404 and/or DCs 406) may (e.g., should) obtain valid VCs from the system SSI Service Providers (SSI SP) 904. For example, the SSI SP 904 may perform SSI issuing and/or provisioning of VC information.

In certain representative embodiments, a DO 404 may be an entity that owns shareable data. For example, a DO 404 may generate various data (e.g., WTRU location, service coverage, QoS status, uplink/downlink data rates, etc.). A DO 404 may be assumed to be willing to share the collected data with any interested DCs 406 (e.g., in a decentralized fashion).

In certain representative embodiments, a DC 406 may be an entity that intends to access data owned by one or more DOs 404. For example, a mobile application (e.g., a DC entity) may be interested in accessing data related to network statistics or WTRU-related information, such as data owned by a WTRU 102 and/or a network provider (e.g., a DO entity). For example, a DC 406 may be interested in data from available DOs 404, such as by renting (e.g., temporarily accessing the data) and/or purchasing the data (e.g., permanently obtaining ownership of the data and becoming its DO).

In certain representative embodiments, an SSI SP 904 may be an entity issuing identity VCs and/or proofs to DOs 404 and/or DCs 406. An SSI SP 904 may be a trusted authority responsible for registering public information of DOs 404 and/or DCs 406 in the DLS 402 network.

In certain representative embodiments, a DLS 402 may be an entity to store various identity management and data control-related information, such as DIDDocs 208. For example, a DLS 402 may be a platform which manages a distributed ledger to store the information and/or documents related to the system participants.

In certain representative embodiments, a DSP 902 may be an entity that stores the (e.g., actual) data shared by a DO 404 to a DC 406. For example, a DSP 902 may interact with a DLS 402 during the data registration process to create relatable transactions about data ownership and data registration public parameters.

As shown in FIG. 9, SSI-enabled and DLS-based interactions may occur between system participants (e.g., in three stages—service subscription, data registration, data access).

### Service Subscription Stage

At 906 in FIG. 9, a DO 404 may send a subscription request to join a data control and access management system. For example, the subscription request may be sent to an SSI SP 904 to issue a subscription VC data. For example, a proof for such a subscription may be appended in the DLS 402.

The SSI SP 904 may process the received request from the DO 404. Before issuing the VC, the SSI SP 904 may (e.g., will) authenticate DO DID identity (e.g., Auth(DO-DID)) at 908. Once validated, the SSI SP 904 may (e.g., will) start issuing the requested VC and/or may compose the DO's subscription DIDDoc 208 (DO-sub-DIDDoc) at 910. The sub-DIDDoc may (e.g., will) include public information about the DO subscription process and CH generated public parameters (CHPP) of the DO 404. After the SSI SP 904 finishes the generation of DO-sub-DIDDoc, the SSI SP 904 may publish it in the DLS 402 (e.g., as a smart contract). For example, the smart contract may be publicly accessed by anyone and/or may only invoked by the SSI SP 904. For example, an address of the published DO-sub-DID may be referred to as its corresponding DO-sub-DID.

### Data Registration Stage

At 912, the DO 404 may start collecting his owned data. For example, the DO 404 may be a WTRU 102 in a wireless communication mobile network. The DO 404 may volunteer and/or be configured to help the service provider collect extra statistical information, such as information relating to network status and stability in various locations. The DO 404 may share and/or sell the collected data to the network provider as statistical testing data for analysis.

At 914, the DO 404 may (e.g., first) register the owned data to be able to share it and/or monetize the data. For example, the DO 404 may send a request to the DSP 902 to store the owned data. The DO 404 may attach in the registration request the DO-sub-DID that includes all the needed information to establish identification and authentication checks (Auth(DO-DID)). For example, the DO 404 may attach the induced CHCPP (Data-CHCPP) computed to cause collisions between the data fingerprint CH value (Data-CH) and the DO-DID CH hash value (DO-CH).

At 916, after the registration request, the DSP 902 may authenticate the DO 404 (e.g., first) through the Auth(DO-DID) process. The DSP 902 may then verify collisions between received Data-CH and DO-CH published in the corresponding DO-sub-DIDDoc. After, the DSP 902 may accept storing data and may create a corresponding Data-DIDDoc. For example, the Data-DIDDoc may be a smart contract confirming the DO data ownership. For example, the Data-DIDDoc may be accessed publicly for viewing and/or information retrieval. The Data-DIDDoc may be (e.g., only) invoked for parameter modifications by the DSP 902.

At 918, the DSP 902 may then deploy the Data-DIDDoc in the DLS 402 and use the corresponding Data-DIDDoc address as the Data-DID.

### Data Access Stage

At 920, a DC 406 may explore and discover data. For example, the DC 406 may (e.g., will then) send a data access request to a DO 404.

At 922, after the data access request is accepted by the DO 404 (e.g., WTRU 102), both DO 404 and DC 406 may identify and/or authenticate each other (e.g., Auth(DO-DID) and Auth(DC-DID). After, the DC 406 and DO 404 may (e.g., will) negotiate and confirm a data access agreement and/or accessibility policies. Once completed, the DO 404 may (e.g., will) generate an access token (e.g., Token_args) for the DC 406. The DO 404 may induce a CH collision between the generated access token hash (e.g., Token-CH) and the governed DID 202 (e.g., DO-CH). Such a collision may occur by computing CHCPP for the generated token (e.g., Token-CHCPP).

At 924, the DC 406 may (e.g., will) submit the obtained access token (e.g., Token_args), the Data-DID, the received Token-CHCPP, and the DC-sub-DID to the DSP 902. For example, a request to access DO data may include and/or indicate any of the obtained access token (e.g., Token_args), the Data-DID, the received Token-CHCPP, and the DC-sub-DID.

At 926, the DSP 902 may (e.g., will) perform authentication and verification checks to grant the DC data accessibility. For example, the DSP 902 may compute (e.g., Auth(DC-DID)), and then verify a collision between the DO-CH and the Token-CH before granting the DC 406 access to the data owned by the DO 404.

In certain representative embodiments, system transactions should be published and/or validated (e.g., prior to data access). Data accessibility may be based on the generated data access token attributes (e.g., Token_args). The token attributes (e.g., Token_args) may be determined based on a (e.g., predetermined and/or negotiated) agreement between the DO 404 and the DC 406, and may be published within DLS 402. The DSP 902 may not provide any data accessibility until the DC 406 provides a valid token with the announced attributes. For example, the DLS may be a public ledger, a private ledger, a federated ledger and/or a consortium ledger. For example, a data fingerprint of data may be a (e.g., unique) hash value corresponding to the data.

In certain representative embodiments, X-DID may refer to a globally identified SSI identifier. For example, a X-DID may be resolvable to its corresponding X-DIDDoc of an entity X (e.g., DO 404 or DC 406). The X-DID and/or X-DIDDoc may (e.g., shall) be registered in the DLS 402.

In certain representative embodiments, any X-DID and/or the associated X-DIDDoc may resolve participants' PKI information. For example, the PKI information alone may be assumed to be insufficient to access data by the system participants. The DO 404 and DC 406 may be assumed to be subscribers to a service system. For example, a subscription may bind participants (e.g., DOs 404 and/or DCs 406) to possess specific identity SSI VCs issued by the SSI SP 904. An issued VC may be considered a subscription identification token, and/or may be used to relate some private information about the actual identity of the participant. For example, in wireless communication networks, VCs may represent and/or be associated with WTRU SUPI, date of birth, and/or other relatable subscription information related to the participants only.

In certain representative embodiments, an X-sub-DID may represent a sub-DIDDoc appended in the DLS 402 (e.g., after being confirmed and broadcasted to the DLS network).

In certain representative embodiments, Data-DIDDoc and Data-DID may respectively represent the appended information in the DLS 402 (e.g., by the DSP 902 during the data registration stage) and the address of the appended information in the DLS 402.

In certain representative embodiments, a X-CH may refer to the computed CH value for a parameter X.

In certain representative embodiments, a X-CHCPP may refer to a set of the chameleon hash collision public parameters. The CHCPP may be computed by the trapdoor holder (e.g., DO), such as when new data or new data access tokens are determined (e.g., generated) by the DO 404.

### Information Elements

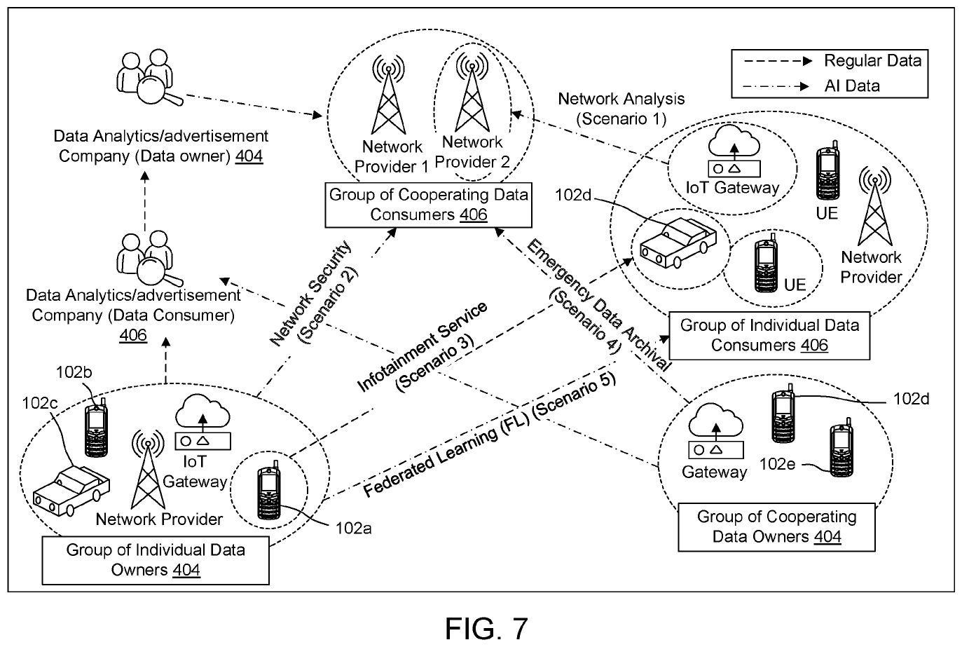

FIG. 10 is a diagram illustrating example procedures for data control and access management and example information elements which may be used therein.

In certain representative embodiments, an X-DID 1002 may refer to a participant X's (e.g., DO 404 or DC 406) self-generated global SSI identifier. Any participant in the system may (e.g., should) have a valid DID 202. As examples, the terms DO-DID and DC-DID represent the data owner and consumer (e.g., SSI-generated) DIDs 202.

In certain representative embodiments, an X-DIDDoc 1004 may refer to a decentralized document associated with the (e.g., SSI-generated) X-DID 1002. An X-DIDDoc 1004 may include (e.g., all of) the public information about its holder's general identity. For example, the public information may include any of verification public keys, type of authentication used, corresponding X-DID values, timestamp, status, and/or type of service provided. For example, a DO-DIDDoc may refer to a DO's generated DIDDoc 208, while a DC-DIDDoc may refer to a DC's governed DIDDoc 208.

In certain representative embodiments, an X-sub-DIDDOC 1006 may refer to a smart contract deployed by an SSI SP 904 for a new participant X (e.g., willing and/or requesting to subscribe to the provided data control and access management service). For example, a X-sub-DIDDoc 1006 may include any of the issuer's DID 202, the holder's DID 202, timestamp, type of issued VC, status, generated CHPP, generated CHCPP, CH value of holders (DO or DC) DID 202, and/or proof of issuance signatures. For example, DO-sub-DIDDoc and DC-sub-DIDDoc may refer to the subscription DIDDoc 208 generated by SSI SP 904 to DOs 404 and DCs 406, respectively. For example, DO-CHPP and DO-CHCPP may refer to CH public parameters (e.g., p, q, g, Yᵤ) and CH collision public parameters seed (e.g., aᵤ, bᵤ) used to compute the CH value of DO-DIDs, respectively. In certain embodiments, an X-sub-DIDDoc may be accessed publicly (e.g., anyone in the network can access and/or extract X-sub-DIDDoc information). In certain other embodiments, an X-sub-DIDDoc smart contract may be configured to allow (e.g., only) the SSI SP 904 to invoke it and apply the needed parametric changes.

In certain representative embodiments, an X-sub-DID 1008 may refer to the X-sub-DIDDoc 1006 address in the DLS 402 after being confirmed and broadcasted to the DLS network. DO-sub-DID and DC-sub-DID in this context define the addresses of the DO-sub-DIDDoc and DC-sub-DIDDoc, respectively.

In certain representative embodiments, Data-DIDDoc 1018 and Data-DID 1016 may refer to the smart contract deployed by DSP 902 during the data registration stage and its address in the DLS 402, respectively. For example, a Data-DIDDoc 1018 may be deployed by an SSI SP 904. For example, a Data-DIDDoc may include any of DO-DID, DO-sub-DID, data hash (e.g., SHA256(Data)), Data-CHCPP, accessibility type, one or more data descriptors, and/or status. For example, a Data-DIDDoc 1016 as a smart contract may be public (e.g., any participant may extract public information from the Data-DIDDoc, and only the DSP 902 and/or SSI SP 904 may invoke and/or apply changes to its content if needed)

In certain representative embodiments, an X-CH 1010 may refer to a computed CH value (e.g., for the DO parameters). For example, the CH value of a DO DID 202 may be denoted as DO-CH. The data fingerprint (SHA256(Data)) and Token CH values may be denoted as Data-CH and Token-CH, respectively. For example, DO-CH, Data-CH, and Token-CH equality may (e.g., should) be satisfied for successful and legitimate data control and management.

In certain representative embodiments, a Data-CHCPP 1012 may refer to the chameleon hash collision public parameters (CHCPP) (e.g., au′, bu′). For example, a Data-CHCPP may be computed by a DO 404 during the data registration process. For example, a Data-CHCPP calculation may use a CH trapdoor key owned by the DO 404. As an example, the Data-CHCPP calculation may be determined as follows:

DO−CH=CH.Hash(DO−DID,aᵤ,bᵤ,p,q,g,Yᵤ)

(aᵤ′,bᵤ′)=CH.Col(Xᵤ,DO−CH,SHA256(Data),p,q,g)

In certain representative embodiments, a Token-CHCPP 1014 may refer to the chameleon hash collision public parameters (e.g., aᵤ″, bᵤ″) computed by the DO 404 for the DC, such as during the data access procedure. For example, a Token-CHCPP calculation may use the CH trapdoor key owned by a DO 404 and Token_args, which may be specified during or by a data access agreement. As an example, a Token-CHCPP calculation may be determined as follows:

(aᵤ″,bᵤ″)=CH.COL(Xᵤ,DO−CH,SHA256(Token_args),p,q,g)

In certain representative embodiments, interactions between participants may use (e.g., require) verification and/or authentication procedures before any service provisioning and/or accessibility may be granted. The following functions may be used in verification and authentication.

### Authorization and Verification

In certain representative embodiments, Auth(X-DID) may refer to the process of authenticating a DID 202 submitted by a participant or an entity X (e.g., a DO 404 or a DC). For example, Auth(X-DID) may authenticate and/or verify an entity X which is (e.g., purportedly) claiming ownership of the provided DID. For example, a new DO 404 may subscribe to the system and may need to submit a valid DO-DID associated with their governing DO-DIDDoc (e.g., to the SSI SP 904). The SSI SP 904 may extract the public information included in the DO-DIDDoc requested to ensure the authenticity of the DO 404.

For example, an example of an Auth(X-DID) process may include any of the following (e.g., considering an SSI SP 904 is executing Auth(DO-DID) on DO-DID). A DO 404 that may request the service submits his DO-DID to the SSI SP 904. The SSI SP 904 may resolve the DO-DIDDoc corresponding to the submitted DO-DID and extract the associated public key and authentication scheme provided in the DO-DID. The SSI SP 904 may send a time-stamped challenge (e.g., a generated random number) encrypted by the holder's (e.g., the DO 404) public key using the authentication scheme determined in the DIDDoc 208. The holder's (e.g., the DO 404) ability to solve such a challenge may confirm the authenticity of the holder (e.g., the DO 404) and ensures the holder's authentic identification.

Other DID 202 authentication mechanisms and/or procedures may be implemented in other representative embodiments.

In certain representative embodiments, Verify_VC may refer to the process of verifying VC content, ensuring its authenticity, and/or identifying the holder of VC. For example, Verify_VC may be used during data registration, such as where a DSP 902 first needs to verify a DO's VC before accepting to register data owned by the requesting DO 404.

For example, an example of a Verify_VC process may include any of the following (e.g., considering the DSP 902 is verifying VC for a DO 404). A DO 404 that may request the service submits his DO-sub-DID that conforms the DO subscription DIDDoc 208 that is obtained during the subscription stage and a copy of the DO's VC to a DSP 902. The DSP 902 may resolve the DO-sub-DIDDoc corresponding to the submitted DO-sub-DID. The DSP 902 may check the SSI SP 904 signature in the VC issuance proof stored in the DO-sub-DIDDoc. The DSP 902 may validate the received VC integrity, such as by comparing the digitally signed hash value created by the SSI SP 904 and the received hash value from the DO 404.

Other VC verification mechanisms and/or procedures may be implemented in other representative embodiments.

In certain representative embodiments, Verify_Collision (X₁-CH, X₂-CH, . . . , Xₘ-CH) may refer to a verification process (e.g., when a DO 404 wants) to induce collisions using a (e.g., DO's) CH trapdoor key. A DO 404 may (e.g., must) submit computed CHCPP that cause collisions between an element (e.g., data and/or token fingerprints) needed to be coupled with the DO's SSI DID hash value. Verifying collisions may require knowledge of CH attributes, including CHPP for the collided elements.

For example, verifying collisions between a DO-DID chameleon hash value (DO-CH) and a data fingerprint (e.g., SHA256) hash value (Data-CH) may require knowledge of DO-CHPP, Data-CHCPP, DO-CHCPP, SHA256(Data), and DO-DID. As an example, a Verify_Collision (Data-CH, DO-CH) function, such as may be used during a data registration procedure, may be represented as:

CH.Hash(DO−DID,Yᵤ,g,p,q,g,aᵤ,bᵤ)

=CH.Hash(SHA256(Data),Yᵤ,g,p,q,g,aᵤ′,bᵤ′)

Here, the Verify_Collision(Data-CH, DO-CH) may confirm whether the DO-CH is equivalent to the Data-CH or not.

As another example, a Verify_Collision (Token-CH, DO-CH, Data-CH) function may be used during a data access procedure. The DC 406 may be required to determine a data access token (Token_args) computed by the DO 404 during a data access request and submit it to a DSP 902. As an example, a Verify_Collision(Token-CH, DO-CH, Data-CH) function, such as may be used during a data access procedure, may be represented as:

CH.Hash(DO−DID,Yᵤ,g,p,q,g,aᵤ,bᵤ)

=CH.Hash(SHA256(Data),Yᵤ,g,p,q,g,aᵤ′,bᵤ′)

=CH.Hash(Token_args,Yᵤ,g,p,q,g,aᵤ″,bᵤ″)

Here, use of the Verify_Collision function may verify whether the DO-CH value is equivalent to both the Data-CH and Token-CH values or not.

In certain representative embodiments, Data_uniqueness may refer to a process to indicate whether or not registering data has not been published before, tampered with and/or stolen from another DO 404. For example, Data_uniqueness may be used by either a DSP 902 and/or SSI SP 904. For example, a data fingerprint of data (e.g., SHA256(Data)) may be compared to the other already stored data fingerprints (e.g., within the scope of the DSP 902). The data may be redundant on condition that the comparison results obtained fingerprints similar to (e.g., the same as) the data fingerprint value. In contrast, the data may be unique (e.g., within the management layer) on condition that no other data is found to have the same fingerprint as it. Other mechanisms and/or procedures may be implemented in other representative embodiments, such as using an AI model to crawl and verify the similarities or differences between received data content, description, attributes, size, etc.

In certain representative embodiments, Revoke(X-VC) may refer to a subscription VC process. Revoke(X-VC) may be managed and/or used by an SSI SP 904. For example, Revoke(X-VC) may be applied due to one or more of the following reasons. A DSP 902 may discover data manipulations and/or redundancy during the data_uniqueness check during the data registration stage. A DO 404 may indicate and/or report that another participant stole their data. A DC 406 may indicate and/or report misleading data is published by a DO 404. A DO 404 may indicate and/or report that a DC 406 misused the owned data and/or did not follow the agreement obtained within the data access stage. Any system entities may report the manipulation, loss, and/or theft of their identity-related information.

For example, Revoke (X-VC) may terminate a participant X's (e.g., DO 404 and/or DC 406) service subscription, either temporarily or permanently, according to an SSI SP 904 decision. Once an SSI SP 904 receives a report indicating a need to invoke “Revoke(X-VC),” the SSI SP 904 may investigate the action until concluding to either revoke or apply changes to a corresponding X-sub-DIDDoc. The X-sub-DIDDoc links (e.g., most or all) public information about the revoked participants. That is, the X-sub-DIDDoc links all the owned data tied to the participant X's DIDs. SSI SP 904 may terminate the participant X's subscription by invoking the X-sub-DIDDoc and by changing the status from an active to an inactive (e.g., revoked) indication. Additionally, the SSI SP 904 should specify with a time-stamped and digitally signed description the reasons for revoking the VC in the X-sub-DIDDoc.

As described herein, the terms “invoke”, “execute”, “compute”, “obtain”, and “determine” may be used changeably as an indication of performing the acts corresponding to the function being used. For example, statements like “SSI SP 904 invoked the Revoke(X-VC) function” or “DSP executed the Verify_Collision function”, or “DC computed the Auth(DO-DID) process” may refer to the acts thereof being performed by the corresponding entity and/or participant.

### Decentralized SSI-Enabled Data Control and Access Management System-Single DC Case

In certain representative embodiments, data control and access management for single DC 406 use cases may include a data subscription stage, a data registration stage, and a data access stage. For example, the data subscription stage may include the participants subscribing to the system, receiving their VC, and determining their chameleon hash public parameters (CHPP). For example, the data registration stage may include the DO 404 registering their owned data to the DSP 902 and linking their owned data to their DID. For example, the data access stage may include where the interactions between the DO 404 and DC 406 are managed in a decentralized and secure way.

### Service Subscription Stage

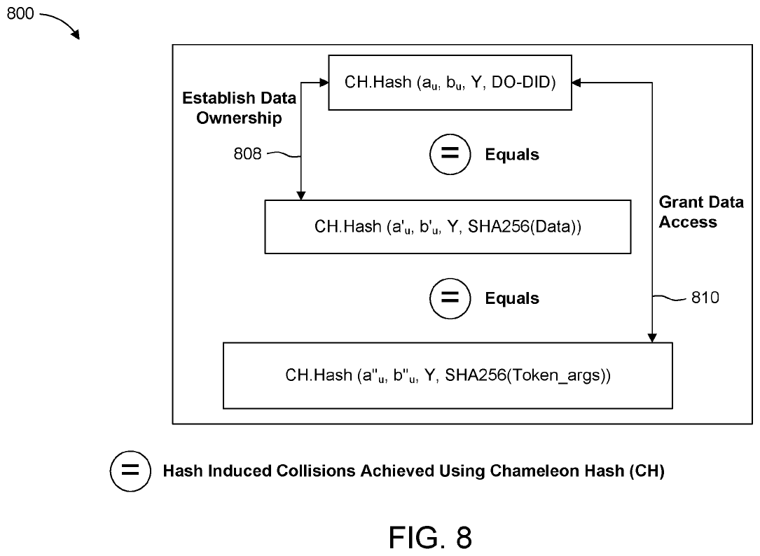

FIG. 11 is a flow diagram illustrating an example procedure for service subscription. In certain representative embodiments, it may be assumed that an (e.g., any) entity may not conduct data access-related activities unless it holds a valid VC (e.g., issued by the SSI SP 904). For example, a wireless communication service provider may be deployed to provide decentralized SSI-enabled data sharing as described herein. The wireless communication service provider may act as an SSI SP 904, which issues VCs for (e.g., new) network subscribers (e.g., WTRUs). An issued VC may contain a device subscription token and/or other relatable identity information required to confirm identity claims (e.g., of the token holder). For a DO 404 and/or a DC 406 to register and/or access specific data within the system, the DO 404 and/or DC 406 may (e.g., shall) first prove its ownership to an issued VC by the SSI SP 904 to prove its identity. In some representative embodiments, the proof of VC ownership may be verified using the Verify_VC process described herein.

In some representative embodiments, the system may make service subscription mandatory for all participants (e.g., DOs 404 and/or DCs 406).

In FIG. 11, a service subscription procedure is shown for a DO 404. A similar service subscription procedure may be performed by a DC 406 to join the system. As shown in FIG. 11, the service subscription stage may be initiated by a DO 404 to join the system. During the service subscription, the DO 404 may (e.g., shall) first prove a real identity claim to the SSI SP 904, such as where the DO 404 does not have any previously issued identity credentials recognized by the SSI SP 904. For example, a DO 404 may be a network subscriber WTRU 102, who may first provide their IMSI and/or SUPI identifier to the network and then may receive SSI credentials issued by SSI SP 904. For example, new participants may not be able to store any data in the DSP 902 until the SSI SP 904 publishes a corresponding DO-sub-DIDDoc (e.g., the issuance process deployed smart contract) in the DLS 402 and obtains a corresponding DO-sub-DID. Hence, a DO 404 may first generate a DO-DID to represent their identity and associate it with their DO-DIDDoc to show the encryption scheme and PKI key pair details, as described herein.

At 1102 in FIG. 11, a DO 404 may or should have an SSI-generated DO-DID associated with a valid DO-DIDDoc (e.g., to store owned data). In certain representative embodiments, the DO 404 may attach a corresponding DO-DID to (e.g., within) a request (e.g., a service subscription request) and submit the service request to the SSI SP 904. For example, the DO 404 may generate CH parameters (e.g., using the CH.Gen function) and send the resulting DO-CHPP to the SSI SP 904 (e.g., within the request).

At 1104, once the request (e.g., the subscription request) is received, the SSI SP 904 may proceed to validate the authenticity and ensure the validity of DO's identity. For example, the SSI SP 904 may invoke the Auth(DO-DID) function to validate the authenticity and ensure the validity of DO's identity. In certain representative embodiments, the SSI SP 904 may select two (e.g., random) numbers as values for aᵤ and bᵤ as a DO-CHCPP seed. For example, the DO 404 may obtain the CHPP after executing the CH.Gen algorithm shown in FIG. 3. The SSI SP 904 may be responsible for computing the first and initial seed for the CHCPP (aᵤ, bᵤ). The CHCPP maybe generated by the SSI SP 904 as two random numbers. The CHCPP may be used as described herein when induced collisions are obtained to couple owned data and access tokens to a DO identity (e.g., DO-DID). For example, the CHCPP may be recalculated by the DO 404 to induce the collisions when the DO 404 registers his owned data with the DSP 902 and/or during the access token calculation obtained for the DC data accessibility. After, the SSI SP 904 may compute the CH value of DO-DID (DO-CH) as described herein and considering DO-DID as m₁. The SSI SP 904 may generate the requested subscription VC. For example, the SSI SP 904 may compose a DO-sub-DIDDoc transaction as described herein.

At 1106, once the VC for the DO 404 is generated, the SSI SP 904 may deploy the DO-sub-DIDDoc (e.g., a smart contract) in the DLS 402. Once the transaction is confirmed, an address of the DO-sub-DIDDoc will be registered within the SSI SP 904 (e.g., internal database). The address of DO-sub-DIDDoc in this context may be referred to as a DO-sub-DID.

At 1108 in FIG. 11, after publishing the DO-sub-DIDDoc in the DLS 402, the SSI SP 904 may send the issued VC and the corresponding DO-sub-DID to the DO 404.

### Data Registration Stage

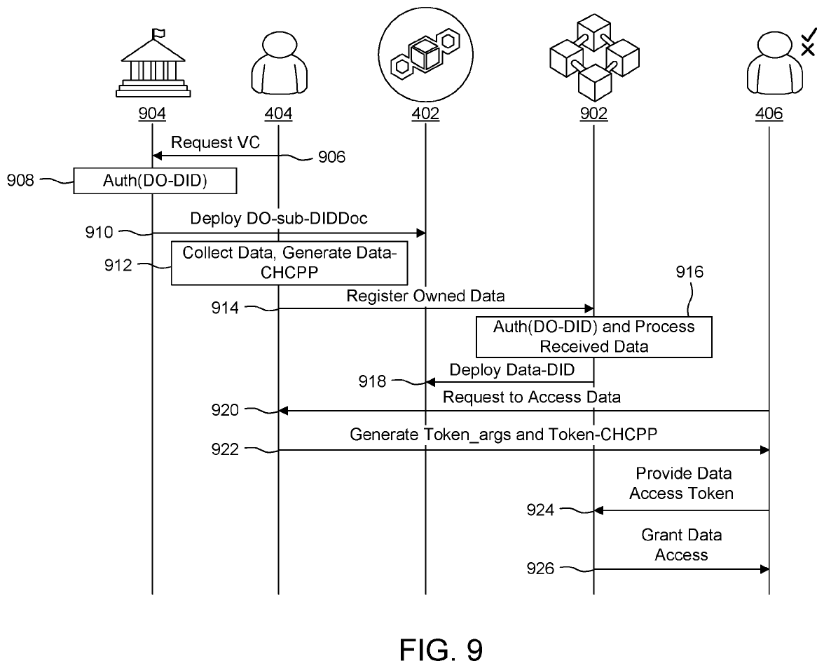

FIG. 12 is a flow diagram illustrating an example procedure for data registration.

In certain representative embodiments, data ownership may be established and tied to the DO-DID in the data registration stage. For example, to register owned data, the DO 404 may compute the Data-CHCPP, which induces intentional collisions between data Data-CH and DO-CH since the equivalence of DO-CH and Data-CH establishes the data ownership, as shown in FIG. 8, for example. Here, data may be registered and the Data-CHCPP parameters (aᵤ′ and bᵤ′) may be found which cause coupling with the DO-DID. According to the data ownership status and usability type, the Data-CHCPP calculation may differ. For example, the data may be owned by one DO 404 or multiple DOs 404 simultaneously. For example, a DO 404 may have the right to outsource the data or keep it locally.

In certain representative embodiments, a single DO 404 may own the data. In that case, the DO 404 may be responsible for computing (e.g., all) the relatable information about data, data fingerprint, and calculating the needed Data-CHCPP (e.g., using the CH.Col function).

In certain representative embodiments, multiple DOs 404 may own the data. In such a case, the data fingerprint and all the needed information may be handled through a secure multi-party computation (SMC) process to involve all the DOs 404.

In certain representative embodiments, a DO 404 may prefer to outsource owned data to an external storage platform like a DSP 902. In this case, the DSP 902 may manage data processing and announcements during the data registration process. The created transaction about the data may be a Data-DIDDoc (e.g., a smart contract deployed by the DSP 902). The DO 404 may have the right to either control data themselves and/or delegate the DSP 902 to perform the data access control process on behalf of and/or controlled by the DO 404.

In certain representative embodiments, a DO 404 may prefer to store owned data locally. In that case, the DO 404 may request the SSI SP 904 to deploy the Data-DIDDoc. After, the DO 404 may manage all the data access requests.

For example, a single DO 404 may perform registering of data and generating its CH fingerprint. The data may be stored in the DSP 902. To compute the Data-CH, the DO 404 may incorporate the owned private trapdoor Xⱼ in the process to cause the needed collisions between the DO-DID and owned data fingerprint (e.g., SHA256(Data)). Such a collision process results in different Data-CHCPP, which are (aᵤ′, bᵤ′) for each piece of data. For example, this may allow granular access control to each piece of data. In certain representative embodiments, the collision information may be computed using the CH.Col function described herein. For example, m₂ may be determined as SHA256(data) and h as the DO-CH value. Those skilled in the art should understand that (e.g., all) the data owned by a same DO 404 may have a same CH value as the DO-DID. The distinguishability between different data will be through the collision resistant hash value (e.g., SHA256(x)) and different Data-CHCPP values. A hash value (e.g., SHA256(Data)) may be used as a reference or index (e.g., data pointer) within the DSP 902 once the data is validated to be stored.

As shown at 1202 in FIG. 12, before requesting any decentralized storage, the DO 404 prepares the owned data, which may include a digital signature and computing the Data-CHCPP to cause a collision with the DO-CH. For example, the DO 404 may encrypt the owned data using the DO's private key to generate a digital signature for the data. Another participant and/or entity receiving the data and the corresponding digital signature may use the DO's public key to verify that the digital signature was generated by the DO 404 and/or that the data has not been tampered with.

At 1204, after the data preparation is complete, the DO 404 may send a request (e.g., data registration request) to the DSP 902. The data registration request may (e.g., should) include the DO-sub-DID and may include the VC (e.g., if needed), by which the DSP 902 can verify the validity before accepting the request.

At 1206, after the information about the DO's identity is received, the DSP 902 may retrieve the corresponding DO-sub-DIDDoc associated with the received DO-sub-DID. For example, the DSP 902 may extract the needed information about the DO 404, such as DO-DID, DO-DIDDoc, DO-CHPP, public keys, authentication scheme, etc.

At 1208, the DSP 902 may invoke the Auth(DO-DID) function and/or the Verify_VC function. On condition that the DO-DID is valid and/or authentic, the DSP 902 may send (e.g., respond with) a request to the DO 404 to send the data content and the related information. On condition that the DO-DID was not valid and/or authentic, the DSP 902 may terminate the registration and reject the DO request that was submitted at 1202.

At 1210, on condition that the identity credentials submitted by the DO 404 were authentic at 1208, the DSP 902 may then request the DO 404 to send the owned data content and the data content hash information (e.g., SHA256(Data)) for linking the data hash information to the DO-DID.

At 1212, after the request at 1210 for the owned data content and the information for linking the data to the DO-DID is received, the DO 404 may establish a secure session (e.g., SSL, TLS, DTSL, etc.) with the DSP 902 to send the digitally signed data, the calculated Data-CHCPP, the data accessibility type options (e.g., Rent and/or Purchase), and/or a brief description of the data attribute (e.g., used for discovery). For example, the DO 404 may send the data digital signature which is signed using the DO's PKI private key corresponding to the public key published within the DO-DIDDoc. For example, the data accessibility type may represent (e.g., indicate) how the DO 404 prefers any interested DCs 406 to access the registered data (e.g., data rental to support temporary data access or data ownership transfer to support permanent data ownership transfer, or both—rent data until an interested DC 406 requests to purchase it).

At 1214, after the data is received, the DSP 902 may verify the data integrity. In certain representative embodiments, the DSP 902 may calculate a fingerprint of received data (e.g., SHA256(Data)) and then use the data_uniqueness function. On condition that the data is non-redundant (e.g., unique), then the DSP 902 may continue the data registration. On condition that the data is redundant (e.g., not unique), the DSP 902 may terminate the process and submit an incident to the SSI SP 904 to revoke the VC, such as by invoking the Revoke(DO-VC) function.

At 1216, after verifying the data, the DSP 902 may verify whether the received Data-CHCPP is valid. For example, the DSP 902 may invoke the Verify_Collision(Data-CH, DO-CH) function.

At 1218, after validation, the DSP 902 may deploy the Data-DIDDoc (e.g., as a smart contract). For example, the DSP 902 may assign any (e.g., all) public parameters. For example, by structuring the Data-DIDDoc to be a smart contract, the Data-DIDDoc may include and/or indicate the logic of any future readjustments or ownership transfer requests. In certain representative embodiments, a smart contract may allow anyone publicly to access and extract needed information from it, however only the DSP 902 may invoke the smart contract to change its parameters under DO acceptance and control. Any (e.g., all) of the interactions with the smart contract may be stored and validated within the DLS 402.

At 1220, the DSP 902 may attach the Data-DID to the DO 404 as a response to the request (e.g., data registration request) sent at 1202. For example, the DSP 902 may keep a copy of the Data-DID (e.g., within a local storage database).

### Data Access Stage

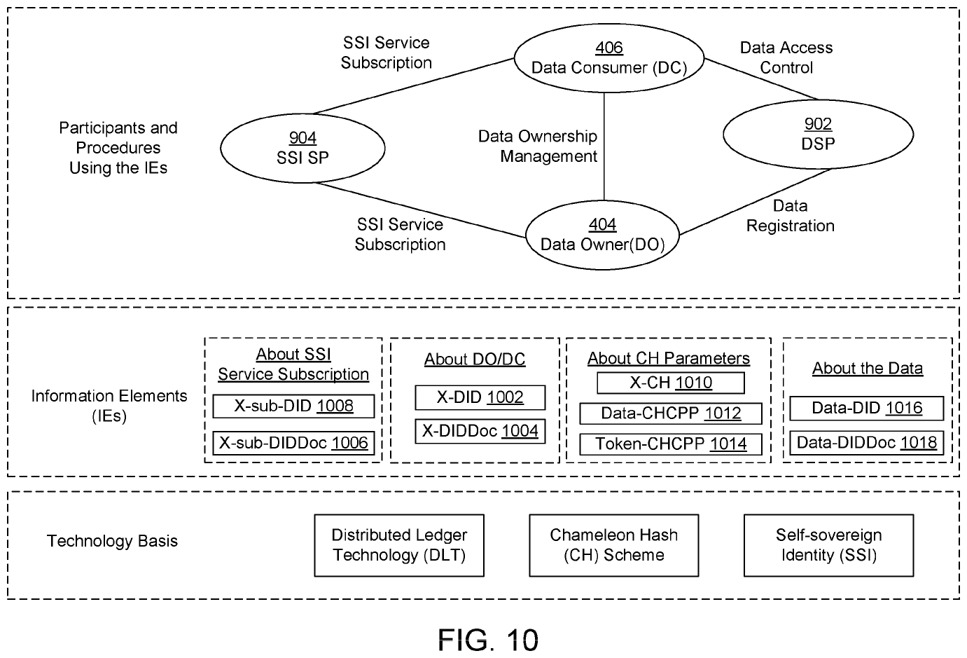

FIG. 13 is a flow diagram illustrating an example procedure for data access. In certain representative embodiments, a DC 406 may explore the DLS 402 market to discover (e.g., types of) available data. For example, a DC 406 may request an access token for desired data owned by the DO 404 (e.g., an access token from the DO 404). After the DC 406 receives an access token from the DO, the DC 406 may retrieve the data from the DSP 902. For example, two data access scenarios are considered data renting (e.g., temporary data access) and purchase (e.g., data ownership transfer).

In certain representative embodiments, a DC 406 may rent owned data (e.g., from a DO). For example, a DC 406 may request to rent access to a piece of data. The data ownership may not transfer from the DO 404. For example, assume the DC 406 is a wireless communication network provider partner. The DC 406 may test the impact of network reliability after deploying new radio units. In this regard, the DC 406 may reach out to the DOs 404 (e.g., WTRUs as network subscribers) to test network reliability. The DC 406 may not do heavy or long-term analysis that requires purchasing the data since the DC 406 may be performing a limited test and/or short-term network diagnostics.

In certain representative embodiments, a DC 406 may purchase owned data (e.g., from a DO 404). For example, a DC 406 may request to purchase and permanently hold ownership of the data. For example, the DC 406 may be a wireless communication network provider partner. The DC 406 may plan to enhance network reliability after deploying new radio units. In this regard, the DC 406 may need to conduct intensive analysis to optimize the new radio deployment costs and/or allocations in the long-term. Since the DC 406 may be performing an intensive and/or long-term research, the DC 406 may seek to purchase the network WTRUs (e.g., DOs 404) data.

As shown at 1302 in FIG. 13, a DC 406 may search and/or discover available data published by a DLS 402 (e.g., within a DLS market). A brief data description of available data may be published in the Data-DIDDocs (e.g., smart contracts) to facilitate data discovery and exploration. For example, the DC 406 may be assumed to desire to rent the data from a DO 404 (e.g., for analytical purposes).

At 1304, the DC 406 may send a request (e.g., a data access request) to a DO 404. For example, the request may include any of the following. A DC-sub-DID and/or a DC-VC, such as when requested. This information may allow the DO 404 to identify and/or authenticate the DC's credentials. Any Data-DID associated with the DC request. An accessibility requirement. For example, how long the DC 406 would like to access data, whether the DC 406 will have a copy of the data or explore its content, the offered fees to access the data, and/or data accessibility type (e.g., rent or purchase), etc.

At 1306, the DO 404 may respond by accepting the request prior to authentication and verification of the DC 406.

At 1308, the DO 404 may authenticate the DC 406 and/or the DC 406 may authenticate the DO 404 at 1310. For example, the DO 404 may authenticate the DC 406 by checking the DC-sub-DIDDoc from the DLS 402, then executing the Auth(DC-DID) function and/or Verify_VC. For example, the DC 406 may authenticate the DO 404 by executing the Auth(DO-DID) function and/or Verify_VC.

At 1312, the DO 404 and DC 406 may negotiate to determine a data access policy and agreement. For example, an agreed upon data access policy may (e.g., should) protect both the DO 404 and DC 406 rights. For example, the agreement may include the allowed time to access the data, data exploitation criteria, limitations of sharing the data content outside the DC scope, and/or liabilities associated with data misuse.

At 1314, after the agreement terms are determined, the DO 404 and DC 406 may create a data access agreement transaction and may publish the agreement transaction in the DLS 402. For example, the data access agreement transaction may include any of: (1) DC-sub-DID, Data-DID, and DO-sub-DID for identification purposes; (2) data access policy and agreement between DO 404 and DC; (3) legal consequences in case of the data access policy terms are not satisfied; (4) data accessibility cost; and/or (5) type of access (e.g., rent or purchase).

At 1316, after the data access agreement transaction is confirmed, the DLS 402 may broadcast the agreement transaction. The DLS 402 may send a block address that contains the validated transaction to the DC 406 and/or DO 404.

At 1318, the DO 404 may generate a data access token (e.g., Token_args). The DO 404 may generate Token-CHCPP. For example, the data access token (e.g., Token_args) may include any of: (1) a timestamp of accessing the data; (2) DC-sub-DID and Data-sub-DID values; (3) a data access agreement transaction address; and/or (4) other constraints the DC 406 and DO 404 may determine during the data accessibility agreement at 1312.

At 1320, the DC 406 may send a data access request to the DSP 902 (e.g., through an initiated secure session with the DSP 902). The DC 406 may establish a secure session with the DSP 902 using SSL, TLS, etc. For example, the data access request may include any of: (1) the DC-sub-DID; (2) the DC's VC; (3) the data access agreement address; (4) the generated data access token; and/or (5) the Token-CHCPP.

At 1322, after receiving the data accessibility request, the DSP 902 may extract information from the DLS 402 about the DC-sub-DIDDoc, Data-DIDDoc, and DO-sub-DIDDoc. For example, the DSP 902 may retrieve the data access agreement from the DLS 402 to identify data access policies and requirements between the DO 404 and the DC 406 before granting data access.

At 1324, after the DSP 902 extracts the needed information from the DLS 402, the DSP 902 may invoke the Auth(DC-DID) function to authenticate the DC 406. On condition that the DC 406 is authenticated successfully, the DSP 902 may compute a Token-CH from the received parameters sent by the DC 406 and execute Verify_Collision(Token-CH, Data-CH, DO-CH) using the provided Token-CHCPP.

At 1326, the DSP 902 may create a data access handling transaction to grant the DC 406 data access. For example, the data access handling transaction may include DO-DID, DC-DID, Data-DID, data access agreement transaction, verification of data access, and/or timestamp, etc.

At 1328, after the data access handling transaction is broadcasted and validated within the DLS network, the DSP 902 may send the DC 406 a response to confirm and authorize the targeted data access to the requesting DC 406.

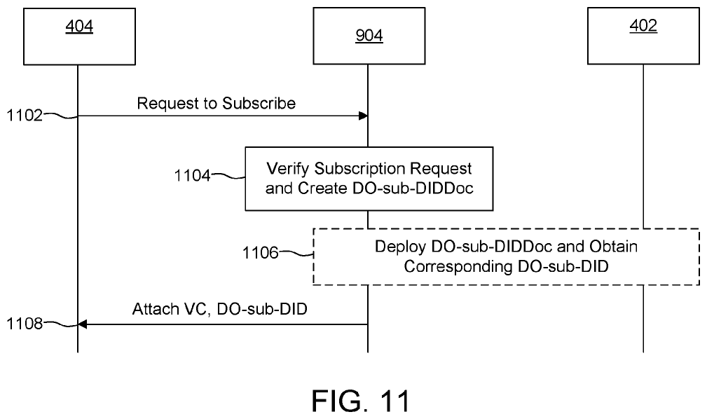

In certain representative embodiments, with the service subscription, data registration, and/or data access stages, (e.g., all) the interactions between the system participants may be recorded in the DLS 402. FIG. 14 is a conceptual diagram illustrating an example structure of X-DIDDocs. For example, a basic structure of a DIDDoc 208 may be based on W3C standards. The DIDDoc 208 structure may include any of the parameters shown in FIG. 14.

For example, an X-DIDDoc transaction 1402 may be created by any of the system participants before data access. For example, the X-DIDDoc may be resolved by the X-DID, which may be used as the participants' (e.g., main) identification of the X-DIDDoc. An X-DID may be the seed coupling all the owned data and generated access tokens to a DO identity.

For example, any (e.g., new) participants (e.g., DC 406 and/or DO 404) may have a X-sub-DIDDoc as shown in FIG. 14. The X-sub-DIDDoc may be issued by an SSI SP 904 as subscription proof for the system. For example, a DO 404 may subscribe to the system and receive a DO-sub-DIDDoc issued by the SSI SP 904 as in FIG. 11. In certain representative embodiments, a X-sub-DIDDoc may be publicly accessible by anyone, and any information therein may be obtained without restrictions.

For example, a DO 404 registering owned data to the system may (e.g., shall) obtain a valid Data-DIDDoc from the DSP 902 and/or from the SSI SP 904 (e.g., according to a storage state of the data). As an example, the data storage may be with the DSP 902 and the DSP 902 may be responsible for deploying the Data-DIDDoc and handling the data registration process. As an example, a DO 404 may store owned data locally and may register the owned data to the system to enable its discovery and protect it during offloading transactions. For example, the registration of the locally stored data to the DLS 402 may be handled by the SSI SP 904.

For example, an X-sub-DIDDoc smart contract 1404 may be created as described and/or shown in FIG. 14.

For example, a Data-DIDDoc smart contract 1406 may be created as described herein and/or shown in FIG. 14.

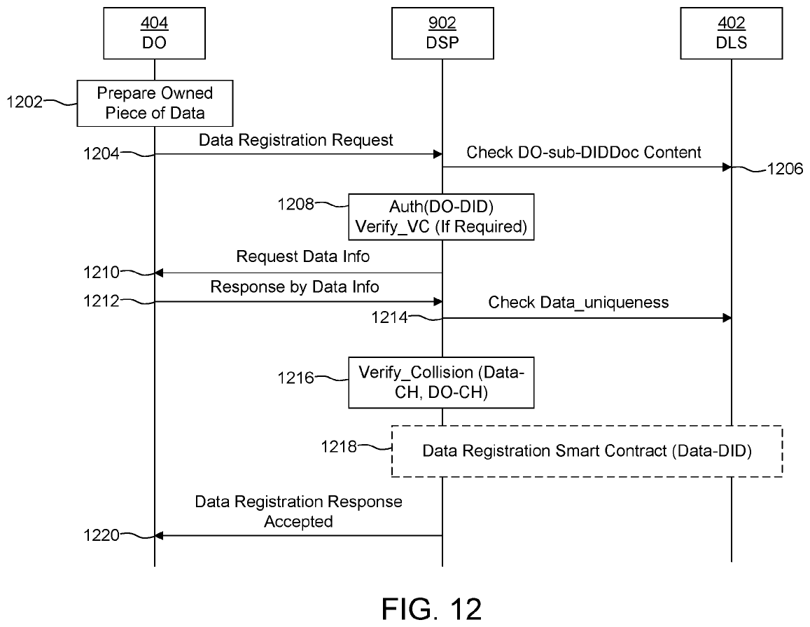

FIG. 15 is a conceptual diagram illustrating examples of smart contracts and transactions.

For example, a DO-sub-DIDDoc 1502 deployed by an SSI SP 904 during service subscription may be a first smart contract (e.g., Smart Contract 1 in FIG. 15). The DO-sub-DIDDoc may be deployed by the SSI SP 904 during the service subscription stage to issue VCs, such as for a new DO participant. In certain representative embodiments, a DO-sub-DIDDoc may include information indicating any of a DO-DID, an SSI SP-DID, a DO-CHPP, a DO-CHCPP, and/or VC issuance proof.

For example, a Data-DIDDoc 1504 deployed by a DSP 902 during data registration may be a second smart contract (e.g., Smart Contract 2 in FIG. 15). The Data-DIDDoc may be publicly accessible by anyone (e.g., DOs 404 and/or DCs 406). In certain representative embodiments, information included in the Data-DIDDoc may be obtained without restriction. For example, the public parameters obtained (e.g., from the DO 404 to accept data registration) may include any of the Data-CHCPP and/or the DO-DID. In certain representative embodiments, a Data-DIDDoc may include information indicating any of a DO-sub-DID, a data hash value (e.g., SHA256(Data)), (e.g., brief) data descriptors, a Data-CHCPP, data accessibility type, and/or an ownership transfer agreement transaction.

For example, a data access agreement 1506 may be a first type of transaction (e.g., Transaction 1 in FIG. 15). A data access agreement may occur between a DC 406 and a DO 404, such as upon a data access request. A data access agreement transaction may include and/or indicate a data access policy and/or copyright agreement between the DO 404 and the DC 406. In certain representative embodiments, a data access agreement may include any of a DO-sub-DID, a DC-sub-DID, a Data-DID, a data access policy, a cost to access data (e.g., access price), any DO 404 and/or DC 406 rights, and/or a timestamp.

For example, a data access handling transaction 1508 may be a second type of transaction (e.g., Transaction 2 in FIG. 15). A data access handling transaction may be published by a DSP 902, such as to confirm DC 406 access to data. For example, a data access handling transaction may include information that indicates a data access decision (e.g., grant). In certain representative embodiments, a data access handling transaction may include any of a DO-sub-DID, a DC-sub-DID, a Data-DID, a data access agreement transaction, verification of a grant to access data, and/or a timestamp.

### Ownership Management

In certain representative embodiments, ownership management of owned data may include procedures for the transfer of ownership of owned data (e.g., among DOs 404 and/or DCs 406). In certain representative embodiments, ownership management of owned data may include procedures for the revocation of ownership of owned data (e.g., among DOs 404 and/or DCs 406). For example, such procedures may apply to situations where a DO 404 locally stores or requests to store owned data in local storage.

### Data Ownership Transfer

In certain representative embodiments, a DC 406 may (e.g., need to) purchase data from the DO 404. In certain representative embodiments, procedures may be implemented for data ownership transfer which may address any of (1) CH linkability concerns during data ownership transfer; (2) linking Data-DID and Data-DIDDoc to the DC 406 (e.g., the new DO); and/or (3) adjusting data control management during data ownership transfer.

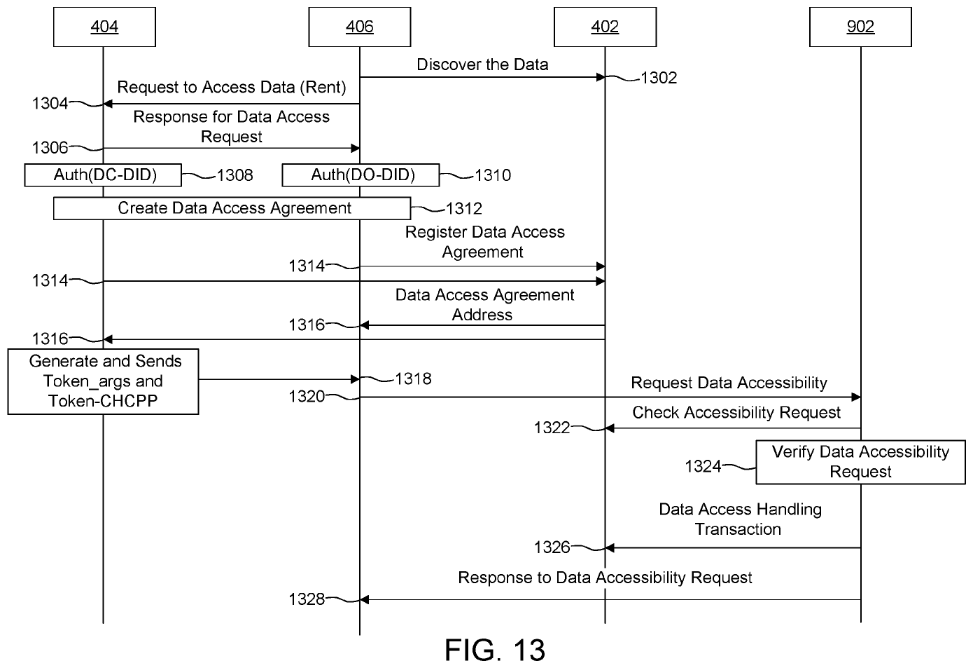

FIG. 16 is a flow diagram illustrating an example procedure for data ownership transfer. As shown at 1602 in FIG. 16, a DC 406 may discover and/or explore the available data published by the DLS 402 (e.g., in a DLS market). A brief data description published in the DLS 402 may facilitate the data discovery and exploration process for the DC 406. In this context, a DC 406 may be willing to acquire and/or purchase certain owned data based on its needs.

At 1604, DC 406 may request data ownership transfer from the DO 404 of one or more units of data. For example, the DC 406 may send a request to a DO 404 asking to purchase the data and/or transfer its ownership to the DC 406. For example, the request may include any of a DC-sub-DID, VC proof, a Data-DID associated with the data that the DC 406 is interested; a data accessibility type (e.g., ownership transfer); and/or a data accessibility cost (e.g., offered price).

At 1606, the DO 404 may process the received request and send the DC 406 a response (e.g., on condition that the DO 404 accepted the data purchase request (e.g., offer)).

At 1608, the DO 404 may perform authentication of the DC, and the DC 406 may perform authentication of the DO 404 at 1610. For example, the DO 404 may authenticate the DC 406 by first checking the DC-sub-DIDDoc from the DLS 402, then computing the Auth(DC-DID) function at 1608. For example, the DC 406 may execute the Auth(DO-DID) function at 4b. to authenticate the DO 404.

At 1612, the DO 404 and DC 406 may negotiate to specify a data ownership transfer policy and agreement. In certain representative embodiments, a data access policy may (e.g., should) protect both the DO 404 and DC 406 (e.g., the new DO) rights. For example, the agreement in this matter may include a negotiation for how the data ownership transfer will be managed. For example, the DC 406 may negotiate with the DO 404 about data cost, consequences if the new DO (e.g., the DC) misuses the data after ownership transfer, etc.

At 1614, the DO 404 and the DC 406 (e.g., the new DO) may register an agreement transaction that shows the data ownership transfer terms. The agreement transaction may be published in the DLS 402. For example, the data access agreement transaction may include information describing the data ownership transfer, such as any of the DC-sub-DID as the new owner of the data, the Data-DID, the DO-sub-DID as the previous owner of the data, the data ownership transfer policy, and/or the participants' rights.

At 1616, after the data access agreement transaction is confirmed, the DLS 402 may send to the DC 406 and/or the DO 404 the validated agreement transaction and/or may send the block address that contains the validated agreement transaction.

At 1618, the DO 404 (e.g., former DO) may (e.g., shall) generate data access token attributes indicating the data ownership transfer agreement. For example, the token attributes may be generated similar to 1318 in FIG. 13. For example, the DO 404 may generate any other parameters specified during the data access agreements. The DO 404 (e.g., former DO) may compute the Token-CHCPP. The Token-CHCPP may be sent to the DC 406 (e.g., new DO).

At 1620, the DC 406 may establish a (e.g., secure) session with the DSP 902, such as by using SSL, TLS, etc. The DC 406 may send a data ownership transfer request to the DSP 902. For example, the request may (e.g., shall) include any of the DC-sub-DID, the Data-DID, data access policy agreement address, Token-CHCPP, and/or Token_args.

At 1622, after receiving the data ownership request, the DSP 902 may retrieve, and extract information from the DC-sub-DIDDoc. The DSP 902 may also check the data access agreement transaction published in the DLS 402 and Data-DIDDoc listings.

At 1624, the DSP 902 may verify the data accessibility request sent at 9. For example, the DSP 902 may invoke the Auth(DC-DID) and/or Verify_Collision(Token-CH, DO-CH, Data-CH).

At 1626, after the Auth(DC-DID) and Verify_Collision(Token-CH, DO-CH) are validated at 1624, the DSP 902 may send a request to the DC 406 asking for a new Data-CHCPP_new from the DC 406 (e.g., the new DO) to be able to re-link the data fingerprint to the DC-DID and transfer the ownership of the Data-DIDDoc to the DC 406. Further, the DSP 902 may ask the DC 406 (e.g., the new DO) to indicate if any changes and/or new policies need to be applied (e.g., to the Data-DIDDoc).

At 1628, the DC 406 (e.g., the new DO) may respond and determine the parameters requested by the DLS 402 at 1626.

At 1630, the DSP 902 may verify the correctness (e.g., accuracy_of the received Data-CHCPP_newly created by the DC 406 (e.g., as new DO) and invoke Verify_Collision (DC-CH, Data-CH_new).

At 1632, the DSP 902 may invoke the Data-DIDDoc (e.g., smart contract) to re-link data ownership to the DC-DID. The changes to be made in the Data-DIDDoc parameters may include any of: (1) changing the DO-DID field to represent the DC-DID instead; (2) Data-CHCPP-new computed by DC 406 (e.g., new DO); (3) a new data accessibility type (renting or selling or both); and/or (4) Ownership transfer agreement.

At 1634 in FIG. 16, the DSP 902 may send a data ownership confirmation to the DC 406 in the form of a response to the DC 406 request sent at 1620. The response may include the Data-DIDDoc that is now owned by the DC 406.

In certain representative embodiments, each participant (e.g., DO 404 and/or DC) may generate their CH parameters, such as during service subscription. For example, each participant's CHPP may be published in each participant's DIDDoc 208 (e.g., by the SSI SP 904). During the data ownership transfer and after verifying the transfer request, the DSP 902 may invoke the initially deployed Data-DIDDoc (e.g., smart contract) to replace the chameleon hash collision parameters (e.g., specified by the old DO) with the new values determined by the new DO 404. For example, the fingerprint of the data being transferred will be linked to the new DO-DID.

In certain representative embodiments, a DSP 902 may deploy a Data-DIDDoc representing the data ownership status (e.g., from the beginning of the data registration). For example, the Data-DIDDoc may be a smart contract, and the Data-DID may indicate an address of the smart contract. Once a data ownership transfer request is verified, the DSP 902 may invoke the Data-DIDDoc, changes the data ownership status, and link the Data-DIDDoc with the DC-DID (e.g., the new DO).

In certain representative embodiments, data requirements and accessibility policies may be broadcasted in the DLS 402 through the Data-DIDDoc (e.g., smart contract). For example, the attributes of the Data-DIDDoc may be invoked (e.g., only) by the DSP 902, such as according to the DO's request.

### Data Ownership Revocation

In certain representative embodiments, procedures may be implemented to revoke an identity of a participant (e.g., DO 404 and/or DC 406). Identity revocation and subscription termination are high-level decisions that may be controlled by an SSI SP 910. For example, a user's identity credentials may (e.g., need to) be revoked due to any number of reasons.

Identity credentials may be revoked on condition that the identity credentials were stolen and/or compromised, the private key or/and CH trapdoor secret key were compromised in the user's DID. For example, the SSI SP 904 may revoke DO-sub-DIDDoc and then invoke a DO-sub-DIDDoc (e.g., smart contract) to replace the manipulated information in the DO-sub-DIDDoc information with newly generated ones. For example, (e.g., all of) the owned data may be re-linked to the new DO-DID with newly generated CHCPP and CHPP. For example, there may be no problems and/or potential risks about losing the owned data tractability or even ownership. The information that was linked to the old DID 202 can easily be re-linked to the newly issued one.

Identity credentials may be revoked on condition that the participant (e.g., DO 404 and/or DC) compromises the agreements related to data accessibility. For example, a participant may be punished by revoking their sub-DIDDoc (e.g., temporarily and/or permanently) according to the SSI SPs 910 consensus judgment. Revoking a sub-DIDDoc includes an SSI SP 904 changing a status of the sub-DIDDoc to inactive or revoked, appending information indicating the reasons for revocation, and/or digitally signing them.

Identity credentials may be revoked on condition that the participant (e.g., DO 404 and/or DC) stole another participant's owned data and/or caused malicious changes to change the data fingerprint (e.g., SHA256(Data)) and re-claim its ownership. For example, during the uniqueness_check function, the DSP 902 may remove redundant data and revoke the Data-DIDDoc accessibility from the DLS 402.

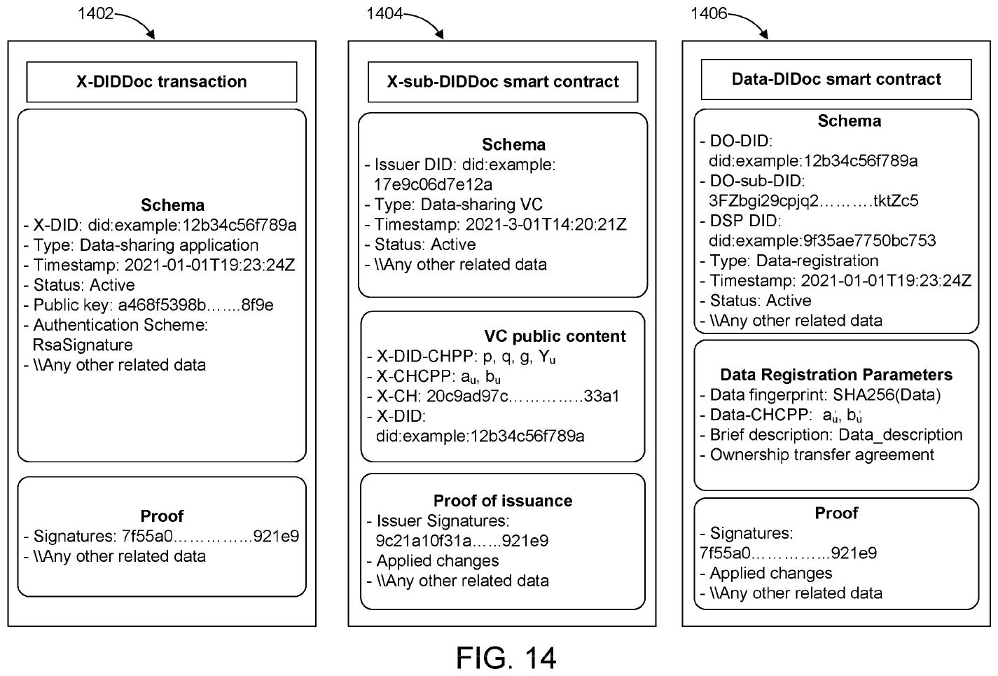

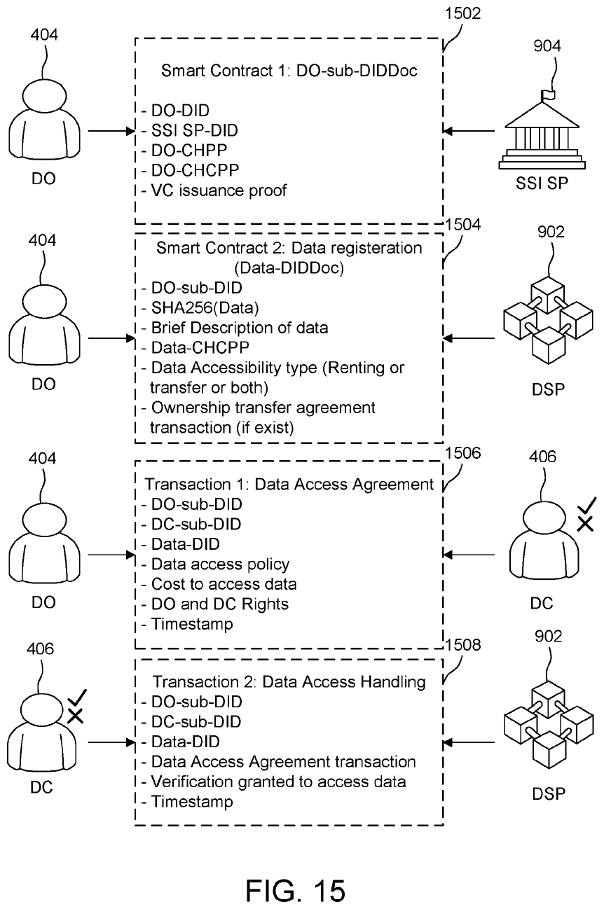

As a revocation example, a DO 404 may have lost their private key and/or the CH trapdoor key associated with the DO's DO-DID. FIG. 17 is a flow diagram illustrating an example procedure for identity credential revocation. FIG. 18 is a flow diagram illustrating an example procedure for linking a data fingerprint with (e.g., new) DO-DID credentials. For example, invoking a Revoke(DO-VC) function may apply changes to a DO-sub-DIDDoc of a DO 404.

At 1702 in FIG. 17, a DO 404 may send an incident report (e.g., request) to an SSI SP 904. The sent information may indicate that the DO's private key associated with (e.g., attached to) the DO's DO-DID and/or the CH trapdoor key associated with (e.g., attached to) the DO's DO-sub-DIDDOC are lost and/or compromised. The DO 404 may include their (e.g., new) DO-DID_new, (e.g., old and/or compromised) DO-DID, and/or DO-sub-DID within the incident report.

At 1704, the SSI SP 904 may investigate the reported case and decides whether or not to invoke the Revoke(DO-VC) process. For example, the SSI SP 904 may execute the Auth(DO-DID_new) function before starting the Revoke(DO-VC) process. The investigation may require the DO 404 to submit actual proofs of their identity (e.g., genuine paper-based credentials such as ID, passport, other credentials). In wireless communication embodiments, a network provider may request theWTRU's physical ID used during service subscription.

At 1706, the SSI SP 904 may request the DO 404 to send a new DO-CHPP (e.g., DO-CHPP_new).

At 1708, the DO 404 may generate the new DO-CHPP (e.g., DO-CHPP_new), such as by using the CH.Gen function. The DO 404 may then submit the new DO-CHPP to the SSI SP 904 and may keep a new private trapdoor key Xᵤ_new (e.g., locally). At 1710, the SP may use DO-CHCPP_new as the new seed to a new DO-DID (e.g., DO-DID_new).

At 1712, the SSI SP 904 may then invoke the DO-sub-DIDDoc (e.g., smart contract) and apply needed changes. For example, the SSI SP 904 may replace DO-DID with DO-DID_new, replace DO-CHPP with DO-CHPP_new, and replace DO-CHCPP with DO-CHCPP_new. The SSI SP 904 may add a description of the applied changes and digitally sign the DO-sub-DIDDoc.

At 1714, the SSI SP 904 may attach the DO-sub-DID and send the DO 404 confirmation and respond that the identity revocation request has been processed successfully.

After receiving a confirmation from the SSI SP 904 about the new changes in the DO-sub-DIDDoc, the DO 404 may submit a request to the DSP 902 to re-link all his owned data to his new identity credentials.

As shown in FIG. 18, the DO 404 may initiate a procedure to re-link his owned data to the new DO-DID. At 1802 in FIG. 18, the DO 404 may send the DSP 902 a request to change the data linkability and tie the previously owned data fingerprints (e.g., SHA256(Data)) to the DO-DID_new. For example, the DO 404 may (e.g., shall) include the DO-DID_new, Data-DIDDoc, and DO-sub-DIDDoc within this request.

At 1804, the DSP 902 may receive the request and start reviewing the changes applied to the DO-sub-DIDDoc. At 1806, the DSP 902 may invoke the Auth(DO-DID_new) function to verify the DO's identity.

At 1808, the DSP 902 may send a request to the DO 404 to specify the new Data_CHCPP_new that ties the owned data to the DO-DID_new. At 1810, the DO 404 may compute a Data-CHCPP_new. The Data-CHCPP_new may cause a collision between the CH value of the newly owned DO-DID (e.g., DO-CH_new) and the CH value of the owned data fingerprint (e.g., Data-CH_new). After, the DO 404 may send (e.g., forward) the Data-CHCPP_new to the DSP 902 as a response to the request sent at 1808 in FIG. 18.

At 1812, after receiving the Data-CHCPP_new, the DSP 902 may execute the Verify_Collision(Data-CH_new, DO-CH_new) function to check that the computed Data-CHCPP_new are authentic and correct.

At 1814, the DSP 902 may invoke the data registration for the Data-DIDDoc (e.g., smart contract) and apply any of the following parametric changes. For example, the DSP 902 may replace DO-DID with DO-DID_new, replace Data-CHCPP with Data-CHCPP_new, and/or digitally sign a proof indicating the details of the applied changes.

At 1816, after verifying the changes, the DSP 902 may respond to the DO 404 request sent at 1802 with a confirmation that the owned data is successfully linked to the DO's new DID.

### Data Ownership Management for Locally Stored Data

In certain representative embodiments, the DO 404 may not store owned data in DSP 902. For example, the DO 404 may be a wireless network provider stores owned data within a local database. As another example, a DO 404 may serve a network and participate in a content off-loading application where a target is to reduce heavy networking traffic. The data should be ready may be stored locally, such as to reduce latency.

In certain representative embodiments, service subscription (e.g., the first stage) may be performed as shown in FIG. 11. The data registration (e.g., the second stage) may not require the DO 404 to interact with the DSP 902 to process and store owned data locally at the DO 404. To enable data discovery and/or link the owned data with the DO-DID, the DO 404 may request data registration from an SSI SP 904.

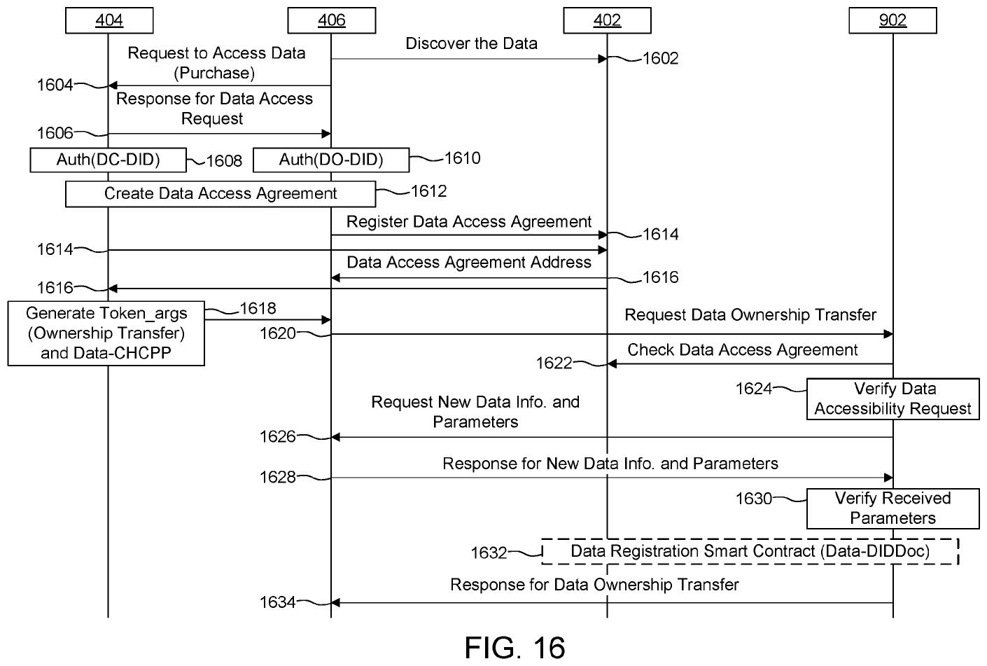

FIG. 19 is a flow diagram illustrating an example procedure for data registration of locally stored data. At 1902 in FIG. 19, a DO 404 may prepare the owned data by digitally signing the data using the DO's PKI private key. The DO 404 may determine a Data-CHCPP that causes a collision with the DO-CH and Data-CH.

At 1904, after the data preparation is done, the DO 404 may send a request (e.g., a data registration request) to an SSI SP 904 and/or DSP 902 to process and register the owned data in the DLS 402. The data registration request may include the DO-sub-DID.

At 1906, after the DO-sub-DID is received, the SSI SP 904 and/or DSP 902 may retrieve a corresponding DO-sub-DIDDoc and extract the information to authenticate the DO 404. For example, the SSI-SP may invoke the Auth(DO-DID) function to verify the DO's identity and/or authenticity.

At 1908, on condition that the DO's identity is valid, the SSI SP 904 and/or DSP 902 may send the DO 404 a request to attach the needed data information and its associated attributes.

At 1910, the DO 404 may establish a (e.g., secure) session with the SSI SP 904 and/or DSP 902 to send the digitally signed data. For example, the data transmitted by the DO 404 to the SSI SP 904 and/or DSP 902 is for integrity check and validation. The SSI SP 904 and/or DSP 902 may (e.g., will) not store the data and/or have the right to use the data. At 1910, the owned data is registered to allow DCs 406 to discover its existence, and link the owned data fingerprint to the DO-DID. For example, the DO 404 may attach the computed Data-CHCPP, the data accessibility type options, and/or one or more descriptors of the data (e.g., attributes) for discovery.

At 1912, the SSI SP 904 (or DSP 902) may verify data integrity and check data_uniqueness of the owned data.

At 1914, after checking the data at 1912, the SSI SP 904 may verify the correctness of the received Data-CHCPP by invoking the Verify_Collision (Data-CH, DO-CH) function.

At 1916, after the owned data is validated, the SSI SP 904 may create a Data-DIDDoc (e.g., a data registration smart contract). For example, the content of the Data-DIDDoc may be the same as in the data registration of FIG. 8.

At 1918, the SSI SP 904 may respond to the DO request at 1902 to register the data. For example, the SSI SP 904 may send DO 404 the Data-DID. For example, the SSI SP 904 may keep a copy (e.g., of the Data-DID) for archival within his local database for data registry.

In certain representative embodiments, for the data access stage, the interaction between the DO 404 and DC 406 before granting any data accessibility may require negotiations about a data access policy and agreement.

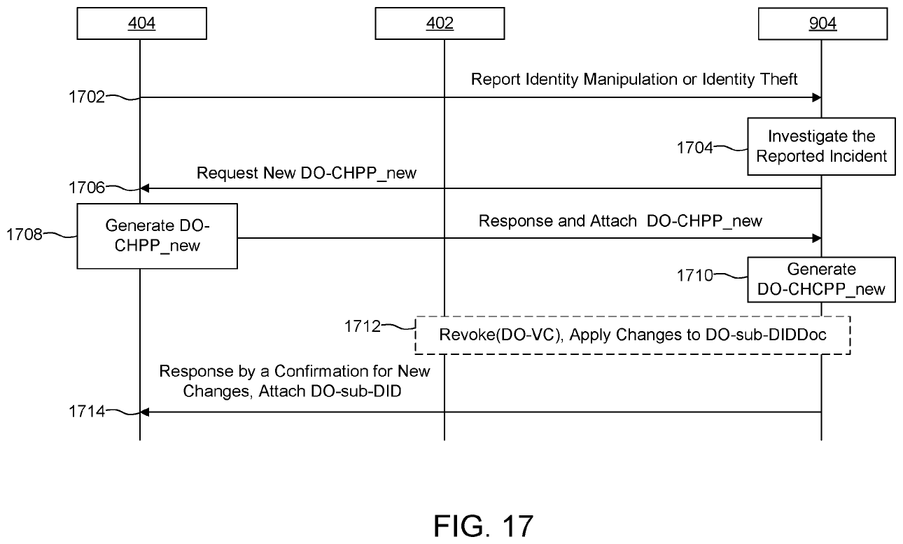

FIG. 20 is a flow diagram illustrating an example procedure for data access of locally stored data. At 2002 in FIG. 20, the DC 406 may begin with exploring the available data published by a DLS 402 (e.g., within the DLS market).

At 2004, a DC 406 may initiate an access data request to the DO 404 after the data discovery process. The request may (e.g., shall) include the DC-sub-DID and the Data-DID. For example, the DC 406 may indicate in the request an accessibility requirement or request. Accessibility requirements may include any of how long the DC 406 would like to access data, whether the DC 406 will have a copy of the data or explore its content, the offered fees to access the data, and/or data accessibility type (rent/purchase), etc. FIG. 20 assumes the DC 406 will request renting data from the DO 404 as the access, but the DC 406 may also request to purchase ownership of the data.

At 2006, the DO 404 may process the received request, check the DC-sub-DIDDoc from the DLS 402, and may execute the Auth(DC-DID) function. The DC 406 may execute the Auth(DO-DID) function at 2008 to authenticate the DO 404.

At 2010, the DO 404 and DC 406 may negotiate the specifics of a data access policy and agreement (e.g., of the requested data). The data access policy may protect both the DO 404 and DC 406 rights.

At 2012, once the agreement terms are determined, the DO 404 and DC 406 may a data access agreement transaction and publish it in the DLS 402.

At 2014, after the data access agreement transaction is confirmed (e.g., published), the DLS 402 may send, to the DO 404 and/or the DC, the validated agreement transaction. For example, the DLS 402 may provide a block address as a reference to the validated transaction.

At 2016, the DO 404 may grant data access to the requesting DC 406. For example, granting the data access to the DC 406 may occur by sending the data directly in an initiated (e.g., secure) session with the DC 406.

At 2018, after receiving the granted data access, the DC 406 may process the data, check signatures, check integrity by computing data fingerprint and compare the value with SHA256(Data) mentioned in the Data-DID, and/or may check Data-CH by computing CH.Ver(Data-CH, SHA256(Data), DO-CHPP, Data-CHCPP). After, the DC 406 may use the Verify_Collision (Data-CH, DO-CH) function to ensure authentic data. On condition that the DC 406 discovered that the received data integrity and/or authenticity did not match the information published in the DLS 402, the DC 406 may terminate the data access process. For example, the DC 406 may send a Revoke(DO-VC) to the SSI SP 904. Otherwise, the DC 406 may accept the received data.

At 2020, the DC 406 may report (e.g., to the DLS 402) that the data accessibility has been processed successfully. For example, the report may be in the form of a broadcasted DLS transaction.

### Decentralized Data Control and Access Management Across Multiple Data Ownerships and Multiple Data Consumers

In certain representative embodiments, procedures may occur for data control and access management between a single DO 404 and a single DC 406. In other representative embodiments, there may be multiple DCs 406 requesting to access the same data (e.g., simultaneously) and/or multiple DOs 404 having different shares in data ownership. For example, a DO 404 may have either one share of the data or multiple shares depending on an agreement between the cooperating DOs 404.

In certain representative embodiments, there may be a single DO 404 and multiple DCs 406. For example, a DO 404 may be a network subscriber WTRU 102 (e.g., to persistently measure network statistics for multiple network providers, including network reliability, downtimes, coverage stability, etc.). The network providers may cooperate to enable better coverage while optimizing their resources. A target of the cooperating network providers may be to maximize the network reliability and/or maximize overall profit and/or minimize resource deployment costs and/or achieve load balancing during fluctuating demands. For example, the network providers may want to access the statistics obtained by (e.g., volunteering) WTRUs to start deploying optimization and/or AI models, determine the deployment plans, and/or determine the policies of managing resource sharing without overloading each other. Here, for example, each WTRU 102 may be a DO, which may provide fair access to the cooperating network providers (e.g., without benefiting one over the others). Here, for example, each network provider may be a DC 406 trying to access shared data (e.g., at the same time).

In certain representative embodiments, there may be multiple DOs 404 and a single DC 406. For example, a consortium of WTRUs may cooperate to run and/or train a federated AI model, such as where all the cooperating WTRUs manage the data, model parameters, and/or testing accuracy operate the model. The model operated by the consortium of WTRUs may relate to (e.g., management of) an application for wireless communications (e.g., re-allocating the resources for load balancing, online learning to specify the network slicing demands accurately, and/or alternating between needed resources for each slice). The (e.g., AI and/or ML) model may be of interest to the network provider. Consequently, the network provider may be interested in renting and/or purchasing the model deployed across the cooperating WTRUs (e.g., connected to the network). Here, for example, the WTRUs may be the DOs 404 that may cooperate in providing an access token to the (e.g., collective) model data to the interested network provider (e.g., the DC 406).

In certain representative embodiments, there may be multiple DOs 404 and multiple DCs 406. For example, multiple network providers may be cooperating to create a federated wireless network and may be interested in the WTRUs' AI model. Here, for example, the WTRUs may be the DOs 404 in this scenario and may cooperate to generate access tokens that provide the federated network providers, as DCs 406), (e.g., fair) access to the owned data.

In certain representative embodiments, such as a system with multiple DOs 404, the various DOs 404 may own a piece of data cooperatively. For example, each DO 404 may hold a share or multiple shares of the data ownership. A DO in this context may refer to one of the DOs 404, where iεN and Nis the number of DOs 404 owning the data. The cooperating DOs 404 may use secret sharing (SS) and secure multiparty computation (SMC) techniques to synchronize data management without risking a single entity to possess the cooperatively owned data. For example, secret sharing techniques may enable splitting the private keys (e.g., data possession shares) among the cooperating DOs 404. For example, SMC techniques may be employed to manage interactions and/or data-driven transactions fairly among the cooperating DOs 404. In general, two SMC models are considered, a semi-honest model and a dishonest model.

In a semi-honest model, for example, the DOs 404 may be assumed to be honest but curious in this model. Being honest may mean that they are not willing to manipulate the shares of data and/or secret keys they hold. The DOs 404 may be curious to know the secret information to steal the data ownership shares from the other DOs 404 (e.g., without permission). In scenarios, adopting a simple secret sharing (SS) technique, like Shamir's secret sharing scheme, integrated with a secure two-party computation scheme may be adequate (e.g., to address risks posed by the semi-honest DOs).

In a dishonest model, for example, the DOs 404 may be assumed to be either malicious and/or under active attack (e.g., compromised). This assumption risks data availability, integrity, and/or authenticity. For example, techniques like Shamir's secret sharing with Reed-Solomon decoding integrated with Yao's garbled circuit protocol may be adequate (e.g., to address risks posed by the dishonest DOs).

As described herein, data owned collaboratively and/or shared by multiple DOs 404 may be referred to as SMC-data. SMC-data may be owned and/or controlled my multiple DOs 404 (e.g., simultaneously).

### Multiple DOs—Service Subscription Stage

In certain representative embodiments, for a group of (e.g., cooperating) DOs 404 to participate in a decentralized SSI-enabled data control and access management system, the DOs 404 may (e.g., shall first) generate a single DID 202 denoted as (SMC-DO-DID), which may represent cooperation regarding shared ownership. For example, an associated DIDDoc 208 (e.g., SMC-DO-DIDDoc) to the generated SMC-DO-DID may include (e.g., extra) public information about the collaborative ownership. For example, SMC-DO-DIDDoc may include any of each DO DID (e.g., denoted as DOᵢ-DID, where iεN), a SMC scheme, an SS scheme, as well as any of the parameters of 1402.

In certain representative embodiments, the chameleon hash trapdoor key (Xᵤ) may be split into different pieces using an SS scheme. As described herein, the CH trapdoor key shares may be referred to as trapdoor shares or Xᵢ, where iεN. Each Xᵢ alone may be considered useless and redundant until combined with the rest of the CH trapdoor shares. Reconstructing the trapdoor key requires all the DOs 404 to cooperate using SMC to use the trapdoor key securely and/or adequately (e.g., without revealing its value). To subscribe to the SSI service, the cooperating DOs 404 may request an SSI SP 904 to issue a VC representing their cooperation. As described herein, an issued VC may be referred to as a SMC-VC. For example, the SSI SP 904 may deploy a SMC-DO-sub-DIDDoc that publishes the public parameters about an issued SMC-VC. The SMC-DO-sub-DIDDoc may be a smart contract. The SMC-DO-sub-DIDDoc may be structured similar to a DO-sub-DIDDoc, such as shown in FIG. 1404. For example, an address of a SMC-DO-sub-DIDDoc in the DLS 402 may be referred to as a SMC-DO-sub-DID.

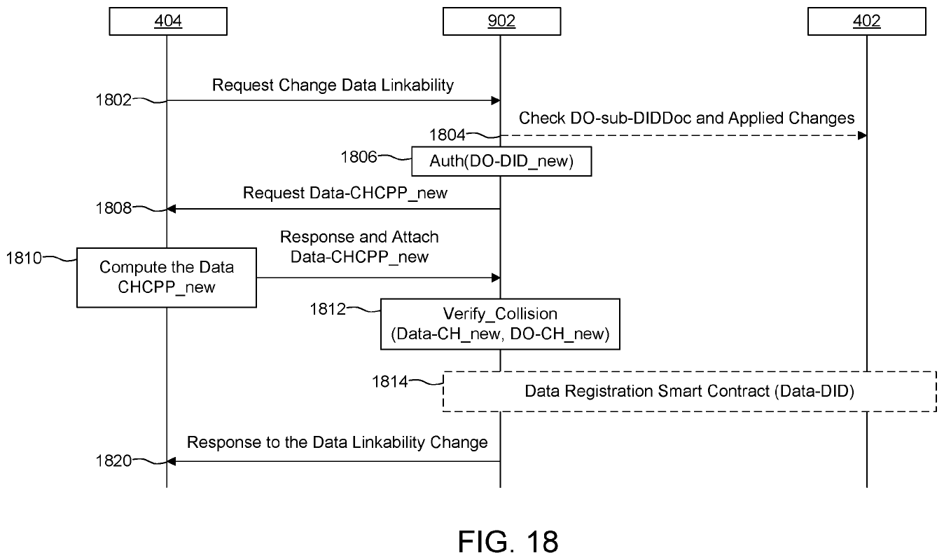

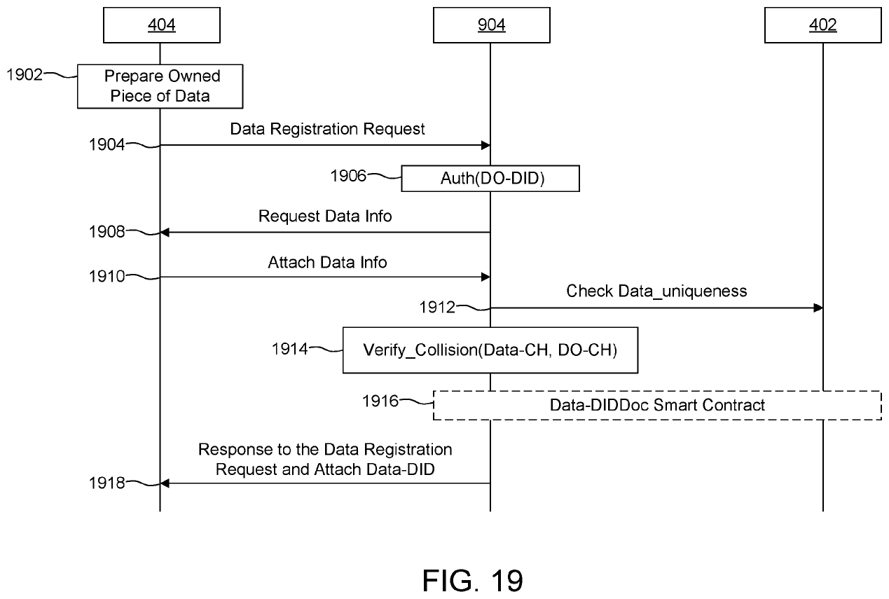

FIG. 21 is a flow diagram illustrating an example procedure for service subscription for shared ownership. At 2102 in FIG. 21, the cooperating DOs 404 may use SMC to generate CHPP. The CH trapdoor secret key may be split into shares (Xᵢ), and the rest of the CHPP values (e.g., other than the CH trapdoor secret key shares) may be published in a DLS 402. The generated CHPP may be referred to as SMC-DO-CHPP. FIG. 22 is a conceptual diagram illustrating an example of SMC-Data sharing scheme 2200. FIG. 22 at (a) shows an example of how the CHPP may be generated. Each DO 404 may select a secret random number representing a trapdoor share Xᵢ, iεN, where N is the total number of data shares owning the shared data. Once the trapdoor is computed, a chameleon hash public-key Yᵤ may be calculated as shown in FIG. 22.

At 2104, a (e.g., random) DO 404 may be selected among the cooperating DOs 404 to submit a request to the SSI SP 904 indicating the parameters needed to issue the SMC-VC and deploy the SMC-DO-sub-DIDDoc in the DLS 402. For example, the submitted request may include the SMC-DO-DID.

At 2106, the SSI SP 904 may then check the content of the SMC-DO-DIDDoc corresponding to the received SMC-DO-DID. The SSI SP 904 will execute the Auth(SMC-DO-DID) as described elsewhere herein.

At 2108, once verified, the SSI SP 904 may broadcast a request to the cooperating DOs 404 to submit the computed SMC-DO-CHPP. At 2110, the cooperating DOs 404 may then submit (e.g., cooperatively) the computed SMC-DO-CHPP from 2102 in FIG. 21.

At 2112, the SSI SP 904 may then calculate the CHCPP seed referred to as SMC-DO-sub-CHCPP.

At 2114, the SSI SP 904 may include the SMC-DO-sub-CHCPP in the invoked SMC-DO-sub-DIDDoc (e.g., smart contract).

At 2116, after the deployment of SMC-DO-sub-DIDDoc is confirmed, the SSI SP 904 may send the SMC-DO-DID value to the cooperating DOs 404 (e.g., as a response to the received subscription request at 2102).

### SMC-Data Registration Stage

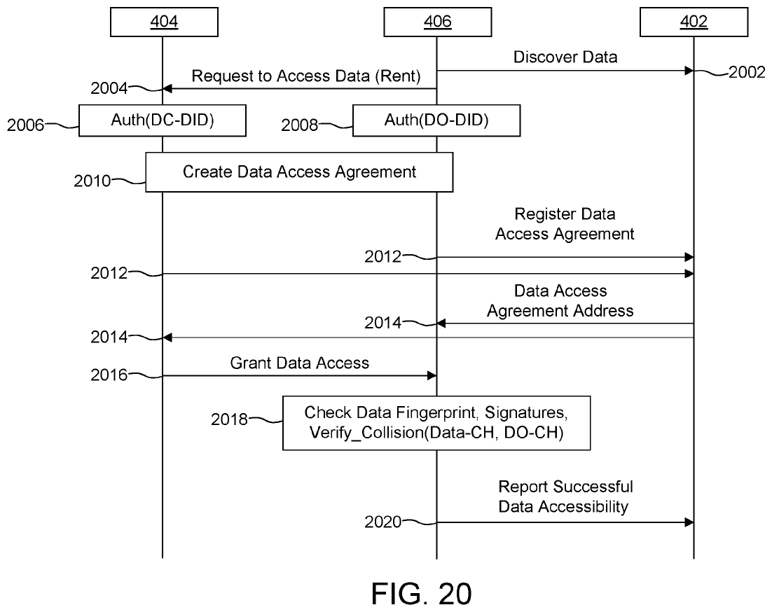

As described herein, data owned collaboratively by multiple DOs 404 may be referred to as SMC-data. For example, SMC-data may be owned and controlled by multiple cooperating DOs 404 (e.g., simultaneously). FIG. 23 is a flow diagram illustrating an example procedure for data registration of SMC-Data.

As shown at 2302 in FIG. 23, prior to requesting any decentralized storage (e.g., of the SMC-data), the cooperating DOs 404 may prepare the owned data (e.g., SMC-Data) by digitally signing it and computing CHCPP (e.g., SMC-Data-CHCPP required to cause collision between the CH values of SMC-DO-DID value and SMC-Data). For example, a SMC-Data-CH should be equivalent in value to a SMC-DO-DID-CH. For example, the calculation of the SMC-Data-CHCPP may require the DOs 404 to cooperate using the adopted SMC scheme. An example of how SMC-Data-CHCPP may be computed is shown in FIG. 22 (b).

At 2304, after the data processing and preparation finished, the cooperating DOs 404 may send a request (e.g., data storage request) to store the SMC-Data with a DSP 902. For example, the request may include the SMC-DO-sub-DID.

At 2306, after the SMC-DO-sub-DID is received, the DSP 902 may retrieve the corresponding SMC-DO-sub-DIDDoc. For example, the DSP 902 may check the public information and then execute the Auth(SMC-DO-DID) process.

At 2308, the DSP 902 may request the cooperating DOs 404 to submit the SMC data content and associated information, such as SMC-Data-CHCPP.

At 2310, the cooperating DOs 404 may establish a (e.g., secure) session (e.g., using SSL or TLS) with the DSP 902 to send the digitally signed data, SMC-Data-CHCPP, data description, accessibility type, and/or any other parameters similar to FIG. 12.

At 2312, the DSP 902 may verify the data integrity by checking a fingerprint and/or data_uniqueness of the received SMC-Data.

At 2314, assuming the data integrity is satisfactory, the DSP 902 may invoke Verify_Collision(SMC-DO-DID-CH, SMC-Data-CH, SMC-Token-DID-CH) before linking the SMC-Data to the SMC-DO-DID.

At 2316, after the collision information is verified, the DSP 902 may deploy the SMC-Data-DIDDoc (e.g., smart contract) similar to FIG. 12.

At 2318, after the SMC-Data-DIDDoc is confirmed and validated within the DLS 402, the DSP 902 may send the SMC-Data-DID to the cooperating DOs 404 (e.g., as a response to the received request at 2304 in FIG. 23. For example, the DSP 902 may keep a copy within its local database registry for archival.

SMC-Data Access Stage

In certain representative embodiments, procedures may be implemented to grant SMC-data accessibility to a group of (e.g., cooperating) DCs 406.

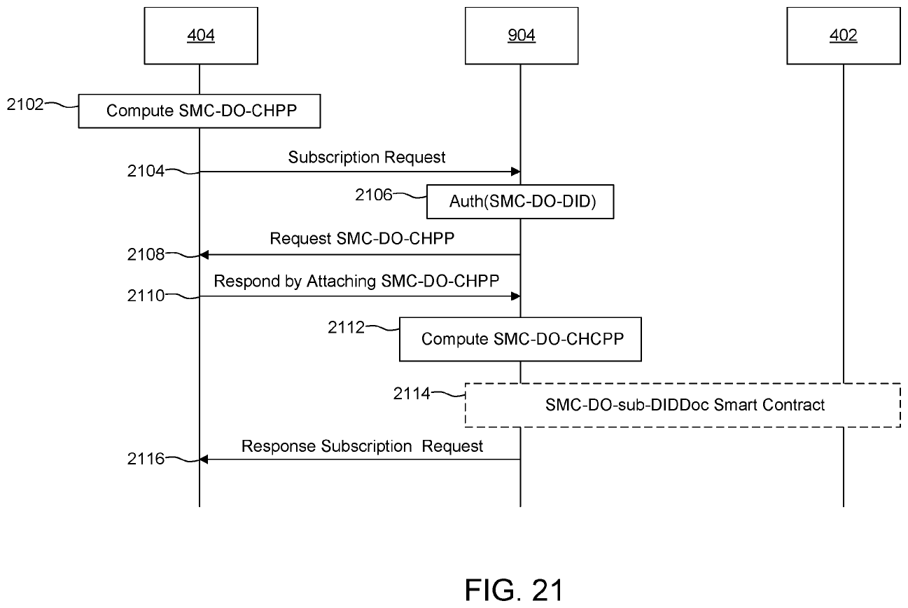

FIG. 24 is a flow diagram illustrating an example procedure for data access of SMC-Data. At 2402 in FIG. 24, a group of (e.g., cooperating) DCs 406 may explore available data published by a DLS 402 (e.g., within the DLS market). For example, a brief data description published in the SMC-Data-DIDDoc may facilitate data discovery and exploration. For example, a group of (e.g., cooperating) DCs 406 may be interested in SMC-data owned by a group of (e.g., cooperating) DOs 404. In FIG. 24, the cooperating DCs 406 may be assumed to be interested in renting the SMC-data.

At 2404, the cooperating DCs 406 may initiate a request to the cooperating DOs 404 (e.g., after the data discovery process). For example, the request to the cooperating DOs 404 may depend on the underlying technology of the adopting data sharing scheme. For example, the request may be broadcast to the cooperating DOs 404 (e.g., through a peer-to-peer connection). For example, the generated request sent to the cooperating DOs 404 may include any of: the SMC-DCs-sub-DID, the SMC-Data-DID, and/or any accessibility requirements. For example, an accessibility requirement may indicate how long the cooperating DCs 406 would like to access data, whether the DCs 406 will have a copy of the data or explore its content, the offered fees to access the data, and/or the data accessibility type (e.g., data renting and/or ownership purchase), etc.

At 2406, the cooperating DOs 404 may start processing the received request and check the content of SMC-DC-sub-DIDDoc. For example, the DOs 404 may execute the Auth(SMC-DC-DID) function to authenticate the DCs 406. For example, the DCs 406 may execute the Auth(SMC-DO-DID) function to authenticate the DOs 404 2408.

At 2410, any of the DOs 404 and the DCs 406 may negotiate a data access policy and agreement. For example, the data access policy may protect both parties' rights.

At 2412, after the agreement terms are determined, one or both parties may create a data access agreement transaction. The data access agreement transaction may be published in the DLS 402. For example, the data access agreement transaction may include any of: the SMC-DC-sub-DID, the SMC-Data-DID, the SMC-DO-sub-DID, the agreement between DOs 404 and DCs 406 to access the data and accessibility policy, any legal consequences in case the data access policy terms are not satisfied, a data accessibility cost and/or type (e.g., purchase or rental), a timestamp, and/or any other public parameters determined during the data accessibility negotiations.

At 2414, after the data access agreement transaction is confirmed, the DLS 402 may broadcast the validated agreement transaction. For example, the DLS 402 may send to the DOs 404 and/or the DCs 406 with a block address that references the validated agreement transaction.

At 2416, after the agreement is confirmed, the cooperating DOs 404 may generate a data access token (e.g., SMC-Token_args). The DOs 404 may compute the SMC-Token-CHCPP. For example, the data access token may include any of a timestamp of accessing the data, SMC-data-DID and/or SMC-DC-sub-DID values, a data access agreement address, and/or any other constraints the DCs 406 and DOs 404 may have determined during the data accessibility agreement negotiation.

In certain representative embodiments, as multiple DCs 406 are requesting to access the SMC-data, accessibility fairness may (e.g., should) be satisfied (e.g., among the DCs 406). For example, accessibility fairness may include the process of granting all the requesting DCs 406 the right to access the data (e.g., simultaneously and/or cooperatively). For example, the cooperating DOs 404 may split, using an SS scheme, the SMC-Data-CHCPP into multiple shares, which may be designated as SMC-Data-CHCPPⱼ, where jεM and M is the total number of cooperating DCs 406. For example, the SMC-Token_args may also be split into M-shares denoted as SMC-Token_args).

At 2418, the cooperating DOs 404 may (e.g., randomly) distribute the shares (e.g., SMC-Token_argsⱼ and SMC-Data-CHCPPⱼ) among the cooperating DCs 406. For example, where a number of cooperating DCs 406 are M=2, the generated shares of the SMC-Token_args and SMC-Token-CHCPP may be split into the following two tuples (SMC-Token_args₁, SMC-Token-CHCPP₁) and (SMC-Token_args₂, SMC-Token-CHCPP₂). The first tuple (SMC-Token_args₁, SMC-Token-CHCPP₁) may be sent to the first DC₁, Similarly, the second tuple (SMC-Token_args₂, SMC-Token-CHCPP₂) may be sent to the other DC₂.

At 2420, the cooperating DCs 406 may request the DSP 902 to access the SMC-data. For example, any of the cooperating DCs 406 may attach any of the SMC-Data-DID, SMC-DC-sub-DID, SMC-Token_argsⱼ, SMC-Data-DHCPPⱼ, where jεM, and/or the data access agreement within the request.

At 2422, to reconstruct the SMC-Token_args and SMC-Data-CHCPP, the DSP 902 may collect the SMC-Token_argsⱼ, SMC-Data-DHCPPⱼ, where jεM from each DC 406. For example, the DSP 902 may execute the adopted SS algorithm determined in their SMC-DC-DIDDoc. For example, the specified SS scheme in the SMC-DC-DIDDoc may be Shamir's Secret Sharing scheme, where the secret reconstruction may follow the Shamir's Secret Sharing secret reconstruction function.

At 2424, the DSP 902 may confirm the SMC-DC-sub-DIDDoc and data access agreement and/or SMC-Data-DIDDoc.

At 2426, the DSP 902 may invoke the Auth(SMC-DC-DID and/or the Verify_Collision (SMC-Data-CH, SMC-DO-DID-CH) functions.

At 2428, after the DSP 902 authenticates and/or verifies the DCs request, the DSP 902 may generate a data access handling transaction (e.g., to grant all the cooperating DCS data accessibility. For example, the data access handling transaction may be generated similar to other embodiments.

At 2430, after the data access handling transaction is validated and broadcasted within the DLS network, the DSP 902 may send a response to the received request to the cooperating DCs 406 (e.g., responsive to 2420 in FIG. 24). For example, the DSP 902 may establish a (e.g., secure) channel (e.g., using SSL, TLS, etc.) with the DCs 406 and may authorize the targeted data accessibility for the DCs 406.

### Data Control and Access Management—Wireless Network

### Architecture

In certain representative embodiments, distributed data access control with ownership protection may be implemented in wireless networks including 3GPP cellular networks, such as cellular networks using 5G service architecture.

For example, a DO 404 may be a WTRU 102, a Network Function (NF), and/or an Application Function (AF). For example, a DC 406 may be a WTRU 102, a NF, and/or an AF.

For example, an SSI SP 904 may be implemented as an SSI Service Subscription Function (SSSF) 2502. An SSSF 2502 may be deployed as a standalone NF, a part of a 5G Authentication and Server Function (AUSF) 504, or a portion of a 5G Unified Data Management (UDM) 512 function. As another example, an SSSF 2502 may be deployed as an Application Function (AF) 113, such as a Network Exposure Function (NEF) 510 which may facilitate other entities to reach an SSSF 2502 and/or an SSSF 2502 to reach other entities via the NEF 510.

For example, a DSP 902 may be implemented as a Data Access Control Function (DACF) 2506. For example, a DACF 2506 may be deployed as a standalone NF, a part of a UDM, or a portion of a Unified Data Repository (UDR) function. As another example, a DACF 2506 may be deployed as an AF, such as a NEF to facilitate other entities to reach the DACF 2506 via the NEF 510, and/or a DACF 2506 to reach other entities via the NEF 510.

For example, a DLS 402 can be implemented as a Distributed Ledger Function (DLF) 2504. A DLF 2504 may interface with different underlying distributed ledger networks and systems, such as on behalf of WTRUs, AFs, and/or NFs, including an SSSF 2502 and/or a DACF 2506. For example, a DLF 2504 may be deployed as a standalone NF, a part of 5G UDR 514, and/or a portion of a 5G Unstructured Data Storage Function (UDSF) 516. As another example, a DLF 2504 may be deployed as an AF, such as a NEF to facilitate other entities to reach a DLF 2504 via the NEF 510, and/or the DLF 2504 to reach other entities via the NEF 510.

For example, a DSP 902 and a DLS 402 may be implemented together as a standalone NF. As another example, a DSP 902 and/or a DLS 402 may be implemented as an expansion to any of an existing (e.g., 5G) UDM, UDR 514, and/or UDSF 516.

In certain representative embodiments, any of an SSSF 2502, a DACF 2506, and/or a DLF 2504 may be deployed in various (e.g., other) locations in a 5G and/or next generation cellular network, such as being located in any of devices, edge data networks, centralized data network, and/or the cloud. In certain representative embodiments, a DLF 2504 may be implemented as a part of any of an SSSF 2502, a DACF 2506, a DO, and/or a DC 406.

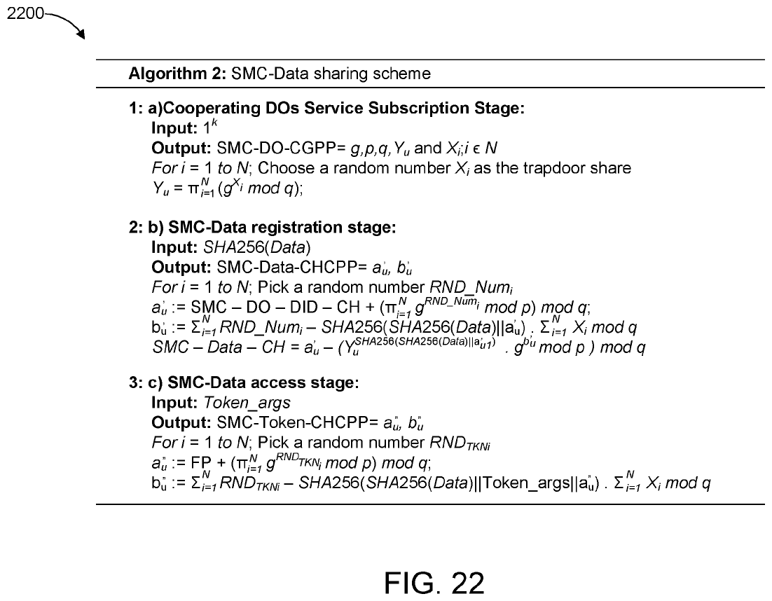

FIG. 25 is a system diagram illustrating an example deployment of distributed access control in a wireless network. As shown in FIG. 25, a WTRU-1 102aWTRU-1 102a may participate as a DO 404, that may provide data access, to a WTRU-2 102b. In FIG. 25, the WTRU-2 102b may participate as a DC 406, that may access the data provided by the WTRU-1 102aWTRU-1 102a.

In FIG. 25, an SSSF 2502 and/or a DLF-1 2504a may be deployed as two (e.g., separate) NFs, or one combined NF, in a core network 115 or centralized data network. For example, the SSSF 2502 may receive two service requests, respectively, from the WTRU-1 102a and the WTRU-2 102b. The WTRU-1 102a and the WTRU-2 102b may indicate their CH Public Parameters (CHPP) to the SSSF 2502 (e.g., in the service requests). The SSSF 2502 processes the requests and may generate a DID 202 and DIDDoc 208 for the WTRU-1 102a and WTRU-2 102b, respectively. The SSSF 2502 may store the DIDs and DIDDocs 208 with a DLS 402 via the DLF-1 2504a.

For example, a DACF 2506 and a DLF-1 2504b may be deployed as two (e.g., separate) NFs, or one combined NF, such as in an edge data network 524. For example, the DACF 2506 may receive and process one or more data registration requests from the WTRU-1 102a. The DACF 2506 may generate one or more records for the WTRU-1 102a's data. The DACF 2506 may store the WTRU-1 102a's data records to the DLS 402 via the DLF-1 2504b. As another example, a DACF 2506 may use a DLF-1 2504a to store the WTRU-1 102a's data records. For example, actual data provided by the WTRU-1 102a may be stored (e.g., separately) in an external storage system, and a hash of the actual data and its location in the external storage system may be stored in the DLS 402.

In certain representative embodiments, the WTRU-2 102b may discover WTRU-1 102a and/or WTRU-1 102a's data from the DACF 2506, for example. As another example, the WTRU-2 102b may find WTRU-1 102a and/or WTRU-1 102a's data from the DLS 402 via the DLF-1 2504b (e.g., directly).

For example, a WTRU-2 102b may need or want to access the WTRU-1 102a's data. The WTRU-2 102b may (e.g., first) request a data access token from the WTRU-1 102a. During the data access procedure, both the WTRU-1 102a and/or the WTRU-2 102b may negotiate and agree upon one or more data access policies. As an example, the negotiation may be directly between the WTRU-1 102a and the WTRU-2 102b and/or facilitated by the DLS 402 via the DLF-1 2504b. The WTRU-1 102a may have an account in the DLS 402 that the DLF-1 2504b interfaces with. The WTRU-2 102b may have an account in the DLS 402 that the DLF-1 2504b interfaces with. For example, the WTRU-1 102a may have (e.g., already) published a data access smart contract to the DLS 402 via the DLF-1 2504b. When the WTRU-2 102b requests to access WTRU-1 102a's data, the WTRU-2 102b may find and trigger the WTRU-1 102a's data access smart contract. Any data access policies as specified in the WTRU-1 102a's data access smart contract may be automatically executed.

For example, after receiving a data access token from the WTRU-1 102a, the WTRU-2 102b may present the data access token to the DACF 2506 to retrieve the WTRU-1 102a's data. The DACF 2506 may have previously stored the WTRU-1 102a's data to a data storage system due to the WTRU-1 102a's (e.g., prior) data registration process. The DACF 2506 may verify the data access token to guarantee the data access token is indeed issued by the WTRU-1 102a and that the WTRU-2 102b has the right to access the WTRU-1 102a's data. Then, the DACF 2506 may send the WTRU-1 102a's data to the WTRU-2 102b. As an example, the WTRU-1 102a's data may have been stored in an external storage system, and the WTRU-2 102b may retrieve the WTRU-1 102a's data directly from the external storage system or the retrieval may be facilitated by the DACF's authentication and authorization.

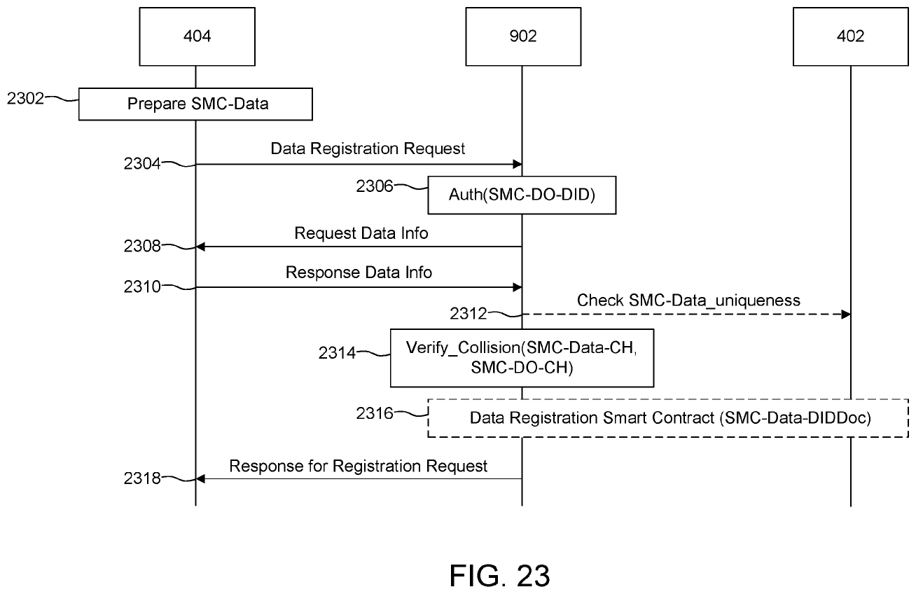

FIG. 26 is a system diagram illustrating another example deployment of distributed access control in a wireless network. For example, the wireless network may be a 3GPP cellular network. As shown in FIG. 26, a WTRU-1 102a and a WTRU-2 102b may interact with different DACFs 2506a, 2506b and DLFs 2504a, 2504b in edge networks 524a, 524b. For example, the WTRU-1 102a may register its data via a DACF-1 2506a and a DLF-1 2504a. The WTRU-2 102b may request data access from a DACF-2 2506b. For example, the DACF-1 2506a and the DACF-2 2506b may interface with a same underlying data storage system where the data of WTRU-1 102a has been stored. As another example, the DACF-1 2506a may store data of WTRU-1 102a to a common DLS 402. The DACF-1 2506a and the DACF-2 2506b may coordinate via the common DLS 402. Another DLF-3 2504c may be provided between the DLS 402 and the SSSF 2502.

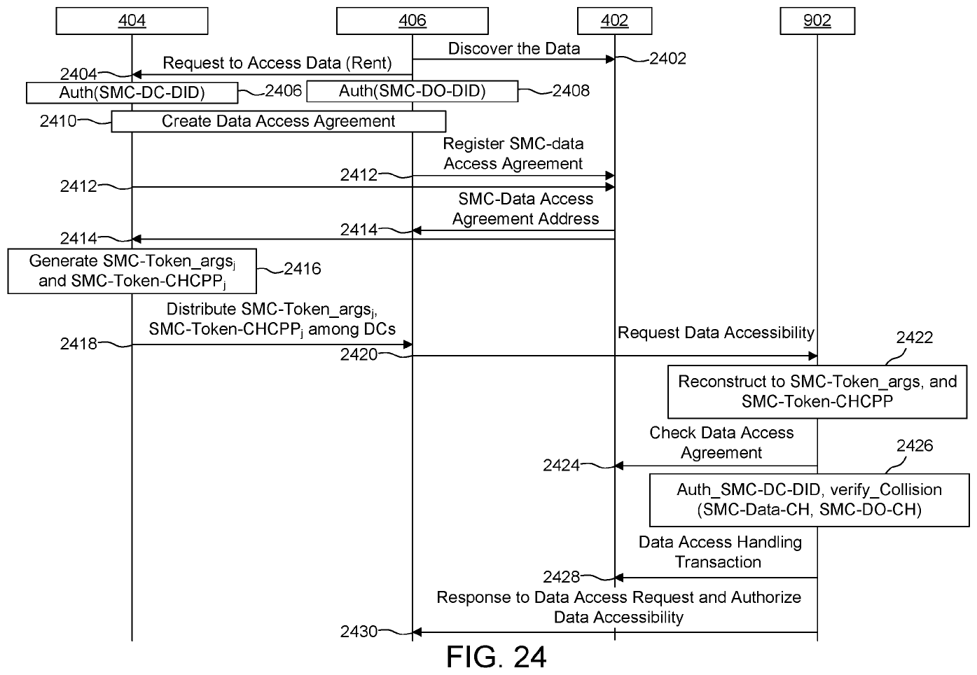

FIG. 27 is a system diagram illustrating another example deployment of distributed access control in a wireless network. For example, the wireless network may be a 3GPP cellular network having a core network 115 or centralized data network. As shown in FIG. 27, both a WTRU-1 102a and a WTRU-2 102b may have an internal DLF 2504a, 2504b. For example, a DO-1 404a in the WTRU-1 102a may interact with a DLS 402 via a DLF-1 2504b. A DC-2 406a in the WTRU-2 102b may interact with the DLS 402 via a DLF-1 2504a. Operations among the DO-1 404a, the DC-2 406a, the DACF 2506 in the edge data network 524, and/or the SSSF 2502 in the core network 115 may be performed as described herein, and may be similar to FIG. 25, for example. The DACF 2506 may interact with the DLS 402 via a DLF-3 2504c. The SSSF 2502 may interact with the DLS via a DLF-4 2504d.

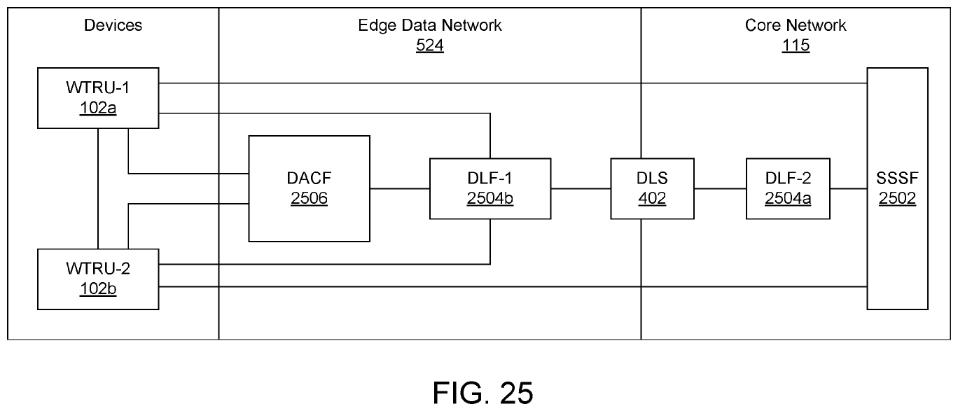

FIG. 28 is a system diagram illustrating another example deployment of distributed access control in a wireless network. For example, the wireless network may be a 3GPP cellular network having a core network 115 or a centralized data network. In FIG. 25, the WTRU 102, DACF 2506, and/or the SSSF 2502 may leverage the DLS 402 to store data access-related records. In FIG. 28, a DACF 2506 and an SSSF 2502 may use a (e.g., 5G) UDR 514 to store data access related records.

For example, in FIG. 28, a WTRU-1 102a, as a DO 404, may register its CHPP to the SSSF 2502 in the core network 115. The SSSF 2502 may store the WTRU-1 102a's CHPP to the UDR 514. The SSSF 2502 may generate the WTRU-1 102a's DID 202 and/or DIDDoc 208 and store them to the UDR 514.

For example, a WTRU-2 102b, as a DC 406, may register its CHPP to the SSSF 2502. The SSSF 2502 may store the WTRU-2 102b's CHPP to the UDR 514. The SSSF 2502 may generate the WTRU-2 102b's DID 202 and/or DIDDoc 208 and store them to the UDR 514.

For example, the WTRU-1 102a may register its data to the DACF 2506 which may be part of the edge data network 524 and/or the core network 115. The DACF 2506 stores the data (e.g., including its attributes) to the UDR 514. For example, the WTRU-2 102b may register its data to the DACF 2506. The DACF 2506 stores the data (e.g., including its attributes) to the UDR 514.

For example, the WTRU-2 102b may discover the WTRU-1 102a and/or the WTRU-1 102a's data from the DACF 2506.

For example, the WTRU-2 102b may request a data access token (e.g., directly) from the WTRU-1 102a.

For example, the WTRU-2 102b may present the data access token to the DACF 2506 to request the (e.g., discovered) WTRU-1 102a's data. The DACF 2506 may authenticate the data access token and/or authorize the WTRU-2 102b's data access request. After the authentication and/or authorization, the DACF 2506 may retrieve the requested data (e.g., from the UDR 514) and sends the retrieved data to the WTRU-2 102b.

In certain representative embodiments, the UDR 514 in FIG. 28 may be replaced with a DLT NF and/or AF (e.g., for storing the data). For example, the DLS 402 and the DSP 902 may be deployed as a (e.g., single) DLT NF for storing all the data (e.g., the control data such as various DIDDocs 208 and/or the application data registered by the DOs 404). In another example, the DACF 2506 may be integrated with the DLT NF, and the integrated DACF 2506 may have a function of conducting data access control and a function for storing data. The integrated DACF 2506 may be deployed as the DSP 902 and the DLS 402 as described herein.

### Service Flows for SSI Service Request

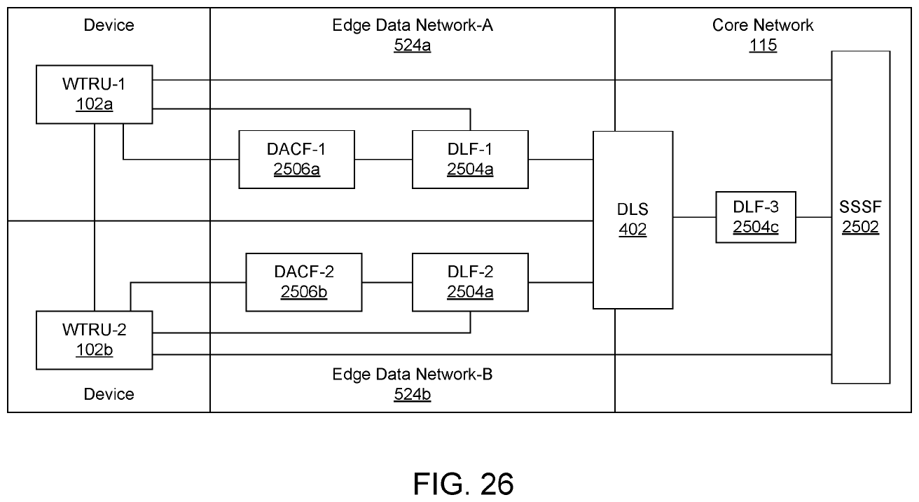

In certain representative embodiments, a DLF 2504 may be deployed as (e.g., part of) a UDR 514 and/or a DACF 2506. FIG. 29 is a flow diagram illustrating an example procedure for an SSI service request. For example, a WTRU 102 and/or an AF, such as may be disposed in a vehicle, may subscribe to an SSI service to be provisioned with a DID 202 and/or DIDDoc 208. The DID 202 and/or DIDDoc 208 may be used as decentralized identifiers to leverage services, such as decentralized data access. For example, during an SSI service request stage, the WTRU 102 may indicate its CHPP to a wireless network (e.g., a 3GPP cellular system). The wireless network may verify the WTRU's ownership of any information and/or service provided and/or requested by the WTRU 102.

As shown in FIG. 29, any of the following prior conditions may be assumed.

For example, an SSSF 2502 has registered to a NRF 502. For example, the SSSF 2502 has found a PCF 506, a UDR 514, and/or a DLF 2504.

For example, the DLF 2504 is configured to interface with a DLS 402.

For example, the WTRU 102 is registered to a 3GPP cellular network and is assigned with the SSSF 2502. As another example, the WTRU 102 may not be registered to the 3GPP cellular network. In that case, the WTRU 102 may include (e.g., an indication for) a SSI service request as a part of an initial and/or periodic registration (e.g., with an AMF 182) and/or as a part of a service request (e.g., to an AMF 182). For example, a WTRU-CHPP may be indicated and/or embedded in a registration request message and/or a service request message. An AMF 182 may discover the SSSF 2502 from the NRF 502 and may assign the discovered SSSF 2502 to the WTRU 102.

For example, the WTRU 102 may have generated a DID 202 (e.g., according to the definition of X-DID describe herein), which may be referred to as a WTRU-DID.

For example, the WTRU 102 may have generated its DIDDoc 208 (e.g., according to the definition of X-DIDDoc as described herein), which may be referred to as a WTRU-DIDDoc. For example, the generated WTRU-DIDDoc may include any of the WTRU-DID, a PKI-generated public key, authentication information, a time stamp, and/or any relatable public information about WTRU 102. The WTRU-DIDDoc may be resolved and/or indicated by the WTRU-DID. For example, the WTRU-DIDDoc may have been stored to the DLS 402 and/or the UDR 514.

For example, the WTRU 102 may have generated its CHPP (e.g., according to the CHPP definition as described herein), which may be referred to as a WTRU-CHPP.

At 2902 in FIG. 29, for example, the WTRU 102 may send a request message (e.g., an SSI Service Request) to the SSSF 2502. For example, the request may include information indicating any of: a WTRU-ID, a WTRU-role, a WTRU-CHPP, and/or a WTRU-DID. The WTRU-ID may indicate an identifier assigned by the 3GPP cellular network (e.g., 5G Global Unique Temporary Identifier (GUTI)). The WTRU-role may indicate whether the WTRU 102 is a DO 404 and/or a DC 406. The WTRU-CHPP may indicate a tuple (Yᵤ, p, q, g) generated and/or assigned to the WTRU 102. The WTRU-DID may have been previously assigned to the WTRU 102 by the SSSF 2502.

For example, the request at 2902 may be sent to the network as part of a WTRU 102 registration request. For example, the WTRU 102 may indicate that this request is associated with a slice that is included in a Requested NSSAI (Network Slice Selection Assistance Information). The WTRU 102 may access the service (e.g., SSI service) in the slice (e.g., if the slice provides SSI service).

For example, the request at 2902 may also be sent to the network as part of a PDU session establishment request. For example, the WTRU 102 may indicate that this request is associated with a DNN that is included in the PDU Session Establishment Request. The WTRU 102 may access the service (e.g., SSI service) in the DNN.

At 2904, the SSSF 2502 may retrieve SSI-related policies for the WTRU 102 from a PCF 506. A policy may specify that certain WTRUs are not using or may not use the SSI service according to their subscription data. For example, the SSSF 2502 may (e.g., first) send an SSI policy request to the PCF 506.

The SSI policy request may contain the WTRU-ID and/or the WTRU-role. The PCF 506 may send an SSI policy response to the SSSF 2502. The SSI policy response may include the content of any SSI policies applicable to the WTRU 102 at 2904. For example, the SSSF 2502 may retrieve a WTRU-DIDDoc corresponding to the received WTRU-DID at 2906. After authentication and/or encryption parameters are extracted from the WTRU-DIDDoc, the SSSF 2502 may start the authentication and identification process of the WTRU 102. The authentication process start with the use of the Auth(WTRU-DID) function as described herein.

At 2908, the SSSF 2502 may reject or accept the SSI service request from the WTRU 102 (e.g., according to the SSI policies retrieved from PCF 506). The SSSF 2502 may accept the SSI service request and generate a WTRU-sub-DIDDoc for the WTRU 102. The creation of the WTRU-sub-DIDDoc may follow the same structure described in the service subscription stage herein. For example, the WTRU-sub-DIDDoc may include information indicating any of the WTRU-Role, the WTRU-ID, the WTRU-CHPP, and/or an initial seed for the WTRU-CHCPP (e.g., selected by the SSSF 2502).

For example, at 2912, the SSSF 2502 may send WTRU information to the UDR 514. The WTRU information may include the WTRU-sub-DIDDoc. The UDR 514 may store the WTRU-sub-DIDDoc in a (e.g., centralized or distributed) storage system.

As another example, at 2914, the SSSF 2502 may (e.g., in the alternative) send the WTRU information to a DLF 2504. The WTRU information may include the WTRU-sub-DIDDoc. The DLF 2504 may store the WTRU-sub-DIDDoc in a DLS 402.

At 2916, after the registration of the WTRU-sub-DIDDoc is confirmed, the DLF 2504 may send the corresponding WTRU-sub-DID (e.g., an address or other index to the WTRU-sub-DIDDoc in the DLF 2504) to the SSSF 2502. The reception of the WTRU-sub-DID (e.g., by the SSSF 2502) may indicate confirmation for having appended the WTRU-sub-DIDDoc to the DLF 2504 (or DLS 402).

At 2918, the SSSF 2502 may send an SSI service response to the WTRU 102. The SSI service response may contain and/or indicate the WTRU-sub-DID and/or the additional WTRU-VC (e.g., assigned by the 3GPP cellular network to the WTRU 102). For example, the response message may include information that can be used by the WTRU 102 to contact the DACF 2506 (e.g., a FQDN (Fully Qualified Domain Name) and/or an IP address of the DACF 2506). For example, the response message may be sent to the WTRU 102 in a WT RU registration response and/or a PDU session establishment accept.

### Service Flows for Data Registration

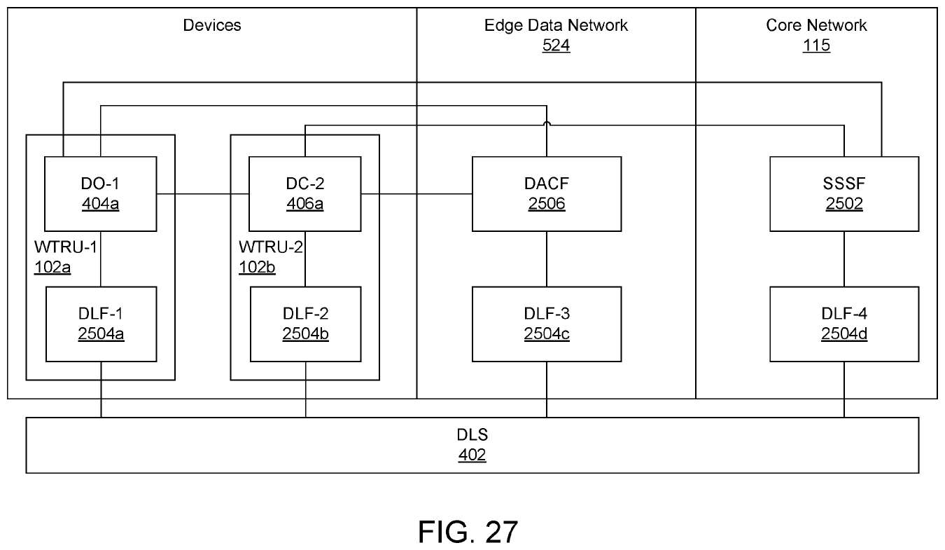

In certain representative embodiments, a DLF 2504 may be deployed as (e.g., part of) a UDR 514 and/or a DACF 2506. FIG. 30 is a flow diagram illustrating an example procedure for an SSI data registration service request. For example, a WTRU 102 and/or an AF, such as may be disposed in a vehicle, may have collected, measured, and/or otherwise generated data (e.g., environmental data, traffic data, AI and/or ML training data, and/or an AI and/or ML model data). The data may be of interest to other network participants.

As shown in FIG. 30, any of the following prior conditions may be assumed.

For example, a DACF 2506 may have registered to an NRF 502.

For example, the DACF 2506 may have found a PCF 506, a UDR 514, and/or a DLF 2504.

For example, the DLF 2504 may be configured to interface with a DLS.

For example, a DO 404 may be the WTRU 102 and/or the AF.

For example, the WTRU 102 may be registered to a 3GPP cellular network. The WTRU 102 may have been assigned with or has discovered the DACF 2506.

For example, interactions between the WTRU 102 and the DACF 2506 may be relayed by an AMF 182.

For example, interactions between the AF and the DACF 2506 may be relayed by a NEF (e.g., known by the AF).

For example, the WTRU 102 may subscribe to SSI service from an SSSF 2502. Any of a WTRU-CHPP, a WTRU-sub-DID, and/or a WTRU-sub-DIDDoc may have been published to a UDR 514 and/or DLS 402. The WTRU 102 may store its WTRU-DID and/or WTRU-sub-DID locally. For example, the Data-DIDDoc may include public information and description about data and a CH link to the WTRU-DID. The Data-DID may refer to and/or indicate a Data-DIDDoc address. The Data-DIDDoc may be resolved and/or indicated by the Data-DID. The Data-CHCPP may refer to the CH collision parameters computed by the WTRU 102 during data registration to link the data-CH to the WTRU-DID-CH.

As shown at 3002 in FIG. 30, the WTRU 102 prepares the data, which will be registered to the DACF 2506. As a part of data preparation, WTRU 102 may determine any of data registration parameters (e.g., data-reg-requirements). For example, a data registration parameter may indicate the WTRU's data registration requirements. As an example, a registration scope may be indicated. The WTRU 102 may request to simply register data without storing the data to a UDR 514 and/or DLS 402 (e.g., the WTRU 102 may not send data to the DACF 2506 at 3022 in FIG. 30). As another example, the WTRU 102 may request to register data and to store the data to the UDR 514 or DLS 402 (e.g., the WTRU 102 may send the data to the DACF 2506 at 3022 in FIG. 30). As another example, a data registration parameter may indicate a storage size requirement for storing the registered data. The WTRU 102 may indicate the size of required storage to store the registered data.

At 3004, the WTRU 102 may send a request (e.g., data registration request) to the DACF 2506. The request may include the WTRU-sub-DID. The DACF 2506 may use the WTRU-sub-DID to authenticate and identify the WTRU 102 before accepting the request sent at 3002.

For example, before 3004, the WTRU 102 may have received an identity of the DACF 2506 during registration to the network. The identity of the DACF 2506 may be provided as an IP Address and/or an FQDN. The identity of the DACF 2506 may be associated with a slice that is identified with an S-NSSAI (Single-NSSAI). When the WTRU 102 registers to a slice, the network may be triggered to provide the identity of the DACF 2506 to the WTRU 102 and/or indicate what S-NSSAI the identity of the DCAF is associated with.

For example, the WTRU 102 may be configured with a URSP (UE Route Selection Policy) rule. The URSP rule may include a Traffic Descriptor that is associated with the DACF 2506. When signaling (e.g., application layer signaling) towards the DACF 2506 is initiated, the URSP rule may trigger the WTRU 102 to establish a PDU Session with an S-NSSAI/DNN combination that may be used to reach the DACF 2506.

At 3006, the DACF 2506 may receive the request (e.g., data registration request) sent at 3004. The DACF 2506 may retrieve any data registration policies for the WTRU 102 from the PCF 506 at 3006. In certain representative embodiments, a data registration policy may include any of: (1) the WTRU 102 is (e.g., only) allowed to register a certain type(s) of data, (2) the WTRU 102 is (e.g., only) allowed to register data during certain time durations (e.g., days or other periods and/or intervals), (3) the WTRU 102 is (e.g., only) allowed to register data at certain locations, and/or (4) a maximum number of allowed registrations for the WTRU 102. For example, the DACF 2506 may control the number of allowed registrations (e.g., per WTRU 102). A number of data registrations from the WTRU 102 may (e.g., shall) not exceed the number of allowed registrations. At 3008, the DACF 2506 may request access to the WTRU-sub-DIDDoc from the DLS 402 to extract the information needed to authenticate the UE at 3010.

At 3010, based on the retried data registration policies and/or the information extracted from the WTRU-sub-DIDDoc, the DACF 2506 may authenticate the WTRU 102 and verifying its identity using Auth(WTRU-DID) process as described herein. At 3010, the DACF 2506 may authorize and/or authenticate the WTRU 102 and determine the request sent at 3004 is approved or rejected.

At 3012, based on the authentication at 3010, on condition that the request (e.g., Data Registration Request) is rejected, 3016 to 3026 in FIG. 30 will be skipped. On condition that the request is approved, the DACF 2506 may request data and its corresponding information from the WTRU 102 to initiate registration and storage.

At 3014, the WTRU 102 may compute the needed Data-CHCPP that will cause collisions between the Data-CH and the WTRU-CH (e.g., the chameleon hash values of the data and WTRU-DID, respectively).

At 3016, the WTRU 102 may send a message to the DACF 2506 containing any of data-content, data-attributes, data-CHCPP, data-ID, and/or data accessibility parameters. For example, the data-content may be the data to be registered and it may be stored to the UDR 514 and/or the DLF 2504. For example, the data-attributes may be a list of data attributes. Each attribute may describe a feature and/or a characteristic of the data being registered. Data attributes may be metadata. For example, the Data-CHCPP are the chameleon hash public parameters of the data being registered. For example, the data-ID may be a local (e.g., unique) ID of the data being registered and/or a (e.g., unique) DID 202 for the data. The data-ID may include a data fingerprint (e.g., of the content being registered). For example, the data accessibility parameters may indicate whether the WTRU 102 is willing to offer the data for rent, ownership transfer, or both.

At 3018, the DACF 2506 may confirm that there is a collision between the chameleon hash of the received data fingerprint and the WTRU-DID, such as by using the Verify_Collision(WTRU-DID-CH, Data-CH) function described herein. The DACF 2506 may generate a Data-DIDDoc for the data being registered (e.g., based on parameters as received at 3016). The generated Data-DIDDoc may contain any of: a data-hash (e.g., Data-CH), a data-DID, a data-DIDDoc, data-attributes, data-access-policies, and/or a data-address. For example, the data-DID may be a (e.g., unique) DID 202 for the data. For example, the data-Attributes may include the data-Attributes from 3016. For example, the data-access-policies may be for the data being registered (e.g., retrieved by the DACF 2506 from the PCF 506). The data access policies may indicate any of: (1) only some data attributes can be accessed by DCs 406, (2) both data-content and data-attributes can be accessed by DCs 406, and/or (3) data access frequency (e.g., a number of accesses). For example, the data-address may indicate where the data (e.g., data-content) is stored (e.g., in an external data storage system). For example, the data-address may indicate where the data has been stored with the UDR 514.

At 3020, the DACF 2506 may store the data (e.g., data-content) with the UDR 514. For example, the DACF 2506 may also store the Data-DIDDoc with the UDR 514.

At 3022, the DACF 2506 may publish the Data-DIDDoc to the DLS 402 via the DLF 2504. For example, the DLF 2504 may be exposed to and may be discovered by any DCs 406 that may be interested in the data being registered. For example, the data registration as requested by WTRU 102 at 3004 may be completed by the DACF 2506.

At 3024, after confirming the received Data-DIDDoc from the DACF 2506, the DLF 2504 may send the Data-DID (e.g., address) of the confirmed Data-DIDDoc to the DACF 2506.

At 3026, the DACF 2506 may send a response (e.g., data registration response) to the WTRU 102. For example, the response may contain any of a Reg-ID (e.g., a same Reg-ID as received at 3004) and/or a Data-DID (e.g., a same Data-DID as received at 3024).

### Service Flows for Data Access

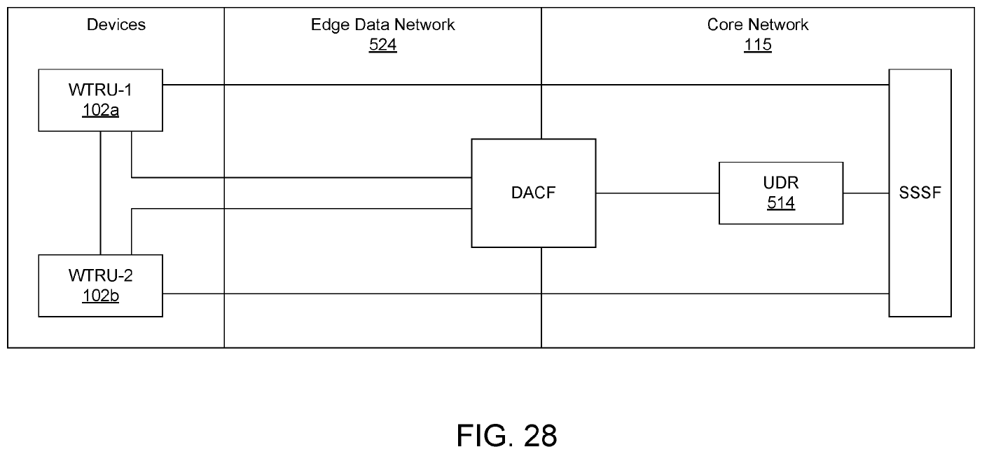

In certain representative embodiments, a DLF 2504 may be deployed as (e.g., part of) a UDR 514 and/or a DACF 2506. FIG. 31 is a flow diagram illustrating an example procedure for data access. a WTRU 102b may want or need to access data which may be provided by (e.g., owned) by a WTRU-1. For example, the WTRU-1 102a (e.g., within a vehicle) may find and/or access data, such as environmental data, traffic data, and/or AI or ML data (e.g., a trained AI model), which may be provided by the WTRU-1 102a (e.g., from another vehicle).

As shown in FIG. 31, any of the following prior conditions may be assumed.

For example, a DACF 2506 may be registered to a NRF 502.

For example, the DACF 2506 may have found a PCF 506, a UDR 514, and/or a DLF 2504.

For example, the DLF 2504 may interface with a DLS 402.

For example, the WTRU-1 102a is registered to a 3GPP cellular network. For example, the WTRU-1 102a may be assigned with and/or has discovered the DACF 2506.

For example, the WTRU 102b may be registered to the 3GPP cellular network. For example, the WTRU 102b may be assigned with and/or has discovered the DACF 2506.

For example, the interactions between the WTRU-1, the WTRU 102b and/or the DACF 2506 may be relayed by an AMF 182.

For example, the WTRU-1 102a and/or the WTRU 102b may have generated a DID 202 (e.g., according to the definition of X-DID described herein), which may be referred to as a WTRU-1-DID and a WTRU-2-DID, respectively.

For example, the WTRU-1 102a and/or the WTRU 102b may have generated a DIDDoc 208 (e.g., according to the definition of X-DIDDoc as described herein), which may be referred to as a WTRU-1WTRU-1-DIDDoc and a WTRU-2-DIDDoc, respectively. For example, the generated WTRU-1WTRU-1-DIDDoc may include any of the WTRU-1WTRU-1-DID, a PKI-generated public key (e.g., of WTRU-1WTRU-1), authentication information (e.g., of WTRU-1WTRU-1), a time stamp, and/or any relatable public information about WTRU-1WTRU-1 102a. For example, the WTRU-1WTRU-1-DIDDoc may be resolved and/or indicated by the WTRU-1WTRU-1-DID. For example, the generated WTRU-2-DIDDoc may include any of the WTRU-2-DID, a PKI-generated public key (e.g., of WTRU-2 102b), authentication information (e.g., of WTRU-2 102b), a time stamp, and/or any relatable public information about WTRU-2 102b. For example, the WTRU-2-DIDDoc may be resolved and/or indicated by the WTRU-2-DID.

For example, a WTRU-1WTRU-1-sub-DIDDoc and/or a WTRU-2-sub-DIDDoc may have been stored to the DLS 402 and/or the UDR 514.

For example, the WTRU-1 102a may generate its CHPP (e.g., according to the CHPP definition as described herein), which may be referred to as a WTRU-1WTRU-1-CHPP.

For example, the WTRU 102b may have subscribed to SSI service from an SSSI. For example, the WTRU-1 102a may have a WTRU-1WTRU-1-sub-DIDDoc. The WTRU-1WTRU-1-sub-DIDDoc may be obtained as described in FIG. 29. For example, parameters (e.g., WTRU-1-CHPP, WTRU-1-DID, and WTRU-1-DIDDoc) for WTRU-1 102a may have been published to the UDR 514 and/or the DLS 402.

For example, the WTRU-1 102a may have successfully registered its data through the DACF 2506.

For example, the WTRU 102b may have subscribed to SSI service from an SSSI. For example, the WTRU 102b may have a WTRU-2-sub-DIDDoc. The WTRU-2-sub-DIDDoc may be obtained as described in FIG. 29. For example, parameters (e.g., WTRU-2-CHPP, WTRU-2-DID, and WTRU-2-DIDDoc) for WTRU 102b may have been published to the UDR 514 and/or the DLS 402.

At 3102 as shown in FIG. 31, the WTRU-2 102b, as a DC, may send a request (e.g., data discovery request) to the DACF 2506 to discover any registered data (e.g., of its interest). For example, the request may include any of: data-attributes and/or a WTRU-2-sub-DID. For example, the data-attributes may indicate a list of data attributes (e.g., as discovery criteria to find desired or target data). For example, the WTRU-2-sub-DID may indicate a (e.g., unique) subscription DID 202 of the WTRU-2 102b. The WTRU-2-sub-DID may be received by the WTRU 102b from the SSSI (e.g., as a result of SSI service request procedure or other processes).

At 3104, based on the data-attributes from 3102, the DACF 2506 may discover desired data from the UDR 514 and/or the DLS 402 (e.g., on behalf of WTRU-2 102b).

At 3106, the DACF 2506 may send a response (e.g., a data discovery response) to the WTRU-2 102b. For example, the response may include any of a Data-List, the WTRU-1-sub-DID, and/or a Data-DID. For example, the Data-List may include a list of discovered data items. Each data item may represent a discovered target data. Each data item may include the WTRU-1-sub-DID (e.g., indicates the DID 202 of the data owner, which owns and has registered the data) and/or the Data-DID (e.g., indicates the DID 202 that (e.g., uniquely) identifies the discovered data).

In certain representative embodiments, as an alternative approach to 3102-3106 in FIG. 31, the WTRU 102b may discover target data directly from the DLS 402 via the DLF 2504, such as by querying data registration records that have been stored to the DLS 402. The WTRU 102b may also (e.g., directly) look up target data from the UDR 514 (e.g., after data registration records have been stored to the UDR 514).

At 3108, the WTRU 102b may send a request (e.g., a data access request) to WTRU-1 102aWTRU-1 102a to request the access to one or multiple data items (e.g., owned by WTRU-1 102a and discovered at 3106). For example, the request may be sent from the WTRU 102b to the WTRU-1 102a (e.g., directly, such as by using PC5 or a side link). For example, the request may be broadcasted to all WTRUs that are in proximity. The WTRU-1 102a may know the request is intended for WTRU-1 102a when the request includes a DID 202 belonging to WTRU-1. For example, the request may include any of the WTRU-2-sub-DID and/or the Data-DID (e.g., one or multiple Data-DIDs as received in 3).

In certain representative embodiments, as an alternative approach to 3108 in FIG. 31, the WTRU 102b may send the request to the DACF 2506. The DACF 2506 may forward the request to WTRU-1 102a (e.g., on behalf of WTRU-2 102b). Before forwarding the request to the WTRU-1, the DACF 2506 may verify the WTRU-2's DC-DID and may decides if the forwarding is approved or not.

At 3110, the WTRU-1 102a may authenticates the WTRU 102b by invoking Auth(WTRU-2-DID) as described herein. For example, the WTRU 102b may authenticate 3112 the identity of the WTRU-1 102a by executing Auth(WTRU-1-DID) function as described herein.

At 3114, the WTRU-1 102a may generate any data access policies (e.g., negotiate a data access agreement) for the WTRU-2 102b. For example, one or more data access policies may be set for each data item as requested at 3108.

At 3116, the WTRU-1 102a may generate a data access token for the WTRU 102b (e.g., DC-Data-Access-Token). The data access token may be generated based on the parameters as received at 4. For example, if multiple Data-DID are requested at 4, the WTRU-1 102a may generate multiple different DC-Data-Access-Tokens, one for each data item as denoted by the associated Data-DID. After, the WTRU-1 102a may compute the chameleon hash collision public parameters (e.g., Token-CHCPP) for each data item requested at 4.

At 3118, the WTRU-1 102a may store any of the data access policies (e.g., DC-Data-Access-Agreement) to the UDR 514 and/or the DLS 402. For example, the storage may be performed directly (e.g., without the use of the DACF 2506) or indirectly (e.g., as relayed and controlled by the DACF 2506).

At 3120, the WTRU-1 102a may send a request (e.g., a data access response) to the WTRU-2 102b. For example, the response may include any of: a DC-Data-Access-Token (e.g., to indicate one or multiple data access tokens), a Token-CHCPP (e.g., chameleon hash public parameters for each data item), and/or a data access agreement ID (e.g., to indicate the identifier of appropriate data access policies, such as those the WTRU-1 102a has determined and/or negotiated for WTRU-2 102b).

At 3122, the WTRU-2 102b may send a request (e.g., a data retrieval request) to the DACF 2506. For example, the request may include any of: a DC-Data-Access-Policy-ID (e.g., a same or a subset of DC-Data-Access-Policy-IDs as received at 3118), a DC-Data-Access-Token (e.g., a same or a subset of the DC-Data-Access-Tokens as received at 3120), and/or a DC-Data-CHPP (e.g., a same or a subset of the DC-Data-CHPP as received at 3120).

At 3124, the DACF 2506 may use the chameleon hash to find a collision to authenticate and authorize the request (e.g., data retrieval request) as received at 3122). For example, the DACF 2506 may execute the Verify_Collision(Data-CH, WTRU-1-CH) function as described herein. On condition that the DACF 2506 does not find a collision, the request may (e.g., will) be rejected.

At 3126, on condition that the request passes the authentication at 3124 (e.g., a collision is found), the DACF 2506 may retrieve the requested data from the UDR 514 and/or the DLS 402. For example, the DACF 2506 may send a response (e.g., a data retrieval response) which may include the requested data (e.g., Data-Content) to the. Otherwise (e.g., on condition that the request did not pass the authentication at 3124), the DACF 2506 may send a response to the WTRU-2 102b indicating a failure (e.g., of the data retrieval request).

### Service Flows for Locally Stored Data Registration

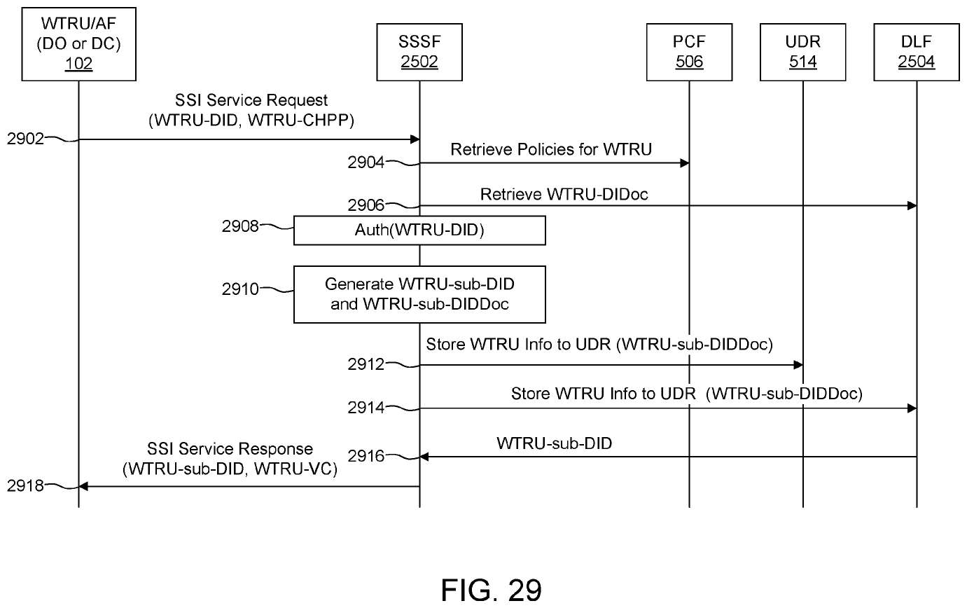

FIG. 32 is a flow diagram illustrating another example procedure for data registration. In certain representative embodiments, data (e.g., to be registered) may be stored locally. In certain representative embodiments, a DLF 2504 may be deployed as (e.g., part of) a UDR 514 and/or a DACF 2506. For example, a WTRU 102 and/or an AF, such as may be disposed in a vehicle, may have content (e.g., entertainment and/or infotainment data) which is offline and/or may be subject to offloading services. For example, the WTRU 102 may store the content (e.g., data) in local storage and may register the locally stored data for discovery by other participants.

As shown in FIG. 32, any of the following prior conditions may be assumed.

For example, an SSSF 2502 be registered to a NRF 502.

For example, the SSSF 2502 may have found a PCF 506, a UDR 514, and/or a DLF 2504.

For example, the DLF 2504 may interface with a DLS 402.

For example, a DO 404 may be a WTRU 102 and/or an AF.

For example, the WTRU 102 may be registered to a 3GPP cellular network.

For example, the WTRU 102 may have subscribed to an SSI service from the SSSF 2502 (e.g., before). A WTRU-CHPP, a WTRU-sub-DID, and/or a WTRU-sub-DIDDoc may have been published to the UDR 514 and/or the DLS 402.

For example, the WTRU 102 may have been provided (e.g., configured and/or indicated) with a WTRU-DID and/or a WTRU-sub-DID, which may be stored locally.

For example, a Data-DIDDoc may include public information and/or a description about data and/or a CH link to the WTRU-DID.

For example, a Data-DID may refer to and/or indicate the Data-DIDDoc address. The Data-DID may resolve the content of the associated Data DIDDoc.

For example, a Data-CHCPP may refer to the CH collision parameters (e.g., computed by the WTRU 102 during a data registration process to link a data-CH to a WTRU-DID-CH).

For example, the WTRU 102 may have sent the data content to an SSSF 2502 for validation and authorization purposes (e.g., not for external storage).

For example, the SSSF 2502 may (e.g., will) not store the received data. The SSSF 2502 may (e.g., only) check the integrity and/or uniqueness of data.

At 3202 in FIG. 32, the WTRU 102 may prepare data, which will be stored locally. For data discovery, the WTRU 102 may want or need to register it (e.g., ownership) within the system. The data preparation may be performed (e.g., similarly) to the description of FIG. 30. In FIG. 32, SSSF 2502 may be replaced with a DACF 2506.

At 3204, the WTRU 102 may send a request (e.g., a data registration request) to the SSSF 2502. For example, the request may include the WTRU-sub-DID, such that the SSSF 2502 can authenticate and identify WTRU 102 before accepting the request.

At 3206, the SSSF 2502 may receive the request (e.g., a data registration request) from 3204. For example, the SSSF 2502 may retrieve any data registration policies for the WTRU 102 from the PCF 506 at 3206. After, the SSSF 2502 may request to access (e.g., retrieve) the WTRU-sub-DIDDoc from the UDR 514 and/or the DLS 402 to extract the information needed to authenticate WTRU 102 at 3208.

At 3210, based on the information extracted from WTRU-sub-DIDDoc, the SSSF 2502 may authenticate WTRU 102 and verify the WTRU's identity through executing the Auth(WTRU-1-DID) function as described herein. For example, the SSSF 2502 may authorize and/or authenticate the WTRU 102. For example, the data registration request may be approved or rejected based on the authorization and/or authentication of the WTRU 102.

At 3212, based on the authentication at 3210, on condition that the data registration request is rejected, 3216-3226 may be skipped. On condition that the data registration request is approved, the SSSF 2502 may request the data and its corresponding information from WTRU 102 for registration at 3212.

At 3214, the WTRU 102 may compute the needed Data-CHCPP that will cause a collision between the Data-CH and a DID CH value (e.g., the chameleon hash of WTRU-DID).

At 3216, the WTRU 102 may send a message to the SSSF 2502. For example, the message may include and/or indicate any of Data-Content, Data-Attributes, Data-CHCPP, Data-ID, and/or data accessibility parameters. For example, the Data-Content may refer to the data content that the WTRU 102 wants to store or stores locally and is subject to registration. The inclusion of the data may be mandatory for the SSSF 2502 to authorize and validate a collision between the data fingerprint and the WTRU-DID-CH. For example, the Data-Attributes may refer to a list of data attributes. Each attribute may describe a feature, or a characteristic of the data being registered. Data attributes may be considered metadata. For example, the Data-CHCPP may be or indicate the chameleon hash public parameters of the data being registered. For example, the Data-ID may be a local (e.g., unique) ID of the data being registered. As another example, the Data-ID may include a data fingerprint (e.g., of the data being registered). For example, the data accessibility parameters may indicate whether the WTRU 102 is willing to offer the data for rent, ownership transfer, or both.

At 3218, the SSSF 2502 may confirm a collision between the chameleon hash of the received data fingerprint and the WTRU-DID by invoking the Collision_Verify (WTRU-CH, Data-CH) function. For example, the SSSF 2502 may (e.g., proceed) to generate a Data-DIDDoc for the data being registered (e.g., based on parameters received at 3216). The generated Data-DIDDoc may contain similar parameters to 3018 in FIG. 30.

At 3220, the SSSF 2502 may store a Data-Reg-Record to the UDR 514 (e.g., in the form of a Data-DIDDoc).

At 3222, the SSSF 2502 may publish the Data-DIDDoc (e.g., Data-Reg-Record) to the DLS 402 via the DLF 2504. For example, the Data-DIDDoc may be exposed to and/or may be discovered by any DCs 406 that may interested in the data being registered. For example, the SSSF 2502 may have completed the data registration as requested by WTRU 102 at 3204.

At 3224, after confirming the received Data-DIDDoc from the SSSF 2502, the DLF 2504 may send an address (e.g., Data-DID) of the confirmed Data-DIDDoc to the SSSF 2502.

At 3226, the SSSF 2502 may send a response (e.g., data registration response) to the WTRU 102. For example, the response may include any of the Reg-ID (e.g., as received at 3204) and/or the Data-DID (e.g., as received at 3224)

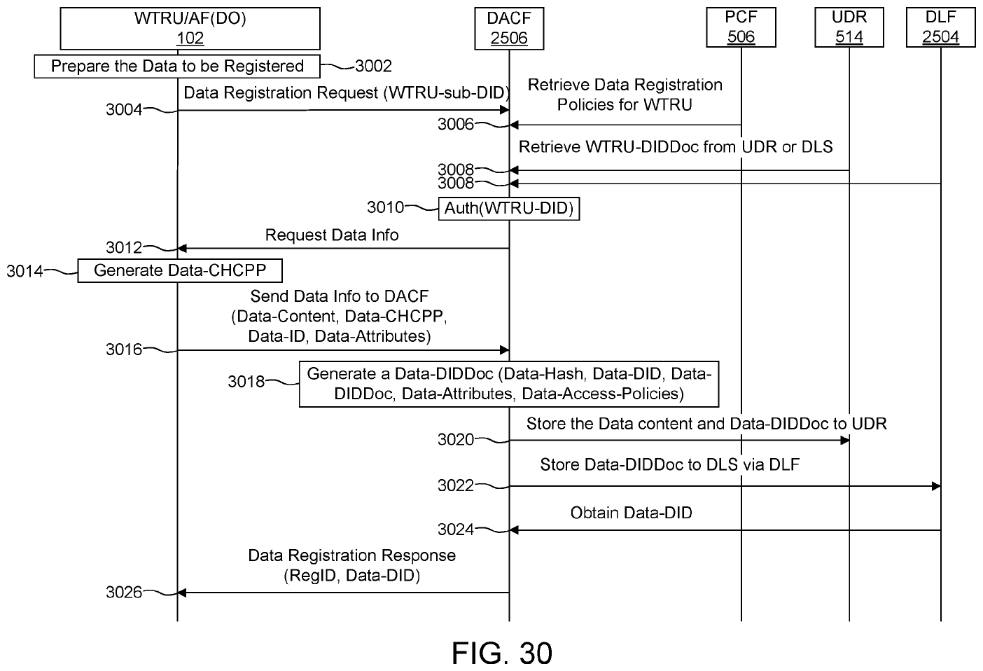

FIG. 33 is a system diagram illustrating an example deployment of distributed data management access control in an ETSI PDL system 3302. In certain representative embodiments, one or more DOs 404 and one or more DCs 406 may be implemented as users and/or applications of the PDL system 3302. In certain representative embodiments, the functionalities of the proposed SSI SP 904 and/or DLS 402 may be implemented as a PDL platform service. The PDL platform service may be referred to as a data registration and access service (DRAS) 3304 in a PDL platform service layer 3306. For example, the DRAS 3304 may interact with a distributed ledger technology (DLT) layer (e.g., a DLS 402 which includes one more underlying DLT networks and DLT nodes 3310a, 3310b, 3310c, 3310d). The DLS 402 may be implemented by and/or supported by the underlying DLT networks.

A SSI mechanism enables DOs 404 and/or DCs 406 to govern and manage their (e.g., portable, global, and/or decentralized) identifiers (e.g., DIDs). For example, the DIDs may not depend on any central authority. In addition, some hashing technologies, such as chameleon hash (CH), not only support traditional collision-free hashing but also may purposely induce hash collisions between two or more different pieces of information (e.g., m₁, m₂, m₃) resulting in having the same hash value for all those pieces of information. Such hash collisions among different pieces of information (e.g., m₁, m₂, m₃) may be conducted (e.g., induced) using a secret collision trapdoor key. DRAS leverages and supports both SSI and CH to provide decentralized data management and access control services.

For example, the DRAS 3304 enables DOs 404 to provide effective access control to DCs 406, even where the data is not directly hosted by the DOs 404 but stored by a PDL system 3302 to an external DSP 902 and/or to an underlying DLT network. A DO 404 may register its owned data to the DRAS 3304 and record the data (e.g., either locally or within a DLS 402 or an external storage). The DO 404 may produce a hashing collision between a DO-DID (e.g., as m₁) and the data (e.g., as m₂), which therefore establishes and/or demonstrates data ownership since only the DO 404 knows the secret trapdoor key to produce a hash collision.

When a DC 406 intends to access the data (e.g., as m₂), the corresponding DO 404 may induce another hash collision between an access token (e.g., as m₃) to be assigned to the DC 406 and the data to be accessed. The DO 404 may send the access token to the DC 406. The DC 406 may present the access token to the DRAS 3304.

The DRAS 3304 may allow the DC 406 to access the data (e.g., only) after the hash collision (e.g., a collision between the hash values of the access token and the data) is verified, which therefore realizes the fully decentralized data management and access control of DOs 404. In certain representative embodiments, the DRAS 3304 may conduct other data management and access control activities, such as data ownership transfer (e.g., a DC 406 intends to permanently hold/own the data from a DO 404), and/or data ownership revocation (e.g., when a DO's identity credentials are stolen or compromised), etc.

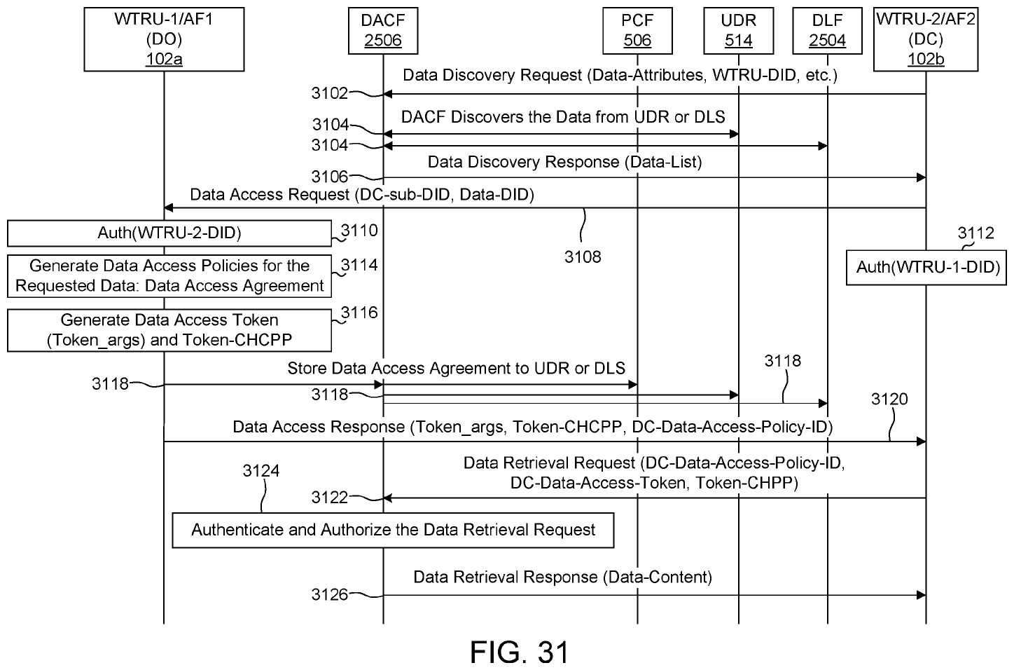

FIG. 34 is a procedural diagram illustrating an example procedure to register data ownership by a data owner. In certain representative embodiments, a WTRU 102 (e.g., as a data owner) may perform a procedure (e.g., implemented as a method) which includes to send, by the WTRU 102, information indicating a request to register data at 3402. For example, the request may include information indicating an identifier (e.g., DO-DID) of an owner of the data. The WTRU may determine a set of chameleon hash (CH) collision public parameters, including an aᵤ′ parameter and a bᵤ′ parameter, based on a CH collision function using a secret key of the owner, a CH value of an (e.g., decentralized) identifier of the owner, a hash value of the data, and a set of public parameters at 3404. The WTRU may send information indicating (1) the data to be registered and (2) the set of CH collision public parameters of the data at 3406. The WTRU may receive, from an access control entity (e.g., a DACF 2506), information indicating an identifier of the registered data at 3408.

For example, the secret key may be a private trapdoor key Xᵤ.

For example, the WTRU may determine the private trapdoor key Xᵤ as a random number from a set of numbers. The set of numbers may be associated with a first prime number q. The WTRU may determine a public hash key Yᵤ based on a function of a cryptographic primitive g, the private trapdoor key, and a second prime number p.

For example, the WTRU may derive the set of CH collision public parameters based on (1) a CH collision function, and (2) the private trapdoor key Xᵤ, a CH hash value of the identifier of the owner, the hash value of the data, the first prime number q, the second prime number p, and the cryptographic primitive g, as parameters of the CH collision function.

For example, the identifier of the owner may be verified credential information of the owner.

For example, the WTRU may determine the hash value of the data based on a data fingerprint of the data using a predetermined hashing algorithm (e.g., SHA).

For example, the information indicating the data to be registered may include a hash value of the data and/or the content of the data.

For example, the identifier of the registered data may be associated with a storage address and/or location of the data with the access control entity.

For example, the request to register the data may be sent to the access control entity.

For example, the (1) the data to be registered and (2) the set of CH collision public parameters of the data may be sent to the access control entity (e.g., a DACF 2506).

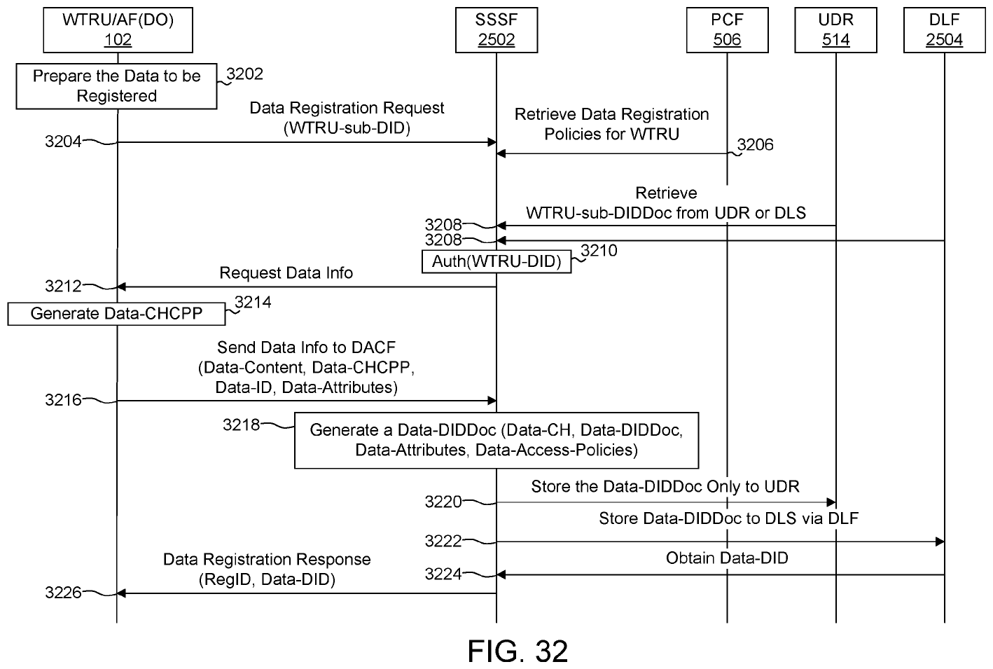

FIG. 35 is a procedural diagram illustrating an example procedure to access data owned by a data owner. In certain representative embodiments, a WTRU 102 (e.g., as a data owner) may perform a procedure (e.g., implemented as a method) which includes to receive, from a data consumer, information indicating a request to access data (e.g., owned by the data owner) at 3502. For example, the request may include an identifier of the data consumer (e.g., DC-DID) and an identifier of the data. The WTRU may generate a data access token and a set of token chameleon hash (CH) collision public parameters at 3504. For example, the set of token CH collision public parameters may include an aᵤ′ parameter and a bᵤ′ parameter which are based on a CH collision function using a secret key of the owner, a CH value of an (e.g., decentralized) identifier of an owner of the data, a hash value of the data access token, and a set of public parameters. The WTRU may send, to the data consumer, information indicating a response to the request at 3506. For example, the response may include the data access token and the set of token CH collision public parameters.

For example, the data access token may include information indicating any of a timestamp associated with data access of the data, the identifier of the data consumer, the identifier of the data, and/or an address of an access agreement associated with the data.

For example, the WTRU may determine the private trapdoor key X as a random number from a set of numbers. For example, the set of numbers may be associated with a first prime number q. The WTRU may determine a public hash key Yᵤ based on a function of a cryptographic primitive g, the private trapdoor key, and a second prime number p.

For example, the WTRU may derive (e.g., determine) a set of CH collision public parameters for the data based on (1) a CH collision function, and (2) the private trapdoor key Xᵤ, a CH hash value of the identifier of the owner, the hash value of the data, the first prime number q, the second prime number p, and the cryptographic primitive g, as parameters of the CH collision function. The WTRU may send information indicating (1) the data to be registered and (2) the set of CH collision public parameters of the data to an access control entity (e.g., a DACF 2506).

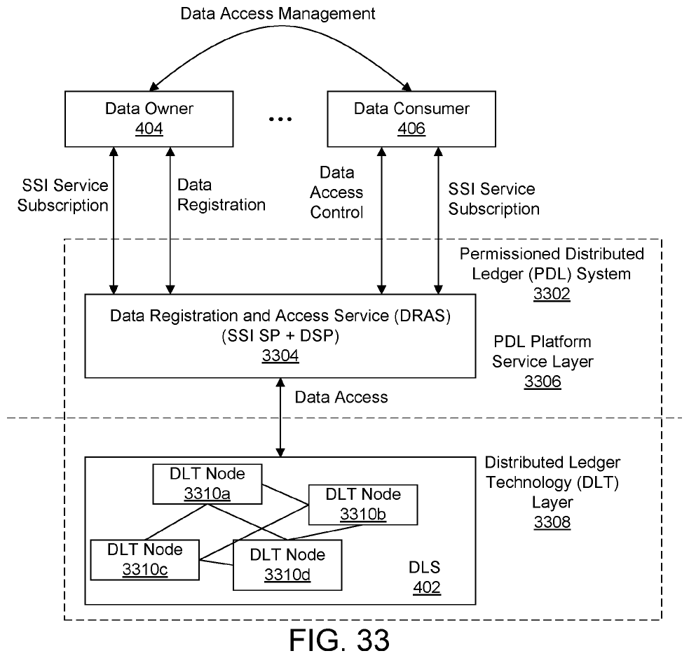

FIG. 36 is a procedural diagram illustrating an example procedure to access data owned by a data owner. In certain representative embodiments, a WTRU 102 (e.g., as a data consumer) may perform a procedure (e.g., implemented as a method) which includes to send, to a data owner, information indicating a request to access data owned by the data owner at 3602. For example, the request may include an identifier of the data consumer and an identifier of the data. The WTRU may receive, from the data owner, information indicating a response to the request at 3604. For example, the response may include a data access token and a set of token CH collision public parameters. For example, the set of token CH collision public parameters may include an aᵤ′ parameter and a bᵤ′ parameter which are based on a CH collision function using a secret key of the data owner, a CH value of a decentralized identifier of the data owner, a hash value of the data access token, and a set of public parameters. The WTRU may send, to an access control entity (e.g., a DACF 2506), information indicating a retrieval request for the data at 3606. For example, the retrieval request may include the data access token and the set of token CH collision public parameters.

For example, the WTRU may receive, from the access control entity, content of the data based on verification (e.g., using Verify_Collision) of a collision existing using the retrieval request.

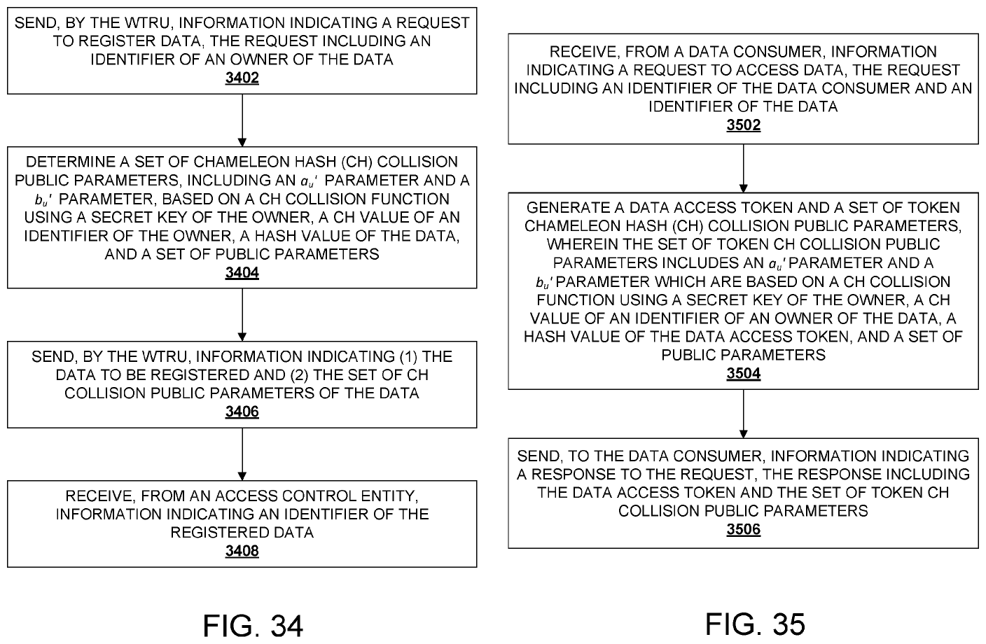

FIG. 37 is a procedural diagram illustrating an example procedure to register ownership of data in a network. In certain representative embodiments, a network entity, such as an access control entity (e.g., a DACF 2506), may perform a procedure (e.g., implemented as a method) which includes to receive, from a data owner, information indicating (1) data to be registered and (2) a set of CH collision public parameters of the data at 3702. For example, the set of CH collision public parameters for the data may be based on a CH collision function (e.g., performed by the data owner) using a secret key of the owner, a CH value of a decentralized identifier of the owner, a hash value of the data, and a set of public parameters. The network entity may receive, from a data consumer, information indicating a retrieval request for the data at 3704. For example, the retrieval request may include a data access token and a set of token CH collision public parameters. For example, the set of token CH collision public parameters includes parameters includes an aᵤ′ parameter and a bᵤ′ parameter which are based on the CH collision function (e.g., performed by the data owner) using the secret key of the owner, a CH value of a decentralized identifier of the owner, a hash value of the data access token, and the set of public parameters.

For example, the network entity may verify (e.g., using Verify_Collision) whether a collision exists for the retrieval request using the set of CH collision public parameters, the set of token CH collision public parameters. The network entity may send, to the data consumer, content of the data based on the verification that the collision exists.

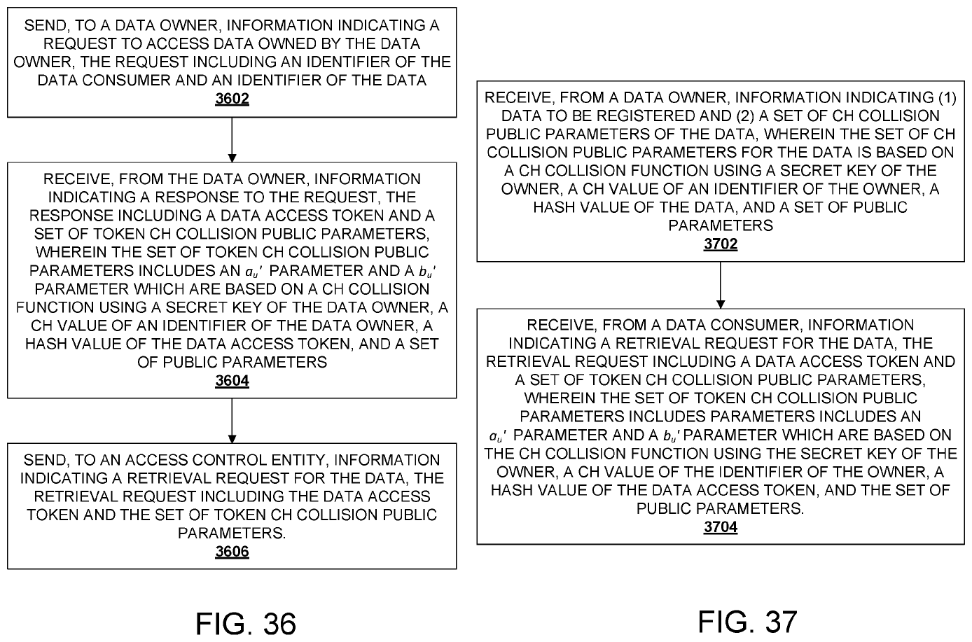

FIG. 38 is a procedural diagram illustrating an example procedure to transfer ownership of data owned by a data owner. In certain representative embodiments, a WTRU 102 (e.g., as a data owner) may perform a procedure (e.g., implemented as a method) which includes to receive, from a data consumer, information indicating a request to transfer ownership of data at 3802. For example, the request may include an identifier of the data consumer and an identifier of the data. The WTRU 102 may generate, based on registration of a transfer agreement (e.g., between the data owner and data consumer to permit ownership transfer of the data), a data transfer token and a set of token chameleon hash (CH) collision public parameters at 3804. For example, the set of token CH collision public parameters may include an aᵤ′ parameter and a bᵤ′ parameter which are based on a CH collision function using a secret key of an owner of the data, a CH value of a decentralized identifier of the owner, a hash value of the data access token, and a set of public parameters. The WTRU 102 may send, to the data consumer, information indicating a response to the request at 3806. For example, the response may include the data transfer token and the set of token CH collision public parameters.

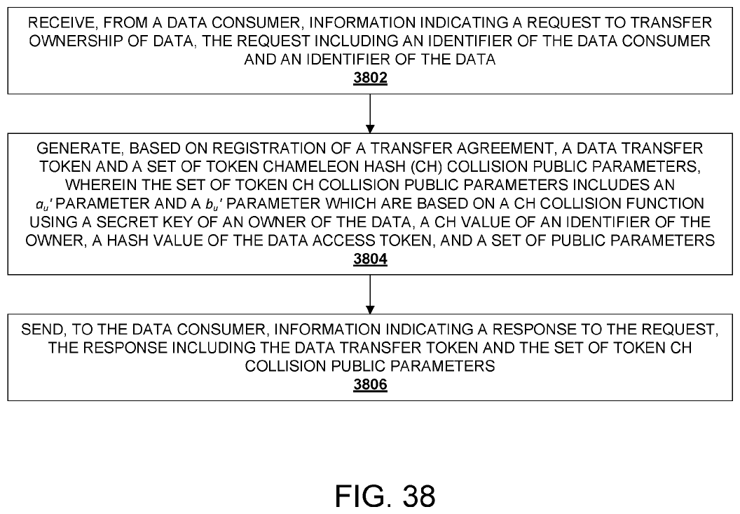

FIG. 39 is a procedural diagram illustrating an example procedure to transfer ownership of data owned by a data owner. In certain representative embodiments, a WTRU 102 (e.g., as a data consumer) may perform a procedure (e.g., implemented as a method) which includes to send, to a data owner, information indicating a request to transfer ownership of data at 3902. For example, the request may include an identifier of the data consumer and an identifier of the data. The WTRU 102 may receive, from the data owner, information indicating a response to the request based on registration of a transfer agreement at 3904. For example, the response may include a data transfer token and a set of token CH collision public parameters. For example, the set of token CH collision public parameters may include an aᵤ′ parameter and a bᵤ′ parameter which are based on a CH collision function using a secret key of the owner, a CH value of a decentralized identifier of an owner of the data, a hash value of the data access token, and a set of public parameters. The WTRU 102 may send, to a storage entity (e.g., a DSP 902), information indicating an ownership transfer request for the data, the ownership transfer request at 3906. For example, the ownership transfer request may include the data transfer token, the set of token CH collision public parameters, and an address of the transfer agreement. The WTRU may receive, from the storage entity, a request for new ownership information from the data consumer at 3908. The WTRU 102 may send, to the storage entity, a response to the request for new ownership information at 3910. For example, the response may include information indicating a set of chameleon hash (CH) collision public parameters. For example, the set of CH collision public parameters may include an aᵤ′ parameter and a bᵤ′ parameter, based on a CH collision function using a secret key of the data consumer, a CH value of a decentralized identifier of the data consumer, a hash value of the data, and a set of public parameters.

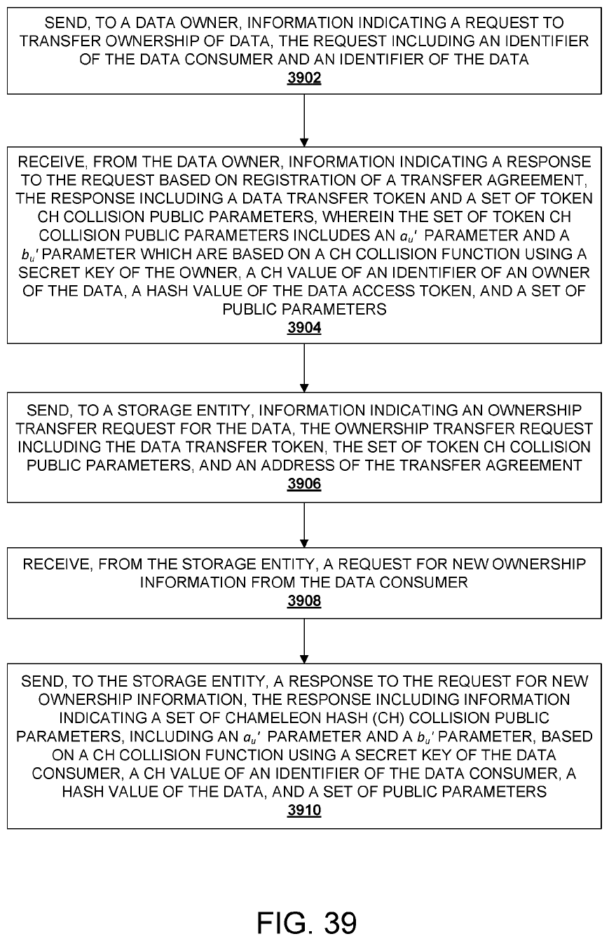

FIG. 40 is a procedural diagram illustrating an example procedure to register data owned by a data owner. In certain representative embodiments, a data owner (e.g., a WTRU 102) may perform a procedure (e.g., implemented as a method) which includes to register ownership of data, with a data storage entity (e.g., a DACF 2506), using a set of chameleon hash (CH) collision public parameters which are generated with a CH collision function using a secret key of the data owner, a CH value of an identifier of the data owner, a hash value of the data, and a set of public parameters at 4002. The data owner may receive, from the data storage entity, information indicating the identifier of the data owner and/or an identifier of ownership information of the data which is stored with the data storage entity at 4004.

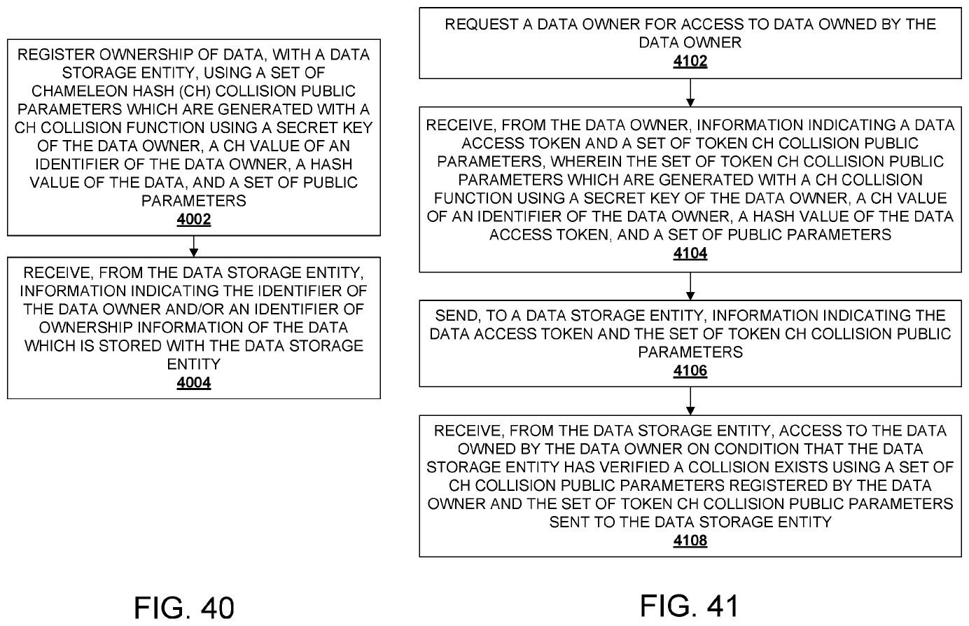

FIG. 41 is a procedural diagram illustrating an example procedure to access data owned by a data owner. In certain representative embodiments, a data consumer (e.g., a WTRU 102) may perform a procedure (e.g., implemented as a method) which includes to request a data owner for access to data owned by the data owner at 4102. At 4104, the data consumer may receive, from the data owner, information indicating a data access token and a set of token CH collision public parameters. For example, the set of token CH collision public parameters may be generated with a CH collision function (e.g., performed by the data owner) using a secret key of the data owner, a CH value of an identifier of the data owner, a hash value of the data access token, and a set of public parameters. The data consumer may send, to a data storage entity (e.g., a DACF 2506), information indicating the data access token and the set of token CH collision public parameters at 4106. At 4108, the data consumer may receive, from the data storage entity, access to the data owned by the data owner on condition that the data storage entity has verified (e.g., using Verify_Collision) a collision exists using a set of CH collision public parameters registered by the data owner and the set of token CH collision public parameters sent to the data storage entity.

In certain representative embodiments, a first entity (e.g., a WTRU 102) may perform a procedure (e.g., implement a method) to register data. The first entity may determine hash collision information for the data. For example, the hash collision information may be associated with causing a collision between a first hash value of the data and a second hash value of a first entity identifier of the first entity. The first entity may send, to a second entity, information indicating a request to register the data. For example, the request may include any of (1) a first index to first public data control and access information associated with the first entity and/or (2) verification credentials for the first entity. The first entity may receive, from the second entity, a request for the data. The first entity may send, to the second entity, information indicating (1) the data and (2) the determined hash collision information. The first entity may receive, from the second entity, information indicating a response that the data is registered. For example, the response may include a second index to second public data control and access information associated with the data which is registered.

For example, the first entity, before determining the hash collision information, may send, to a service provider, information indicating a subscription request. The subscription request may include information indicating a second entity identifier of the first entity. The first entity may receive, from the service provider, information indicating the first entity identifier and/or the verification credentials for the first entity. As an example, the first entity identifier may indicate the first index, and the first public data control and access information may include any of the second entity identifier and/or the hash collision information.

For example, the first public data control and access information may (e.g., also) include hash public parameters. The hash public parameters (e.g., associated with the first entity) may include (1) a public key, (2) a p parameter, (3) a q parameter, and (4) a g parameter.

For example, the hash collision information may include hash collision public parameters determined using a private trapdoor key (e.g., Xᵤ), the first hash value, and the second hash value. For example, the second hash value may be determined using the public key.

For example, the hash collision public parameters may include an aᵤ′ parameter and a bᵤ′ parameter.

For example, the first hash value of the data may be a secure hashing algorithm (SHA) hash value, and the second hash value of the first entity identifier may be a chameleon hash value.

For example, the first public data control and access information and/or the second public data control and access information may be a smart contract (e.g., between the first and second entities).

For example, the public key and the private trapdoor key may form a key pair generated for the first entity.

In certain representative embodiments, the first entity may be a WTRU 102 and/or an AF.

In certain representative embodiments, the second entity may be another WTRU 102 and/or a network entity.

In certain representative embodiments, the network entity and the service provider are associated with a wireless network.

In certain representative embodiments, a first entity (e.g., a WTRU 102) may perform a procedure (e.g., implement a method) to access data owned by a second entity. The first entity may receive, from the second entity, access token information including one or more token parameters and hash collision information. The first entity may send, to a third entity, information indicating a data access request. For example, the data access request may include the one or more token parameters and hash collision information. The first entity may receive, from the third entity, a response which includes information indicating the data.

For example, the first entity may, before receiving the access token information, receive, from the third entity, information indicating a list of data owned by the second entity. The first entity may send a request to access the data owned by the second entity.

For example, the one or more token parameters may include any of a first index to first public data control and access information associated with the first entity, and/or a second index to second public data control and access information associated with the data owned by the second entity.

For example, the hash collision information may include hash collision public parameters determined using a private trapdoor key (Xᵤ) of the second entity, a first hash value of the one or more token parameters, and a second hash value of an entity identifier of the second entity. For example, the first hash value may be determined using a public key of the second entity.

For example, the hash collision public parameters may include an aᵤ“parameter and a bᵤ” parameter.

For example, the first hash value of the data may be a secure hashing algorithm (SHA) hash value, and the second hash value of the first entity identifier may be a chameleon hash value.

For example, the public key and the private trapdoor key may form a key pair generated for the second entity.

For example, the information included in the response may include the data owned by the second entity or an index to the data owned by the second entity.

For example, the data may be a set of data. The set of data may include any of environmental data, traffic data, multimedia data, measurement data, and/or artificial intelligence and/or machine learning (AI/ML) data. As an example, the AI/ML data may include training data and/or AI/ML model data.

In certain representative embodiments, the first entity may be a WTRU 102 and/or an AF. In certain representative embodiments, the second entity may be a WTRU 102 and/or an AF.

In certain representative embodiments, the third entity may be a network entity.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). Atypical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method implemented by a wireless transmit/receive unit (WTRU), the method comprising:
sending, by the WTRU, information indicating a request to register data, the request including an identifier of an owner of the data;
determining a set of chameleon hash (CH) collision public parameters, including an aᵤ′ parameter and a bᵤ′ parameter, which are based on a CH collision function using a secret key of the owner, a CH value of an identifier of the owner, a hash value of the data to be registered, and a set of public parameters;
sending, by the WTRU, information indicating (1) the data to be registered and (2) the set of CH collision public parameters of the data; and
receiving, from an access control entity, information indicating an identifier of the registered data.

2. The method of claim 1, wherein the secret key is a private trapdoor key Xᵤ.

3. The method of claim 2, further comprising:
determining, by the WTRU, the private trapdoor key Xᵤ as a random number from a set of numbers, wherein the set of numbers is associated with a first prime number q; and
determining, by the WTRU, a public hash key Yᵤ based on a function of a cryptographic primitive g, the private trapdoor key Xᵤ, and a second prime number p.

4. The method of claim 3, further comprising:
deriving, by the WTRU, the set of CH collision public parameters based on (1) the CH collision function, and (2) the private trapdoor key Xᵤ as the secret key, a CH hash value of the identifier of the owner, the hash value of the data, the first prime number q, the second prime number p, and the cryptographic primitive g as input parameters of the CH collision function.

5. The method of claim 1, wherein the identifier of the owner is verified credential information of the owner.

6. The method of claim 1, further comprising:
determining the hash value of the data based on a data fingerprint of the data using a predetermined hashing algorithm.

7. The method of claim 1, wherein the information indicating the data to be registered includes a hash value of the data and/or the content of the data.

8. The method of claim 1, wherein the identifier of the registered data is associated with a storage address of the data with the access control entity.

9. The method of claim 1, wherein the request to register the data is sent to the access control entity.

10. The method of claim 1, wherein the (1) the data to be registered and (2) the set of CH collision public parameters of the data are sent to the access control entity.

11. A wireless transmit/receive unit (WTRU) comprising:
a processor and a transceiver which are configured to:
send information indicating a request to register data, the request including an identifier of an owner of the data;
determine a set of chameleon hash (CH) collision public parameters, including an aᵤ′ parameter and a bᵤ′ parameter, which are based on a CH collision function using a secret key of the owner, a CH value of an identifier of the owner, a hash value of the data to be registered, and a set of public parameters;
send information indicating (1) the data to be registered and (2) the set of CH collision public parameters of the data; and
receive, from an access control entity, information indicating an identifier of the registered data.

12. The WTRU of claim 11, wherein the secret key is a private trapdoor key Xᵤ.

13. The WTRU of claim 12, wherein the processor is configured to:
determine the private trapdoor key Xᵤ as a random number from a set of numbers, wherein the set of numbers is associated with a first prime number q; and
determine a public hash key Yᵤ based on a function of a cryptographic primitive g, the private trapdoor key Xᵤ, and a second prime number p.

14. The WTRU of claim 13, wherein the processor is configured to:
determine the set of CH collision public parameters based on (1) the CH collision function, and (2) the private trapdoor key Xᵤ as the secret key, a CH hash value of the identifier of the owner, the hash value of the data, the first prime number q, the second prime number p, and the cryptographic primitive g as input parameters of the CH collision function.

15. The WTRU of claim 11, wherein the identifier of the owner is verified credential information of the owner.

16. The WTRU of claim 11, wherein the processor is configured to:
determine the hash value of the data based on a data fingerprint of the data using a predetermined hashing algorithm.

17. The WTRU of claim 11, wherein the information indicating the data to be registered includes a hash value of the data and/or the content of the data.

18. The WTRU of claim 11, wherein the identifier of the registered data is associated with a storage address of the data with the access control entity.

19. The WTRU of claim 11, wherein the request to register the data is sent to the access control entity.

20. The WTRU of claim 11, wherein the (1) the data to be registered and (2) the set of CH collision public parameters of the data are sent to the access control entity.
